(19) United States
(12) Patent Application Publication
(10) Pub. No.: US 2024/0409423 A1
(43) Pub. Date: Dec. 12, 2024

(54) CATALYST-SORBENT STRUCTURE FOR AMMONIA SYNTHESIS AND SORPTION AND METHOD OF AMMONIA PRODUCTION

(71) Applicant: Ammobia, Inc., San Francisco, CA (US)

(72) Inventors: Tristan Gilbert, Stanford, CA (US); Karen Baert, San Francisco, CA (US); Lee Tonkovich, Gilbert, AZ (US)

(21) Appl. No.: 18/736,195

(22) Filed: Jun. 6, 2024

Related U.S. Application Data
(60) Provisional application No. 63/524,465, filed on Jun. 30, 2023.
(60) Provisional application No. 63/506,744, filed on Jun. 7, 2023.

(51) Int. Cl. C01C 1/04; B01D 53/04; B01J 20/02; B01J 20/18; B01J 20/28; B01J 20/30; B01J 20/34; B01J 23/58; B01J 23/63; B01J 23/75; B01J 35/54; B01J 35/64

(52) U.S. Cl. CPC C01C 1/0411; B01D 53/04; B01J 20/027; B01J 20/0288; B01J 20/186; B01J 20/28042; B01J 20/28083; B01J 20/28085; B01J 20/3085; B01J 20/3408; B01J 20/3458; B01J 20/3491; B01J 23/58; B01J 23/63; B01J 23/75; B01J 35/54; B01J 35/647; B01J 35/651; B01J 35/653; B01J 35/657; C01C 1/0458; B01D 2253/108; B01D 2253/25; B01D 2253/308; B01D 2253/34; B01D 2257/406

(57) ABSTRACT

An active catalyst for ammonia synthesis is integrated with a specialty sorbent in a composition or composite, such that the catalyst portion and the sorbent portion are in direct intimate contact, which overcomes the thermodynamic limits for conversion. The sorbent may comprise a metal halide absorbent, zeolite adsorbent, other material absorbents or adsorbents, to capture ammonia as it is produced in intimate or near molecular contact with the catalyst, wherein the composition/composite may be provided in the form of a granular or pellet structure. By removing ammonia essentially as it forms, the forward reaction for producing ammonia can continue nearly unabated such that high net conversion can be achieved in a single pass or cumulative within segmented reactors as operated in series.

### CROSS-REFERENCE TO RELATED APPLICATION

This present application claims benefit of U.S. Provisional Application No. 63/524,465 filed Jun. 30, 2023 and U.S. Provisional Application No. 63/506,744 filed Jun. 7, 2023, which is hereby incorporated herein its entirety by reference.

### TECHNICAL FIELD

The present disclosure relates generally to compositions and composites for synthesizing ammonia, more particularly operable catalyst-sorbent structures comprising a catalyst portion for ammonia synthesis in intimate contact with a sorbent portion for integrated ammonia sorption upon synthesis in a first reaction and sorption stage, whereby the catalyst-sorbent structures are configured to provide the synthesized ammonia in a later desorption stage, and whereby the catalyst-sorbent structures can be provided in various forms, including in the form of a pellet structure for utilization in the ammonia synthesis, sorption and desorption stages to provide the ammonia.

### BACKGROUND

Ammonia is an inorganic compound of nitrogen and hydrogen with the formula NH₃. Ammonia is a vital molecule necessary to support life. The discovery of the Haber-Bosch process in 1909 to catalytically convert nitrogen gas (N₂) and hydrogen gas (H₂) over an iron-based catalyst to make ammonia allowed for the synthetic production of nitrogen fertilizers which supports billions of lives. In 2019 approximately 88% of ammonia was used as fertilizers, either in the form of salts, solutions or anhydrously. There has also been growth in using ammonia as a fuel or fuel source, particularly in view of it being a clean, effective fuel compared to carbon-based fossil and renewable fuels giving rise to global CO₂ emissions.

Ammonia at ambient temperature and pressure is a colorless gas, as ammonia boils at −33.34° C. (˜28.012° F.) at a pressure of one atmosphere, such that liquid ammonia typically must be stored under pressure or at low temperature. The production of ammonia is highly exothermic, and as equilibrium limited, reactors generally operate at high pressure (about 60 to 300 barg) and temperatures (about 400-600° C.). Industrially, the per pass conversion of nitrogen gas and hydrogen gas feedstocks to ammonia production is low, with some processes having a 20% conversion in a single pass due to the thermodynamics of the Haber-Bosch process. To achieve a high net utilization of feedstock as needed for an industrial process, the reactor effluent is cooled to ammonia condensation temperature to capture product and allow recycle of unreacted feedstocks. Recycle material is added to a fresh feedstock to heat and compress to the reactor inlet. A commercial process has a large reactor volume due to low per pass conversion and a high recycle ratio which adds to the industrial energy requirements for heating/cooling and compression. The primary reaction is shown in Equation (1), which has a change in enthalpy (ΔH°) of about −92 kJ/mol of N₂ converted:

$${N}_{2} + 3 {H}_{2} = 2 {NH}_{3} \qquad ( 1 )$$

A known process for synthesizing ammonia is disclosed in U.S. Pat. No. 5,711,926, which discloses a Haber-Bosch ammonia synthesis reactor followed by a separate adsorption vessel to adsorb the product ammonia. The separate device is described as a pressure swing adsorption (PSA) device independent of the reactor. The disclosed system also contains a recycle line of the unreacted nitrogen geed gas and unreacted hydrogen feed gas back to the upstream reactor.

Another process for synthesizing ammonia is U.S. Pat. Nos. 9,914,645 and 10,287,173, which disclose a system comprising first a reactor having a catalyst bed followed by a second reactor with an absorbent bed configured to selectively absorb at least a portion of the ammonia as produced from the upstream reactor. It is disclosed that the absorbent can be regenerated by increased temperature or decreased pressure. However, this method requires stopping of a flow of feed gases to the reactor, then decreasing pressure or increasing temperature of the vessel containing the absorbent. Also, the disclosed system contains a recycle line of the unreacted nitrogen geed gas and unreacted hydrogen feed gas and unabsorbed ammonia that is fed back to the upstream reactor. Still further, the absorber system performs absorption at low temperatures of 50-100° C. and requires a large temperature swing to desorb at 150-350° C.

Another process for synthesizing ammonia is disclosed in U.S. Pat. No. 11,548,789, which discloses a system comprising a catalyst for ammonia generation and an absorber configured to selectively absorb ammonia from the reaction mixture at temperatures between 180-330° C. and pressures of 1-20 bar. The disclosed system also contains a recycle line of the unreacted nitrogen geed gas and unreacted hydrogen feed gas and unabsorbed ammonia that is fed back to the reactor.

U.S. Patent Publication No. 2020/0325030 discloses a catalyst and a metal-halide absorbent as separate components disposed within an internal volume of the reactor. The process utilizes a reaction temperature above 350° C. and appears to utilize a downstream separation unit.

Another process for synthesizing ammonia is disclosed in U.S. Pat. No. 10,974,970, having distinct catalyst particles and absorbent particles, where the catalyst particles are at least ten times larger than sorbent particles, are introduced into a fluidized bed reactor and the sorbent is cycled through multiple reactors as a continuous flow of solid sorbent particles.

As such, there is a need in the industry of ammonia synthesis for compositions and processes that are more efficient and have higher net conversions. There is also the need to synthesize ammonia that minimizes recycle of unreacted nitrogen feedstock and unreacted hydrogen feedstock, as well as ammonia that was generated. There is also a need for a system that is capable of overcoming equilibrium thermodynamic limits for conversion of the hydrogen and nitrogen gas feedstocks into ammonia. There is further a need of a composition that synthesizes a product ammonia gas from hydrogen and nitrogen and provides efficient sorption via a sorbent, eliminating a need for or reducing the size of a chiller for separation by condensation. Cost-effective and environmentally friendly materials that allow for the synthesis of ammonia at lowered temperatures and/or pressures are also desired.

### SUMMARY

The present inventors have surprisingly discovered a composition, system and method comprising a plurality of catalyst-sorbent particles that overcomes the thermodynamic limits traditionally encountered in converting nitrogen and hydrogen feedstock gases to an ammonia gas. In some aspects, the plurality of catalyst-sorbent particles integrate an active catalyst for ammonia synthesis with a specialty sorbent for ammonia sorption that allows for the removal of ammonia essentially as it forms in a first reaction and sorption stage. The plurality of catalyst-sorbent particles is also configured to provide a resulting ammonia product in a later desorption stage, whereby at least a portion of the ammonia synthesized and absorbed and/or adsorbed in the first reaction and sorption stage is released from the plurality of catalyst-sorbent particles to provide the resulting ammonia product.

In some aspects, the integration of the active catalyst with the specialty sorbent comprises the catalyst portion and the sorbent portion being configured within the same catalyst-sorbent particle, and in some preferred aspects a plurality of catalyst-sorbent particles each having a catalyst portion and a sorbent portion. In some aspects, the integration of the active catalyst with the specialty sorbent comprises an intimate connection between the catalyst portion and the sorbent portion, preferably in some aspects the catalyst portion and the sorbent portion being in direct contact, more preferably in some aspects the catalyst portion being in molecular contact or near molecular contact with the sorbent portion. In some aspects, the plurality of catalyst-sorbent particles can be provided in a compressed structural configuration, such as a compressed pellet, a compressed tablet, a granule, an extrudate, or the like. Alternatively, the pellets may be formed first from an active sorbent material and then impregnated with an active catalyst material. This approach avoids pressing sorbent and catalyst powders at the same time into pellets. The catalyst may be disposed as an eggshell coating on the exterior of the sorbent pellet or it may be disposed throughout the sorbent pellet. In some other alternative aspects, the pellets may be formed from an active catalyst material or supported active catalyst material and then coated with an active sorbent material.

In some aspects, instead of a plurality of particles, the integration of the active catalyst with the specialty sorbent comprises a monolithic structure. The integration of the active catalyst with the specialty sorbent in the monolithic structure comprises an intimate direct connection between a catalyst portion and a sorbent portion, preferably in some aspects whereby the catalyst portion is in molecular contact or near molecular contact with the sorbent portion.

In some aspects, the integration of the active catalyst with the specialty sorbent in an intimate direct configuration between the catalyst portion and the sorbent portion, whether as a plurality of catalyst-sorbent particles or a monolithic structure allows for the removal of ammonia via absorption and/or adsorption essentially as it forms via the catalytic reaction. By removing ammonia essentially as it forms, the forward reaction for producing ammonia can continue nearly unabated such that high net conversion can be achieved in a single pass or cumulative within segmented reactors as operated in series and the kinetics of the catalytic reaction can be improved.

In some aspects, the catalyst portion converts non-condensable feedstocks comprising nitrogen and hydrogen to ammonia. The active catalyst material can comprise iron (Fe), cobalt (Co), ruthenium (Ru), molybdenum (Mo), or combinations thereof. It is generally understood that the active catalyst material may be supported on a porous support material, such as a molecularly or micro- or meso-porous support material, and may contain other promoters to increase catalyst activity and/or improve catalyst stability. In some other aspects, the active catalyst material may be supported on the sorbent material, such that the catalyst-sorbent is supported on a molecularly porous support material and may contain other promoters to increase catalyst activity and/or improve catalyst stability. In some aspects, the promoter can be potassium (K), cerium (Ce), cesium (Cs), barium (Ba) or a combination thereof.

In some aspects, the molecularly porous support material for the active catalyst or the catalyst-sorbent may have an average pore diameter between about 20 nm and about 50 microns, in some aspects between about 50 nm and about 5 microns, and in some preferable aspects between about 100 nm and about 1 micron.

In some aspects, the molecularly porous support material for the active catalyst or the catalyst-sorbent may have a surface area in a range from about 1 to 1000 m²/gram.

In some aspects, the porous support material may comprise oxides of alumina, silica, magnesium, ceria, titania, iron oxides, zeolites, or combinations thereof. Other high surface area porous materials with a reduced activity to the active material are also contemplated.

In some other aspects, the active catalyst may be self-supported in a porous form. In some aspects, the specialty sorbent may be supported on the active catalyst.

The pores in relation to the active catalyst or catalyst-sorbent may be straight or tortuous and facilitate gas phase mass transfer through either molecular diffusion or Knudsen diffusion therein.

In some aspects, the sorbent portion comprises one or more metal halide absorbents that has an absorption affinity for NH₃ over N₂ and H₂. In some preferred aspects, the sorbent portion comprises one or more metal halides, wherein the metal of the one or more metal halides is chosen from Mn, Mg, Ca, and Fe, and wherein the halide of the one or more metal halides is chosen from Cl, Br and Sr. In some other preferred aspects, the sorbent portion comprises one or more zeolites, particularly microporous, crystalline aluminosilicate material, such as Y-type zeolites, X-type zeolites, A-type zeolites, ZSM-5, or mixtures thereof.

In some aspects, the sorbent portion includes a metal halide salt chosen from the group consisting of LiCl, NH₄Cl, CoCl₂, MgCl₂, CaCl₂, MnCl₂, FeCl₂, NiCl₂, CuCl₂, ZnCl₂, SrCl₂, SnCl₂, BaCl₂, PbCl₂, LiBr, NaBr, MgBr₂, CaBr₂, MnBr₂, FeBr₂, NiBr₂, CoBr₂, SrBr₂, BaBr₂, PbBr₂, NH₄Br, NaI, KI, CaI₂, MnI₂, FeI₂, NiI₂, SrI₂, BaI₂, NH₄I and PbI₂. In some preferred aspects, the sorbent portion includes a metal halide salt chosen from the group consisting of MgCl₂, CaCl₂, MnCl₂, FeCl₂ and NiCl. In some other aspects, the one or more metal halide salts comprises MnCl₂, MgCl₂, CaCl₂, MgBr₂, CaBr₂, MgClBr, CaClBr, MgCaBr and mixtures thereof. In some preferred aspects, the sorbent portion includes one or more zeolites that includes zeolite Y, zeolite X, zeolite 13X, zeolite 4A, zeolite 5A, ZSM-5, or mixtures thereof. In some other preferred aspects, the sorbent portion includes a mixture of one or more metal halide salts and one or more zeolites. Other material absorbents or adsorbents to capture ammonia as it is produced in intimate or near molecular contact with the catalyst are also contemplated, whether utilized alone or in combination with one or more metal halide salts and/or one or more zeolites.

In some aspects, the sorbent portion comprises the metal halide MnCl₂, which can absorb 6, 2, 1, 0.5 or 0 moles of ammonia per mole of metal halide depending on the operating temperature. For example, with MnCl₂ at an operating temperature from about 260° C. to about 330° C., 1 mole of ammonia is absorbed per mole of absorbent. MnCl₂ at an operating temperature from about 130° C. to about 260° C. can absorb about 2 moles of ammonia per mole of absorbent. Below about 130° C., about 6 moles of ammonia can be absorbed per mole of MnCl₂. Between about 330° C. to about 370° C., about 0.5 moles of ammonia can be absorbed per mole of MnCl₂. Above about 370° C., ammonia is not favored to absorb on MnCl₂.

In some aspects, the sorbent portion comprises one or more zeolites, particularly one or more aluminosilicate zeolites, such as one more zeolites chosen from zeolite Y, zeolite X, zeolite 4A, zeolite 5A, ZSM-5, or a mixture thereof. The one or more zeolites preferably binds NH₃ over N₂ and H₂, which in some preferred aspects at least 5 times, in some aspects at least 10 times, in some aspects at least 100 times, in some aspects at least 200 times, in some aspects at least 300 times, in some aspects at least 400 times, in some aspects at least 500 times, in some aspects at least 600 times, in some aspects at least 700 times, and in some aspects at least 1000 times or more greater affinity for NH₃ than for N₂ and/or H₂.

In some aspects, the sorbent can absorb ammonia in the capacity range of 1-2000 mg_{NH3}/g_{sorbent}, or more preferably, between 5-300 mg_{NH3}/g_{sorbent} within the temperature range of 100-500 C and pressure range of 1 bar-100 bar. In some aspects, the sorbent may be a material other than a metal halide, including but not limited to a metal organic framework (MOF), covalent organic framework (COF), Zeolitic imidazolate framework (ZIF), or zeolite, or other sorbent material that selectively uptakes and sorbs NH₃ in the gas phase within this temperature and pressure range. More preferably, the sorbent uptakes NH₃ through phase-transitions on the surface or bulk, where a sharp boundary exists between capacities at given conditions, as in the exemplary MnCl₂ material.

In some aspects, the integration of the active catalyst with the specialty sorbent comprises a catalyst portion and a sorbent portion intermixed and pressed into a shaped configuration, such as a pellet, tablet, granule, or extrudate. In some aspects, the catalyst-sorbent in the compressed shaped configuration further comprises a porous support material. In some aspect, the active catalyst and specialty sorbent are intermixed such that the catalyst-sorbent is configured on a monolithic structure.

In some other aspects, the integration of the active catalyst with the specialty sorbent comprises a sorbent portion configured to have a compressed structural configuration, such as a compressed pellet, a compressed tablet, an extrudate, a granule, or the like, which provides a sorbent core, and the catalyst portion is coated onto the sorbent core such that the catalyst coating provides a surrounding shell or external layer, whereby the catalyst portion at least partially encapsulates the sorbent core, preferably substantially encapsulating the sorbent core. In some aspects, the sorbent core further comprises a porous support material. In some aspects, the catalyst coating further comprises a porous support material. In some aspects, the porous support material of the sorbent core and the catalyst coating are the same material. In some aspects, the porous support material of the sorbent core and the catalyst coating are different materials. In some aspects, the catalyst coating comprising active material and support has an average thickness between about 3 microns and about 200 microns, preferably between about 10 microns and about 150 microns, more preferably between about 20 microns and about 100 microns.

In some other aspects, the integration of the active catalyst with the specialty sorbent comprises a sorbent portion configured to have a compressed structural configuration, such as a compressed pellet, a compressed tablet, an extrudate, or the like, which provides a sorbent core, the catalyst portion is coated onto the sorbent core such that the catalyst coating provides a surrounding shell or external layer, whereby the catalyst portion at least partially encapsulates the sorbent core, preferably substantially encapsulating the sorbent core, and a second sorbent portion is coated onto the catalyst coating as a surrounding shell or external layer at least encapsulating the catalyst coating, preferably substantially encapsulating the catalyst coating. In some aspects, the sorbent core further comprises a porous support material. In some aspects, the catalyst coating further comprises a porous support material. In some aspects, the sorbent coating over the catalyst coating further comprises a porous support material. In some aspects, the porous support material of the sorbent core, the catalyst coating and the sorbent coating are the same material. In some aspects, the porous support material of at least two of the sorbent core, the catalyst coating and the sorbent coating are the same material. In some aspects, the porous support material of the sorbent core, the catalyst coating and the sorbent coating are all different materials. In some aspects, the porous support material of at least two of the sorbent core, the catalyst coating and the sorbent coating are different materials. In some aspects, the porous support material of the sorbent core and the catalyst coating are different materials. In some aspects, the catalyst coating has an average thickness between about 3 microns and about 200 microns, preferably between about 10 microns and about 150 microns, more preferably between about 20 microns and about 100 microns. In some aspects, the sorbent coating has an average thickness between about 3 microns and about 200 microns, preferably between about 10 microns and about 150 microns, more preferably between about 20 microns and about 100 microns.

In some other aspects, the sorbent portion and the catalyst portion are loaded and dispersed along the same porous support (either sequentially or simultaneously, e.g., by incipient wetness impregnation, colloidal synthesis, or a sol-gel method, or other method), such that the catalyst-sorbent particle is supported on the same porous support. In some other aspects, the sorbent portion is loaded and dispersed on a different porous support than the catalyst portion.

The catalyst-sorbent configuration, whether as a plurality of catalyst-sorbent particles having the intermixed configuration, sorbent core with catalyst coating, or sorbent core with first catalyst coating and second coating can be provided in a compressed structural configuration, such as a compressed pellet, a compressed tablet, an extrudate, or the like.

In some aspects, each of the catalyst-sorbent pellets, tablets, extrudates or the like configurations used during normal operation of ammonia synthesis preferably has an average diameter as defined by hydraulic diameter for a non-spherical shape between 1 and 20 mm, preferably between 3 and 10 mm, more preferably between 3 and 9 mm.

In some aspects, the catalyst-sorbent particle that comprises support material has an active sorbent portion loading between 5% and 90% by weight, preferably between 10% and 75% by weight, more preferably between 20% and 50% by weight. In some aspects, the catalyst-sorbent particle has an active catalyst portion loading between 0.01% and 30% by weight, preferably between 0.25% and 10% by weight, more preferably between 0.5% and 5% by weight. In some preferred aspects, the catalyst-sorbent particle has a catalyst portion loading less than about 5% by weight.

In some aspects, the catalyst-sorbent particle has an active catalyst portion loading to active sorbent portion loading (catalyst:sorbent) ratio by weight of about 1:1 to about 1:100, preferably about 1:1 to about 1:50, more preferably about 1:1 to about 1:10.

In some aspects, the anticipated sorbent portion loading density is in the range from about 100 kg/m³ to 2000 kg/m³, preferably in the range from about 300 kg/m³ to about 1500 kg/m³, more preferably in the range from about 500 kg/m³ to about 1200 kg/m³.

In some aspects, the anticipated catalyst portion loading density is in the range from about 10 kg/m³ to 2000 kg/m³, preferably in the range from about 100 kg/m³ to about 1500 kg/m³, more preferably in the range from about 150 kg/m³ to about 1200 kg/m³.

In some embodiments where an increased cycle time is desired, the weight loading of the catalyst portion can be in a range from about 5 kg/m³ to about 500 kg/m³, preferably from about 5 kg/m³ to about 400 kg/m³, more preferably from about 5 kg/m³ to about 250 kg/m³, while the sorbent portion weight loading can be in a range from about 50 kg/m³ to 1500 kg/m³, preferably from about 150 kg/m³ to about 1400 kg/m³, more preferably from about 250 kg/m³ to about 1200 kg/m³. In some aspects, the ratio by weight of the catalyst portion loading to sorbent portion loading (catalyst:sorbent) can be in a range from about 1:3 to about 1:300.

In some aspects, the integrated catalyst-sorbent process exceeds the equilibrium NH₃ composition that would be obtained if the sorbent portion was not used. In some aspects, a nitrogen conversion (in terms of % of stoichiometric conversion of an unreacted nitrogen feedstock to ammonia) may range from about 30 to 99.99%, preferably from 50 to 99.9% and more preferably from about 70 to 99% per pass, wherein the pass is understood to be a single tube or a series of segmented tubes in fluidic communication during one process feed cycle. In some aspects, a hydrogen conversion (in terms of % of stoichiometric conversion of an unreacted hydrogen feedstock to ammonia) can be greater than 70%, in some aspects at least 80% up to 100%, in some other aspects at least 80% up to 99.99%, and in some other aspects at least 80% up to 99%, per pass, wherein the pass is understood to be a single tube or a series of segmented tubes in fluidic communication during one process feed cycle.

In some aspects, the integrated catalyst-sorbent of the present disclosure comprises a catalyst portion and a sorbent portion, wherein the catalyst portion is capable of converting an unreacted hydrogen feedstock and an unreacted nitrogen feedstock to an ammonia product and the sorbent portion is capable of absorbing the produced ammonia, wherein the converting of the catalyst portion and absorbing of the sorbent portion are both capable of occurring at a temperature in a range between about 100° C. and about 500° C., preferably between about 200° C. and about 400° C., more preferably between about 250° C. and about 350° C., and even more preferably between about 280° C. and about 330° C., and wherein the converting of the catalyst portion and sorbing of the sorbent portion are both capable of occurring at a pressure in a range between about 2 bar to about 200 bar, preferably between about 5 bar and about 100 bar, more preferably between about 5 bar and about 50 bar, and even more preferably between about 5 bar and about 20 bar.

In some aspects, the present disclosure is directed at a process for producing ammonia, the process comprises providing a catalyst-sorbent of the present disclosure in a reactor, preferably as a fixed bed, such as a packed bed, wherein during normal operating conditions the catalyst portion converts an unreacted hydrogen feedstock and an unreacted nitrogen feedstock to an ammonia product, and the sorbent portion absorbs and/or adsorbs the produced ammonia.

In some aspects, the catalyst-sorbent is arranged within a reactor, wherein the catalyst-sorbent are loaded in a range between about 0.1% to about 99.9% of the volume of the reactor, preferably between about 10% to about 98%, preferably between about 15% to about 96%, more preferably between about 20% to about 94%, and in some aspects even more preferably between about 25% to about 90%, of the volume of the reactor.

In some preferred aspects, the catalyst-sorbent loading in the reactor is at least 10%, in some aspects at least 20%, in some aspects at least 30%, in some aspects at least 40%, in some aspects at least 50%, in some aspects at least 60%, in some aspects less than 98%, in some aspects less than 80%, and in some aspects less than 70%, of the volume of the reactor.

In some aspects, the active catalyst portion of the catalyst-sorbent is present in the reactor in a weight range (w/w) between about 0.01% and about 20%, preferably between about 0.25% and about 10%, more preferably between about 0.5% and less than about 5%. In some preferred aspects, the catalyst-sorbent particle has a catalyst portion loading in the reactor that is less than 5% by weight.

In some aspects, the sorbent portion of the catalyst-sorbent is present in the reactor in a weight range (w/w) between about 5% and 95%, preferably between 10% and 90%, more preferably between 20% and 80%.

In some aspects, the catalyst-sorbent is present in the reactor in a weight ratio of the catalyst portion to the sorbent portion (catalyst:sorbent) of about 1:1 to about 1:300, preferably about 1:10 to about 1:50, more preferably about 1:15 to about 1:25.

In some aspects, the process for producing ammonia with the catalyst-sorbent of the present disclosure has a process cycle that is less than a full sorption capacity of the sorbent portion. In some aspects, the process cycle is at least 20% up to about 95% of full theoretical capacity as defined by the temperature and pressure of operation for the process bed.

In some aspects, the process for producing ammonia with the catalyst-sorbent of the present disclosure has an initial process cycle having an initial conversion and a second process cycle having a second conversion, wherein the second conversion has a lower conversion than the initial conversion, in some aspects at least 0.1% lower, and in some preferred aspects between 0.1% and 10% lower than the initial conversion.

In some aspects, the process for producing ammonia comprises providing the catalyst-sorbent of the present disclosure in multiple beds. In some aspects, the multiple beds are provided in series. In some aspects, the multiple beds are provided in parallel. In some aspects, the multiple beds are provided in both series and parallel.

In some aspects, the unreacted hydrogen is provided from a hydrogen source. While the unreacted hydrogen is contemplated to be able to be provided from any hydrogen source, in some preferred aspects the hydrogen source comprises synthesis from water in an electrolyzer.

In some aspects, the unreacted nitrogen is provided from a nitrogen source. While the unreacted nitrogen is contemplated to be able to be provided from any nitrogen source, in some preferred aspects the nitrogen source is a pressure swing adsorption (PSA) system, air separation unit (ASU) system, membrane separator, or a combination thereof.

The above summary is not intended to describe each illustrated embodiment or every implementation or aspect of the subject matter hereof. The figures and the description that follow more particularly exemplify various embodiments and aspects of the present disclosure.

### BRIEF DESCRIPTION OF THE DRAWINGS

Subject matter hereof may be more completely understood in consideration of the following detailed description of various embodiments in connection with the accompanying figures, in which:

FIG. 1 is an illustrative depiction of the integration of the active catalyst with the specialty sorbent in an intermixed catalyst-sorbent particle configuration, whereby the catalyst portion and the sorbent portion are intermixed with and co-supported on a support material, such that each catalyst-sorbent particle comprises a support particle, wherein the exploded square view depicts a porous intermixed structure, according to certain embodiments of the present disclosure.

FIG. 2 is another illustrative depiction of the integration of the active catalyst with the specialty sorbent in a catalyst-sorbent particle configuration, whereby the sorbent portion may be a continuous or a discontinuous layer on the surface of the support material and the catalyst portion may be dispersed on the sorbent surface and/or the surface of the support material to provide a co-supported catalyst-sorbent configuration, according to certain embodiments of the present disclosure.

FIG. 3 is an illustrative depiction of the integration of the active catalyst with the specialty sorbent in a compressed structural configuration, such as a pellet, tablet or extrudate, whereby the catalyst portion and the sorbent portion are intermixed in the compressed structural configuration, wherein the exploded oval view depicts a porous intermixed structure, according to certain embodiments of the present disclosure.

FIG. 4 is an illustrative depiction of the integration of the active catalyst with the specialty sorbent in a compressed structural configuration, such as a pellet, tablet or extrudate, whereby a core of the sorbent portion is at least partially encapsulated by a coating of the catalyst portion, and wherein the exploded oval view of the core depicts a porous structure of the sorbent portion, and wherein the exploded view of the interface between the core and coating depicts a direct contact between the catalyst portion and the sorbent portion, according to certain embodiments of the present disclosure.

FIG. 5 is an illustrative depiction of the integration of the active catalyst with the specialty sorbent in a compressed structural configuration, such as a pellet, tablet or extrudate, whereby a core of the sorbent portion is at least partially encapsulated by a coating of the catalyst portion, and whereby the coating of the catalyst portion is at least partially encapsulated by a coating of the sorbent portion, wherein the exploded oval view of the core depicts a porous structure of the sorbent portion, and wherein the exploded view of the interface between the core and coatings depicts a direct contact between the catalyst portion and the sorbent portions, according to certain embodiments of the present disclosure.

FIG. 6 is a graphical depiction of the production rate of ammonia per gram of catalyst per hour as reported in the prior art in closed circles and modeled kinetic data for a comparative system of the present disclosure shown with open squares, according to certain embodiments of the present disclosure.

FIG. 7 is a graphical depiction of nitrogen gas conversion by a low catalyst loading (0.2 grams) and a high catalyst loading (1.5 grams) and by changes in temperature in a comparative analysis of a data set reported in the prior art and a modeled kinetic data according to certain aspects of a commercial catalyst comprising Iron and Cobalt, whereby the modeled kinetic fit data reflects a reasonable approximation for the current and anticipated performance for scaling the catalyst portion, according to certain embodiments of the present disclosure.

FIG. 8 is a graphical depiction of modeled adsorption constant values for ammonia (NH₃) (depicted as closed circles), nitrogen gas (N₂) (depicted as closed triangles), and hydrogen gas (H₂) (depicted as open circles), as function of temperature over the range of test data provided in FIG. 7, whereby the adsorption constant for H₂ decreases with temperature, while the adsorption constants for NH₃ and N₂ increase with temperature, according to certain embodiments of the present disclosure.

FIG. 9 is a graphical depiction of a modeled bed temperature versus length of an integrated catalyst-sorbent based on catalyst loadings between 100 and 300 kg/m3 (100 kg/m3 depicted as closed squares; 125 kg/m3 depicted as open triangles; 150 kg/m3 depicted as closed circles; 175 kg/m3 depicted as open X symbols; 200 kg/m3 depicted as closed triangles, and 300 kg/m3 depicted as open diamonds), whereby the modeling data of a higher catalyst activity or loading depicts more conversion activity towards the front of the bed, according to certain embodiments of the present disclosure.

FIG. 10 is a graphical depiction of a modeled bed temperature versus length of an integrated catalyst-sorbent based on catalyst loadings between 400 and 1200 kg/m3 (400 kg/m3 depicted as closed triangles; 800 kg/m3 depicted as open triangles; 1000 kg/m3 depicted as closed circles; and 1200 kg/m3 depicted as open circles), whereby the modeling data illustrates that the higher catalyst loading has peak temperature exceeding about 330° C., according to certain embodiments of the present disclosure.

FIG. 11 is a schematic representation of a fluidic chamber having a void configuration that includes a packed bed in an annular chamber located between an inner porous tube and an exterior heat transfer wall, whereby the process feed during the reaction and/or sorption cycle is fed into the annular packed bed and the outlet of the central void space is closed, and whereby the desorbed ammonia during the desorption cycle can exit the outlet of the central void space, according to certain embodiments of the present disclosure.

FIG. 12A is a cross-section SEM image of a catalyst-sorbent structure in the form of a pellet, according to certain embodiments of the present disclosure.

FIG. 12B is a cross-section EDS image of a catalyst-sorbent structure in the form of a pellet, according to certain embodiments of the present disclosure.

FIG. 13 is a graph of experimental data representing weight increase of the respective ion exchanged zeolites attributed to ammonia adsorption, according to certain embodiments of the present disclosure.

FIG. 14 is a graph of experimental data illustrating ammonia being adsorbed by a zeolite during a reaction process over time, according to certain embodiments of the present disclosure.

FIG. 15 is a graph of experimental data illustrating the effects of pre-reduction on catalyst activity in relation to ammonia formation, according to certain embodiments of the present disclosure.

FIG. 16 is a graph of experimental data illustrating the effects of ammonia pretreatment in relation to ammonia formation, according to certain embodiments of the present disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DESCRIPTION

The term “absorbent” or “solid absorbent” as used herein refers to and encompass salts such as metal halide salts, metal-organic frameworks, and similar materials, whereby ammonia resides in the bulk material rather than or in addition to merely at the surface of the molecules or at the surface of molecules that may otherwise form a cage like structure.

The term “absorption” as used herein refers to the process in which a fluid (gas or liquid) enters into the bulk phase of a solid material.

The term “adsorbent” or “solid adsorbent” as used herein refers to and encompass zeolites, such as aluminosilicate zeolites, or other materials whereby ammonia resides at the surface of the molecules of the solid material or at the surface of molecules of the solid material that otherwise form a cage like structure, including chemisorption, physisorption, or combinations thereof, rather than entering into the bulk phase of the solid sorbent material.

The term “adsorption” as used herein refers to the process in which a fluid (gas or liquid) is retained at the surface of a solid material and includes chemisorption.

The term “sorbent” as used herein refers to an insoluble material or mixture of materials used to recover a fluid through the process absorption, adsorption or both, and includes the terms absorbent, solid absorbent, adsorbent and solid adsorbent.

The term “intimate contact” as used herein refers to a relation of the catalyst portion and the sorbent portion of the catalyst-sorbent structure concerning a characteristic dimension that is less than the radius of an apparatus containing the catalyst and sorbent portions, such as a particle, pellet, tablet or extrudate, such that the catalyst and sorbent portions are contained within the same structural component.

The term “coordination number” as used herein refers to the number of moles of ammonia that are held per mole of the sorbent portion.

The term “capacity” as used herein refers to the weight of ammonia in grams that are held per gram of the sorbent portion.

The term “intermixed structure” as used herein refers to a granulated catalyst-sorbent structure, such as a particle, pellet, tablet, or extrudate, that contains an intermix of the catalyst and sorbent portions, including a homogenous mixture of the catalyst and sorbent portions.

The term “single coated structure” as used herein refers to a granulated catalyst-sorbent structure, such as a particle, pellet, tablet, or extrudate, that contains an inner core of one material and an outer shell coating comprising a second different material.

The term “double coated structure” as used herein refers to a granulated catalyst-sorbent structure, such as a particle, pellet, tablet, or extrudate, that contains an inner core of one material, a first outer shell coating comprising a second different material, and a second outer shell coating comprising a third material. The third material may be the same as either the first or second material, a combination of the first and second material, the first or second material with a different weight loading of the active material, and combinations therein.

The term “continuous-discontinuous sorbent” as used herein refers to a region of a granulated catalyst-sorbent structure that is continuous for a first portion of the structural radius and discontinuous for a second portion of the structural radius. The length of the continuous region may range from about 0.05 to 5 times the structural radius. The length may be higher than the structural radius in accordance with a non-linear and tortuous pore structure that may be found within the present catalyst-sorbent structure.

The term “continuous-discontinuous” may refer to regions of a coating of a catalyst or sorbent that is continuous for a portion and discontinuous for a portion of the coverage of a particle, pellet, tablet, or extrudate.

The term “continuous sorbent” as used herein refers to a continuous and molecularly connected sorbent portion that is dispersed through a porous catalyst-sorbent structure, whereby at least 95% of the sorbent molecules of the sorbent portion are in molecular contact.

The term “discontinuous sorbent” as used herein refers to the sorbent portion of the catalyst-sorbent wherein less than 5% of absorbent molecules are in molecular contact, such that the sorbent portion is dispersed throughout as islands, spots, or small connection of molecules that are separated from other islands or disconnected regions of absorbent. Molecules of support, catalyst, or other additives and open pores that allow gaseous diffusion may separate discontinuous small groups of absorbent molecules.

The term “dual function” as used herein refers to a material that provides two functions, such as the material functioning as a catalyst portion to increase the rate of reaction or synthesis of ammonia, and the material also functioning as a sorbent portion or a material that activates the sorbent portion to increase the capacity of ammonia during combined operation of reaction and sorption The term “co-pressed catalyst-sorbent” or “co-pressed catalyst-sorbent structure” as used herein refers to mixing powders or particles comprising a catalyst portion and a sorbent portion before compressed into a structure, such as a pellet, tablet or extrudate, such that the resulting catalyst-sorbent structure retains an internal porosity to aid mass transfer of reactants and products to and from active sites for reaction, sorption, or desorption, and combinations therein. It is understood that the pressed structure comprising a pellet, tablet, ore extrudate may include binders used to assist with materials processing during synthesis whereby said binders are removed after pressing by a thermal process, extraction, or other means that substantially removes the binder material from the finished structure such that the pellet retains internal porosity to accommodate internal mass diffusion of reactants and products.

The term “co-supported catalyst-sorbent” as used herein refers to structures upon which the catalyst and sorbent are supported on the same support particle. The support may be the catalyst itself if the catalyst is self-supported.

The terms “catalyst loading density” and “catalyst portion loading density” as used herein refer to the mass of catalyst in kg loaded or packed within a reaction tube, chamber, or vessel volume, such that the kg/m³ catalyst loading represents the amount of catalyst in the reaction chamber. The mass of catalyst comprises the active catalyst material, any support material for the catalyst, and any additional dopants or additives added to improve stability or activity of the catalyst system.

The terms “sorbent loading density” and “sorbent portion loading density” as used herein refer to the mass of sorbent in kg loaded or packed within a reaction tube, chamber, or vessel volume, such that the kg/m³ sorbent loading represents the amount of active sorbent in the reaction chamber. The mass of sorbent comprises the active sorbent material, any support material for the sorbent, and any additional dopants or additives added to improve stability or activity of the sorbent portion.

The term “cycle time” as used herein refers to the time in hours that a feed of unreacted hydrogen and/or unreacted nitrogen is continuously fed to a first process vessel comprising catalyst-sorbent structure of the present disclosure, wherein the feed of unreacted hydrogen and/or unreacted nitrogen are converted in whole or part to ammonia. In the same cycle time, a second vessel comprising other catalyst-sorbent structure can be undergoing regeneration, whereby the ammonia sorbed during the previous cycle time is removed in whole or part.

The term “feed switch” as used herein refers to the end of the cycle time whereby the feed of unreacted hydrogen and/or unreacted nitrogen is moved to at least a second process vessel comprising other catalyst-sorbent structures whereby the reaction can continue to form ammonia.

The feed of unreacted hydrogen and/or unreacted nitrogen is moved from one or more vessels in parallel to at least a second vessel or set of vessels in parallel by using valves to block flow to one part of the system while opening flow to at least a second part of the system.

The terms “segmented reactor and absorber” and “segmented bed” as used herein refer to a series of reactor and absorber tubes in fluidic communication during each part of the cycle time. The dimensions, operating conditions, and loading of absorbent and/or loading of catalyst may be different or the same in the segmented tubes connected in series.

The term “recycle reactor” as used herein refers to a reactor system comprising a first vessel containing a catalyst to produce ammonia from nitrogen and hydrogen followed by at least a second unit operation that removes ammonia in whole or part from the product effluent exiting the first vessel. The unreacted feed of unreacted hydrogen and/or unreacted nitrogen is recompressed and reheated to the inlet conditions for the first vessel to continue to react.

The term “recycle ratio” as used herein refers to a system whereby the product is selectively separated downstream from the first reactor as one divided by the per pass conversion. The unreacted feedstock of unreacted hydrogen and/or unreacted nitrogen after product separation by absorption, adsorption, membranes, condensation, or some other method is recycled back to the inlet of the reactor. The recycled feed of unreacted hydrogen and/or unreacted nitrogen is recompressed to the inlet pressure and heated to the inlet temperature.

The term “REDOX activation” as used herein refers to one or more process steps conducted prior to operating a catalyst for ammonia synthesis comprising an oxidation step followed by a reduction step in a gas comprising hydrogen. In one embodiment, multiple series REDOX steps are conducted such that a catalyst may be oxidized at least twice with an intervening reduction step and a final reduction step prior to operating a catalyst for ammonia synthesis. The catalyst portion of the present disclosure is operated in a reduced state. In an alternate embodiment, the catalyst undergoes all steps of REDOX activation prior to loading or packing in a reactor tube, such that only the final reduction step is conducted in situ prior to operation.

The term “activation” as used herein refers to a process step prior to operating the catalyst-sorbent for the production of ammonia and sorption thereof, whereby the process increases the activity, capacity, or stability of a catalyst portion and/or sorbent portion. The activation steps can be conducted at a temperature and/or pressure that may be higher, lower, or the same as the operating conditions for the ammonia synthesis reaction. The flowrate and gaseous composition of flowing matter during activation may be different than that during the reactor and sorption operation.

The terms “absorbent transition” or “sorbent transition” or “adsorbent transition” as used herein refer to the uptake of ammonia into the sorbent portion of the catalyst-sorbent by a chemical reaction or formation of a complex. For example, and without limiting the terms “absorbent transition” or “sorbent transition”, wherein the sorbent portion comprises MnCl₂, the uptake can have the following complex formula: MnCl₂-xNH₃+y NH₃→MnCl₂-zNH₃, where x+y=z and x, z may comprise values of 0, 0.5, or integer values such as about 1, 2, 4, 6, or 8.

The term “transition temperature” as used herein refers to the temperature at which the absorbent transition occurs, typically set by a pressure of NH₃.

The term “superficial velocity” as used herein refers to the gas phase velocity at the local temperature and pressure in the open cross section of a reactor tube or vessel.

The term “average residence time” as used herein refers to the average amount of time that reactant molecules spend within a reactor system containing the catalyst-sorbent structure, which is calculated as the reactor length multiplied by the void fraction and divided by the superficial velocity.

The term “metal halide” as used herein refers to a material comprising at least one metal molecule and at least one halide molecule that form a stable molecular complex, wherein the complex has an affinity for ammonia. It is desirable that a metal halide of the present disclosure can remove ammonia molecules from a fluid (such as the gas phase) and retain the ammonia molecules within the stationary phase comprising the metal halide.

The term “zeolite” as used herein refers to a microporous, crystalline aluminosilicate material that has an affinity for ammonia. It is desirable that a zeolite of the present disclosure can remove ammonia molecules from a fluid (such as the gas phase) and retain the ammonia molecules on the surface of the stationary phase comprising the zeolite.

The term “decomposition reaction” as used herein refers to the reverse reaction of ammonia synthesis, whereby ammonia catalytically decomposes to gaseous nitrogen and hydrogen. It is desirable to reduce the rate of decomposition such that most ammonia formed during the synthesis step can be removed from the system for recovery as a valuable process product.

The terms “pellet,” “tablet” and “extrudate” as used herein refers to a granulated structured material of the catalyst-sorbent, whereby the pellet, tablet, or extrudate is configured to be substantially free flowing when packed or loaded into a reactor vessel, and the granulated catalyst-sorbent structure contains internal porosity to aid in diffusion of reactants and products to and from active sites for reaction, adsorption, desorption, and combinations therein.

The term “tpd” refers to the tonnes per day of ammonia nominally formed from the catalyst-sorbent of the present disclosure, wherein a tonne is understood to be 1000-kg of ammonia. While the nominal capacity of the plant disclosed herein relates to 4 tpd, it should be understood that the inventive technology could be applied to smaller or larger capacity systems by decreasing or increasing, respectively, the number of parallel reactor tubes or vessels and/or increasing the reactor length and/or diameter to the extent that performance allows based on heat transfer in a packed bed. In one embodiment, the inventive plant capacity may range from about 1 to 5000 tpd or more, and more preferably from about 2 to 100 tpd of ammonia production.

The present inventors have surprisingly discovered a composition, system and method of overcoming the thermodynamic limits traditionally encountered in converting nitrogen and hydrogen feedstock gases in conversion to an ammonia gas. In some aspects, integrating an active catalyst for ammonia synthesis with a specialty sorbent for ammonia sorption in a common structural component allows for the removal of ammonia essentially as it forms. The sorption can be in the form of absorption, adsorption, or a combination thereof.

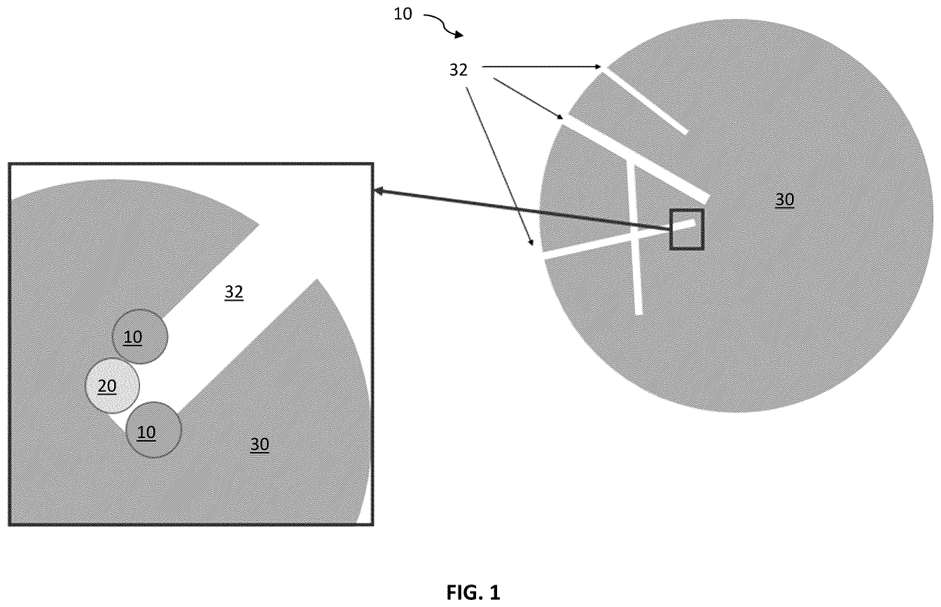

Catalyst-Sorbent Particles and Structures Referring now to FIGS. 1-5, the integration of the active catalyst with the specialty sorbent is disclosed on an individual catalyst-sorbent particle level or a plurality of catalyst-sorbent particles level on a micro-scale level, as well as operable ammonia synthesis structures such as pellets, tables, extrudates or the like, which in some aspects can be comprised of the plurality of catalyst-sorbent particles or in other aspects different micro-scales structures.

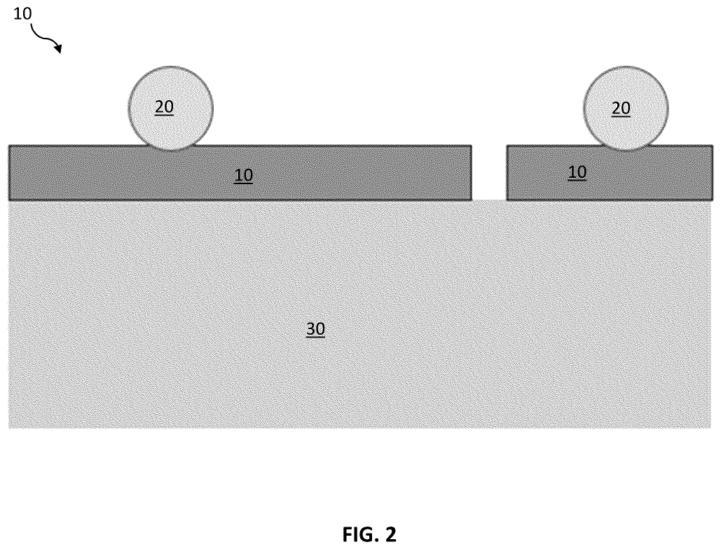

Referring now to FIGS. 1 and 2, the integration of the active catalyst with the specialty sorbent can be in the form of individual catalyst-sorbent particles 10. For instance, as illustrated in FIG. 1, the integration of the active catalyst with the specialty sorbent can have the configuration of an intermixed catalyst-sorbent particle 10, whereby the catalyst portion 20 and the sorbent portion 10 are intermixed with and co-supported on a support material 30, such that each catalyst-sorbent particle comprises a support particle 30 with the intermixed catalyst portion 20 and sorbent portion 10. The catalyst portion 20 and sorbent portion 10 can be found on the surface of the support material 30, such as within a plurality of pores 32 of the porous support material 30. As shown in FIG. 2, the sorbent portion 10 may be in the form of a continuous/discontinuous layer on the support surface 30. While the catalyst portion 20 is shown dispersed on the sorbent portion 10, the catalyst portion 20 can be dispersed on the sorbent portion 10 and/or the support surface 30. Each of FIGS. 1 and 2 illustrate a co-supported catalyst-sorbent particle configuration, according to certain embodiments of the present disclosure.

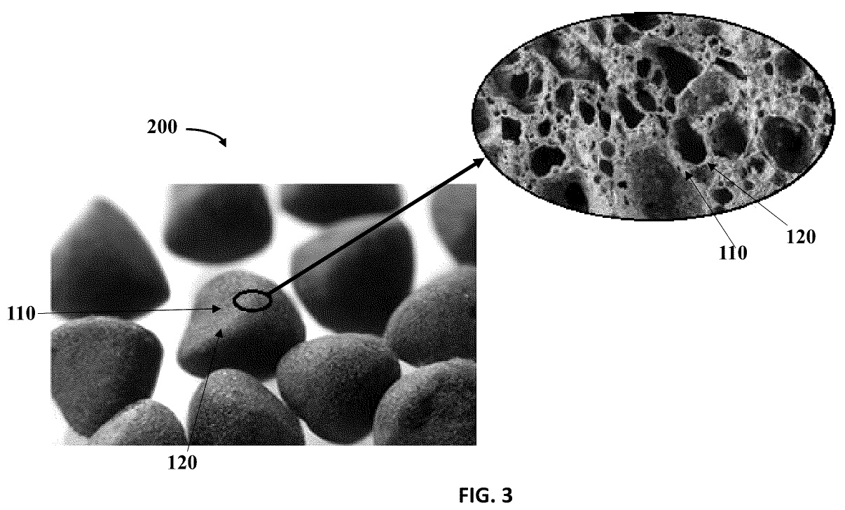

Referring to FIGS. 3-5, various operable ammonia synthesis structures. Referring now to FIG. 3, a plurality of intermixed structures 100 for producing a gaseous product, such as ammonia (NH₃) from a feedstock of unreacted nitrogen and a feedstock of unreacted hydrogen, are shown. Intermixed structure 200 is a granulated catalyst-sorbent structure having a plurality of catalyst-sorbent particles, wherein each catalyst-sorbent particle has a sorbent portion 110 intermixed with a catalyst portion 120. In some preferred aspects, the plurality of catalyst-sorbent particles are compressed into intermixed structure 100. Compressed intermixed structure 200 can be in the configuration of a particle, pellet, tablet, or extrudate. Sorbent portion 110 and catalyst portion 120 can be intermixed into a homogenous mixture or non-homogenous mixture. The exploded oval view of intermixed structure 200 depicts a porosity, which may be straight or tortuous and facilitate gas phase mass transfer through either molecular diffusion or Knudsen diffusion therein.

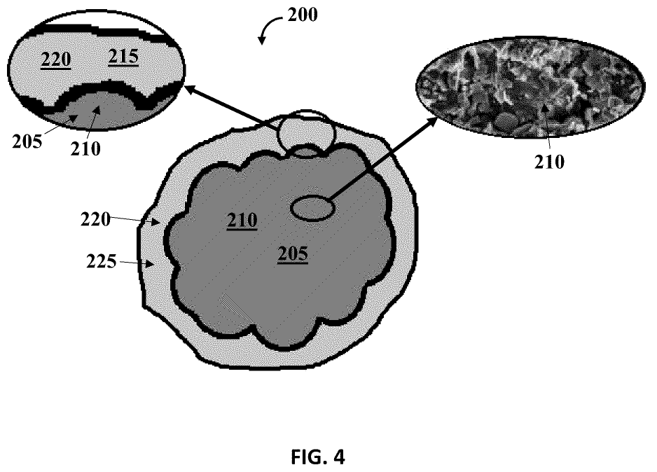

Referring now to FIG. 4 another operable ammonia synthesis structure is shown, which is a single coated structure 200 for producing a gaseous product, such as ammonia (NH₃) from a feedstock of unreacted nitrogen and a feedstock of unreacted hydrogen, is shown. Single coated structure 200 can be a granulated catalyst-sorbent structure having an inner core 205 comprising a sorbent portion 210 and an outer shell coating 215 comprising a catalyst portion 220. In some preferred aspects, sorbent portion 210 is compressed into a desired configuration, such that inner core 205 can be in the configuration of a particle, pellet, tablet, or extrudate. In some aspects, sorbent portion 210 may be supported on a support material, such as a porous support material, such that inner core 205 comprises sorbent portion 210 and the support material. Outer shell coating 215 can form a continuous outer shell essentially encapsulating inner core 205. In some other aspects, outer shell coating 215 can form a discontinuous outer shell, such that outer shell coating 215 at least partially encapsulates inner core 205. In other aspects, outer shell coating 215 may be a continuous-discontinuous structure whereby a portion of outer coating 215 is continuous around the inner core 205 structure and a portion is discontinuous. The exploded oval view of inner core 205 depicts a porous structure of the sorbent portion, which may be straight or tortuous and facilitate gas phase mass transfer through either molecular diffusion or Knudsen diffusion therein. The outer shell coating 215 can have a porous configuration, which may be straight or tortuous and facilitate gas phase mass transfer through either molecular diffusion or Knudsen diffusion therein. The exploded view of the interface between the inner core 205 and outer shell coating 215 depicts intimate contact between the sorbent portion 210 and catalyst portion 220.

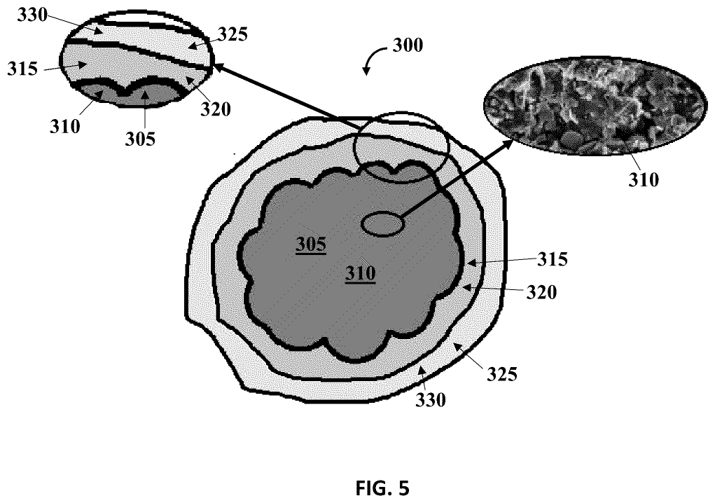

Referring now to FIG. 5 another operable ammonia synthesis structure is shown, which is a double coated structure 300 for producing a gaseous product, such as ammonia (NH₃) from a feedstock of unreacted nitrogen and a feedstock of unreacted hydrogen, is shown. Double coated structure 300 is a granulated catalyst-sorbent structure having an inner core 305 comprising a sorbent portion 310, an inner shell coating 315 comprising a catalyst portion 320, and an outer shell coating 325 comprising a second sorbent portion 330. In some preferred aspects, sorbent portion 310 is compressed into a desired configuration, such that inner core 305 can be in the configuration of a particle, pellet, tablet, or extrudate. In some aspects, sorbent portion 310 may be supported on a support material, such as a porous support material, such that inner core 305 comprises sorbent portion 210 and the support material. Inner shell coating 315 can form a continuous inner shell essentially encapsulating inner core 305. Outer shell coating 325 can form a continuous or continuous-discontinuous outer shell essentially encapsulating inner shell coating 315. In some other aspects, inner shell coating 315 can form a discontinuous shell, such that the inner shell coating 315 at least partially encapsulates inner core 305. Further, outer shell coating 325 can form a discontinuous shell, such that the outer shell coating 325 at least partially encapsulates inner shell coating 315. The exploded oval view of inner core 305 depicts a porous structure of the sorbent portion, which may be straight or tortuous and facilitate gas phase mass transfer through either molecular diffusion or Knudsen diffusion therein. The inner shell coating 315 and/or outer shell coating 325 can also have a porous configuration, which may be straight or tortuous and facilitate gas phase mass transfer through either molecular diffusion or Knudsen diffusion therein. The exploded view of the interface between the inner core 305, inner shell coating 315, and outer shell coating 325 depicts intimate contact between the catalyst portion 320 and respective sorbent portions 310, 330.

The catalyst-sorbent structures can have dual-function materials, wherein the same material may serve two functions. In some aspects, the catalyst-sorbent structures having dual-function materials serve two functions, but the catalyst-sorbent structures contain separate materials for catalytic conversion and sorption that are maintained in intimate contact within the catalyst-sorbent structure, whereby the maximum distance between an sorbent site and a catalyst site is less than the radius of the catalyst-sorbent structure, such as a pellet.

The sorbent portion can be disposed in a discontinuous or continuous-discontinuous sorbent manner within the catalyst-sorbent structure, such that volume expansion is localized to maximize mechanical stability of the catalyst-sorbent structure. This allows the catalyst-sorbent structure to be cycled from at least hundreds to tens of thousands of times without fracture.

Catalyst-sorbent structures of the present disclosure, such as those illustrated in FIGS. 1-3, can comprise a plurality of particles compressed into operable ammonia synthesis structures, such as a pellet, tablet, granule or extrudate, wherein each particle integrates the catalyst portion to be in intimate contact with sorbent portion, which allows for the removal of ammonia essentially as it forms via the catalyst reaction. Alternatively, as provided in FIGS. 4-5, the operable ammonia synthesis structures can have an inner core comprising the sorbent portion, such that the catalyst-sorbent structures provide a different configuration for integrating the catalyst portion to be in intimate contact with sorbent portion, which also allows for the removal of ammonia essentially as it forms via the catalyst reaction. The catalyst-sorbent structure may alternatively be a monolithic structure, such that the catalyst portion and the sorbent portion are co-located on a common monolithic structure, which also allows for the removal of ammonia essentially as it forms via the catalyst reaction, the catalyst portion and sorbent portion preferably configured to be in direct contact on the monolithic structure. By the catalyst-sorbent structures of the present disclosure removing ammonia essentially as it forms, the forward reaction for producing ammonia can continue nearly unabated such that high net conversion can be achieved in a single pass or cumulative within segmented reactors as operated in series during the cycle time before a feed switch.

The catalyst portion of the catalyst-sorbent structures of the present disclosure is capable of converting non-condensable feedstocks comprising unreacted nitrogen and unreacted hydrogen to ammonia, particularly gaseous ammonia. The active catalyst material of the catalyst portion can comprise iron, cobalt, ruthenium, molybdenum, or combinations thereof. It is generally understood that the active catalyst material may be supported on a molecularly or micro or meso-porous support material and may contain other promoters to increase catalyst activity and/or improve catalyst stability. The active catalyst material may be supported on the sorbent material, such that the catalyst-sorbent is supported on a molecularly porous support material and may contain other promoters to increase catalyst activity and/or improve catalyst stability. Alternatively, the active catalyst may be self-supported in a porous form. In some aspects, the sorbent may be supported on the active catalyst.

Support materials for the catalyst portion and/or sorbent portion may be an oxide material or other high surface area porous materials. Exemplary oxide materials include alumina, silica, magnesium, ceria, titania, iron oxides, and combinations thereof. The support material is preferably a molecularly porous support material having an average pore diameter between about 20 nm and about 50 microns, in some aspects between about 50 nm and about 5 microns, and in some preferable aspects between about 100 nm and about 1 micron. The molecularly porous support material preferably has a surface area in a range from about 1 m²/gram to 1000 m²/gram.

The pores in relation to the active catalyst or catalyst-sorbent may be straight or tortuous and facilitate gas phase mass transfer through either molecular diffusion or Knudsen diffusion therein.

The sorbent portion in some preferred aspects comprises one or more metal halide absorbents that has an absorption affinity for NH₃ over unreacted nitrogen (N₂) and unreacted hydrogen (H₂). In some preferred aspects, the sorbent portion comprises one or more metal halides, wherein the metal of the one or more metal halides is chosen from Mn, Mg, Ca, and Fe, Sr and wherein the halide of the one or more metal halides is chosen from Cl, Br.

The sorbent portion can be a metal halide salt chosen from the group consisting of LiCl, NH₄Cl, CoCl₂, MgCl₂, CaCl₂, MnCl₂, FeCl₂, NiCl₂, CuCl₂, ZnCl₂, SrCl₂, SnCl₂, BaCl₂, PbCl₂, NH₄Cl, LiBr, NaBr, MgBr₂, CaBr₂, MnBr₂, FeBr₂, NiBr₂, CoBr₂, SrBr₂, BaBr₂, PbBr₂, NH₄Br, NaI, KI, CaI₂, MnI₂, FeI₂, NiI₂, SrI₂, BaI₂, NH₄I and PbI₂. In some preferred aspects, the sorbent portion is a metal halide salt chosen from the group consisting of MgCl₂, CaCl₂, MnCl₂, FeCl₂ and NiCl. In some other aspects, the one or more metal halide salts comprises MnCl₂, MgCl₂,

CaCl₂, MgBr₂, CaBr₂, MgClBr, CaClBr, MgCaBr and mixtures thereof. Other material absorbents or adsorbents to capture ammonia as it is produced in intimate or near molecular contact with the catalyst are also contemplated.

One preferred sorbent portion comprises the metal halide MnCl₂, which can absorb 6, 2, 1, 0.5, or 0 moles of ammonia per mole of metal halide depending on the operating temperature. For example, with MnCl₂ at an operating temperature from about 260° C. to about 330° C., 1 mole of ammonia is absorbed per mole of absorbent. MnCl₂ at an operating temperature from about 130° C. to about 260° C. can absorb about 2 moles of ammonia per mole of absorbent. Below about 130° C., about 6 moles of ammonia can be absorbed per mole of MnCl₂. Between about 330° C. to about 370° C., about 0.5 moles of ammonia can be absorbed per mole of MnCl₂. Above about 370° C., ammonia is not favored to absorb on MnCl₂.

In some aspects, the sorbent can absorb ammonia in the capacity range of 1-2000 mg_{NH3}/g_{sorbent}, or more preferably, between 5-300 mg_{NH3}/g_{sorbent} within the temperature range of 100-500° C. and pressure range of 1 bar-100 bar.

In some aspects, the sorbent may be a material other than a metal halide, including but not limited to a metal organic framework (MOF), covalent organic framework (COF), Zeolitic imidazolate framework, or zeolite, or other sorbent material that selectively uptakes NH₃ in the gas phase within this temperature and pressure range. More preferably, the sorbent uptakes NH₃ through phase-transitions on the surface or bulk, where a sharp boundary exists between capacities at given conditions as in the exemplary MnCl₂ material.

The sorbent portion of the catalyst-sorbent structures in some other preferred aspects comprises one or more zeolites that has an adsorption affinity for NH₃ over unreacted nitrogen (N₂) and unreacted hydrogen (H₂) on the surface of the zeolite material. The affinity for NH₃ on the surface of the zeolite material can be by chemisorption, physisorption, size exclusion, or combinations thereof. As compared to metal halides that have a step isotherm curve, zeolites typically have a smooth isotherm curve such that NH₃ adsorption increases with pressure/concentration of NH₃ at a constant temperature. Similarly, zeolites have smooth isobar curves, wherein the adsorption of NH₃ decreases with increasing temperatures at constant NH₃ pressure. While it is contemplated that any zeolite may be used as an adsorbent in the catalyst-sorbent particles of the present disclosure preferred zeolites include zeolite Y, zeolite X (especially 13X), zeolite 4A, zeolite 5A, ZSM-5, or a mixture thereof. Each of the foregoing zeolites may be in the hydrogen form, sodium form and/or contain other cations. The other cations of the zeolites include transition metals, alkali metals, or rare earth metals such as Mg, Mn, Cu, Co, Ru, Fe, K, Ce, Cs, Zn, or the like.

While it is contemplated that any zeolite may be used as an adsorbent in the catalyst-sorbent particles of the present disclosure, there may be instances whereby one or more certain zeolites may be preferred based upon various parameters. For instance, some of the major differences between zeolites come from the effective pore size and the material hydrophobicity. If the pore size tends to be on the same magnitude of the gases moving through the sorbent, there can be steric exclusion on internal molecular transport, including internal pellet molecular transport. Since NH₃ is a small molecule with a diameter between 3-4 Å, if the pore size of the zeolite material is near this 3-4 Å diameter, such as for example zeolite 4A having a pore diameter of about 4 Å, then molecules larger than ammonia are typically excluded from the pores based upon size exclusion, whereas ammonia may pass into the pores where it tends to adsorb to oxygen ions or cations within the porous framework.

In some preferred aspects, the zeolite can have a pore size smaller than N₂ and H₂ molecules but larger than NH₃ molecules, such that the pore size effectuates size exclusion of unreacted N₂ and unreacted H₂ but allows for the flow of NH₃. In some aspects, the pore size is between about 3 Å and about 5 Å, more preferably between about 4 Å and about 5 Å. When the zeolite has an effective pore size that is below about 5 Å, the pore size effectuates size exclusion of molecular flow providing selectivity towards NH₃. The size exclusion of the zeolite pores allows NH₃ to pass into the pores but excludes larger sized molecules, including unreacted nitrogen and unreacted hydrogen. Once in the porous framework of the zeolite, the NH₃ tends to absorb to oxygen ions or cations.

In some other preferred aspects, the zeolite has an effective pore size that is much larger than NH₃ molecules. In some aspects, the effective pore size of the zeolite is greater than 5 Å, such as in 13X, whereby selectivity towards NH₃ is achieved via surface properties of the zeolite.

In some embodiments, the surface polarity of the zeolite and its pores may cause preferential binding of polar NH₃ over H₂ or N₂ as measured by a selectivity ratio or sorption capacity ratio of NH₃ over H₂ or N₂. The sorption capacity of NH₃ in some aspects is at least 5 times and preferably 10 times or more greater for NH₃ over H₂ and N₂.

The pore size for commercially available and known sorbents, including zeolites, can be manipulated to a desired pore size. Zeolites are typically found with Na or H forms, wherein the Na or H are the primary cation in the crystalline structure. Ion exchange may partially or fully replace the Na and/or H cations with other metals, such as alkali or transition metals. Changing the metal in the zeolite affects the pore size, which may increase selectivity to NH₃. It can also affect the strength of binding to NH₃, and therefore the capacity that the zeolite has for NH₃ adsorption. In some aspects, a larger ion has a weaker binding to NH₃. The replacing ion may be monovalent, divalent, or trivalent. The electric field within and at the surface of the zeolite may be altered by exchanging ions, and that the result of the ion exchange can be a change in pore size, a change in surface polarity, a change in electric field gradient, and/or a change in hydrophobicity. These changes may result in increased or decreased activation energies and/or binding energies of NH₃ to the zeolite, and therefore may change the NH₃ capacity of the sorbent at a given temperature and pressure. One may appreciate that it is desirable to increase the NH₃ capacity at a given temperature and pressure, preferably between 250-400° C., and more preferably between 300-350° C. It is also desirable to increase the difference in NH3 capacity of a zeolite at a given temperature/pressure pair relative to another temperature/pressure pair, such that ammonia may be separated from a gas stream via a temperature/pressure swing.

In some embodiments, the sorbent is a zeolite chosen from Y, X, 4A, 5A, ZSM-5, or other, that preferentially binds NH₃ over unreacted N₂ and unreacted H₂. The sorbent may include one or more of the foregoing zeolites. In some aspects, the sorbent composition may change radially or axially throughout the reactor bed. For instance, one type of sorbent composition may be desirable towards the entrance end of the reactor where the reactant gases are introduced than at the exit end of the reactor whereby the NH₃ and any unreacted H₂ and unreacted N₂ leave the reactor. In an another exemplary aspect, it may be desirable to have one type of sorbent composition towards the center of the reactor bed than towards the edge of the reactor bed where another sorbent composition may be desired.

In some embodiments, the zeolite may act as both a sorbent and a support. The zeolite may be impregnated or otherwise loaded with an active catalyst or secondary sorbent. In some preferred aspects, the secondary sorbent is another zeolite material. In some other preferred aspects, the secondary sorbent is a metal halide. The secondary sorbent may be a metal halide in the form of a coating or cluster within the pores of the zeolite.

In some aspects, the active catalyst for NH₃ synthesis with a zeolite sorbent may include Fe, Co, Ru, Mo, or combinations thereof. The active catalyst may be loaded in the macropores or micropores of the zeolite and may take the form of a nanocrystal, cluster, coating, or similar. The active catalyst may be in the form of a metal ion. For example, the Na ion of Zeolite 13X can be exchanged with the active ammonia catalyst, such as Ru and/or Co.

In some preferred aspects, the zeolite may be impregnated, ion exchanged, coated, or otherwise loaded with a promoter material. The promoter material is preferably K, Ce, Cs, Ba or a mixture thereof. The promoter material is preferably loaded into the zeolite in an amount greater than 0 and up to about 10 wt %. In an exemplary aspect, it may be beneficial to incorporate Ce into the framework of the zeolite material to enhance catalytic activity, for example with an Ru catalyst.

In some aspects, it may be preferable to reduce an oxide layer in relation the active catalyst to achieve maximum activity. The active catalyst may be reduced by applying a temperature greater than 400° C., such as between about 400° C. and about 500° C. for Fe as the active catalyst, to the catalyst-sorbent particles. Reduction of the catalyst at a temperature between 400-500° C. is typically above the thermal stability of certain sorbents, for example metal halides, which decompose above about 400° C. Therefore, in some other preferred aspects, it may be desirable to have the catalyst pre-reduced prior to integration with the sorbent and into the reactor to remove the need for the reduction procedure in the presence of the sorbent that would otherwise decompose at the reduction temperature.

In some other aspects, decomposition of the sorbent can be magnified by trace water molecules, especially those which absorb spontaneously in the presence of moisture to metal halides, forming metal halide hydrates, for example MnCl2-xH2O. Since NH₃ binds more strongly to sorbents than water, the sorbent may be subjected to ammonia prior to loading or mixing with the active catalyst, such that ammonia is absorbed by the sorbent prior to any high (>300° C.) temperature process. Subjecting the sorbent to ammonia allows the ammonia to be absorbed and replace any previously absorbed water, thus increasing the stability of the sorbent. The form of the catalyst-sorbent structure may comprise a pellet, tablet, extrudate, or granule and is generally understood to encompass any structure that is free flowing while loading the reactor.

The catalyst-sorbent structures in the form of a pellet, tablet, extrude or granule can have an average diameter between 1 mm and 20 mm, preferably between 3 mm and 10 mm, more preferably between 3 mm and 9 mm.

The catalyst-sorbent structures with an outer coating shell can have an outer coating shell having an average thickness between about 3 microns and about 200 microns, preferably between about 10 microns and about 150 microns, more preferably between about 20 microns and about 100 microns.

The catalyst-sorbent structures having one or more inner coating shells can have an inner coating shell having an average thickness between about 3 microns and about 200 microns, preferably between about 10 microns and about 150 microns, more preferably between about 20 microns and about 100 microns.

The catalyst-sorbent structures in the form of a monolithic structure may include a support material. The support material can preferably be a ceramic material, metal oxide such as alumina, or a combination thereof. The support material may be microporous, macroporous, or combinations thereof. The supporting monolith may be impregnated, coated, or otherwise loaded with an active catalyst portion and/or sorbent portion. The monolithic structure may be formed partially or fully from a sorbent material, such as a zeolite, metal halide, or a combination thereof. In exemplary aspects wherein the monolithic structure is formed from a sorbent material, the monolithic structure may be impregnated, coated, or otherwise loaded with an active catalyst portion and/or a sorbent portion, whereby the sorbent portion is additional sorbent material that may be the same sorbent as the monolithic structure or a different sorbent than the monolithic structure.

In some aspects, the monolithic structure formed from a metal oxide or a zeolite may be altered by ion-exchange to incorporate metal cations to alter surface properties and tune affinity for ammonia sorption. Further, the monolithic structure may be silanated, hydrated, doped, or modified by similar methods to change the hydrophobicity of the structure. The monolithic structure may be of a metallic variety, and coated, impregnated, fused, or otherwise loaded with an active catalyst portion and/or a sorbent portion. A metallic monolithic structure may have a higher thermal conductivity than a ceramic, metal oxide, or zeolitic monolithic structure. One of ordinary skill in the art will appreciate that the higher thermal conductivity may be advantageous by quickly heating or cooling the monolithic structure and therefore the active catalyst portion and/or sorbent portion. It may further be appreciated that a monolithic structure can simplify the loading process of a reactor by the loading of single structure rather than a plurality of structures. A monolithic structure may also reduce pressure drop across an active bed by increased total void fraction and decreased tortuosity.

In some aspects, the active catalyst portion and/or sorbent portion loaded on the monolithic structure may take the form of metal ions, or nanocrystals, or microcrystals. Any such monolithic structure may be highly ordered, especially zeolites, by extrusion, by additive manufacturing, or by other manufacturing methods inducing structured 3D periodicity throughout the structure. In some exemplary aspects, the structured 3D periodicity throughout the structure may have the form of a honeycomb, which contains hundreds to thousands of parallel channels or holes, which are defined by many thin walls, in a honeycomb structure. The channels can be square, hexagonal, round, or other shapes. The hole density may be from 30 to 200 per cm². and the separating walls can be from about 0.05 mm to about 3 mm.

The catalyst-sorbent structures preferably have a sorbent portion loading between 5% and 95% by weight, preferably between 10% and 90% by weight, more preferably between 20% and 90% by weight. The catalyst-sorbent structures preferably have a catalyst portion loading between 0.01% and 20% by weight, preferably between 0.25% and 10% by weight, more preferably between 0.5% and 5% by weight. In some preferred aspects, the catalyst-sorbent particle has an active catalyst portion loading less than 5% by weight. The catalyst-sorbent structures preferably have a catalyst portion loading to sorbent portion loading (catalyst:sorbent) ratio by weight of about 1:1 to about 1:300, preferably about 1:1 to about 1:50, more preferably about 1:1 to about 1:10.

The anticipated sorbent portion loading density can be in the range from about 100 kg/m3 to 2000 kg/m³, preferably in the range from about 300 kg/m³ to about 1500 kg/m³, more preferably in the range from about 500 kg/m³ to about 1200 kg/m³. The anticipated catalyst portion loading density is in the range from about 100 kg/m³ to 2000 kg/m³, preferably in the range from about 300 kg/m³ to about 1500 kg/m³, more preferably in the range from about 500 kg/m³ to about 1200 kg/m³.

In some embodiments where an increased cycle time is desired, the weight loading of the catalyst portion can be in a range from about 5 kg/m³ to about 500 kg/m³, preferably from about 5 kg/m³ to about 400 kg/m³, more preferably from about 5 kg/m³ to about 250 kg/m³, while the sorbent portion weight loading can be in a range from about 50 kg/m³ to 1500 kg/m³, preferably from about 150 kg/m³ to about 1400 kg/m³, more preferably from about 250 kg/m³ to about 1200 kg/m³. In some aspects, the ratio by weight of the catalyst portion loading to sorbent portion loading (catalyst:sorbent) can be in a range from about 1:3 to about 1:300.

The process involving the integrated catalyst-sorbent structure of the present disclosure exceeds the equilibrium NH3 composition that would be obtained if the sorbent portion was not used. In some aspects, a nitrogen conversion (in terms of % of stoichiometric conversion of an unreacted nitrogen feedstock to ammonia) may range from about 30 to 99.99%, preferably from 50 to 99.9% and more preferably from about 70 to 99% per pass, wherein the pass is understood to be a single tube or a series of segmented tubes in fluidic communication during one process feed cycle. In some aspects, a hydrogen conversion (in terms of % of stoichiometric conversion of an unreacted hydrogen feedstock to ammonia) can be greater than 70%, in some aspects at least 80% up to 100%, in some other aspects at least 80% up to 99.99%, and in some other aspects at least 80% up to 99%, per pass, wherein the pass is understood to be a single tube or a series of segmented tubes in fluidic communication during one process feed cycle.

The integrated catalyst-sorbent structure of the present disclosure comprises a catalyst portion and a sorbent portion, wherein the catalyst portion is capable of converting an unreacted hydrogen feedstock and an unreacted nitrogen feedstock to an ammonia product and the sorbent portion is capable of absorbing the produced ammonia, wherein the converting of the catalyst portion and absorbing of the sorbent portion are both capable of occurring at a temperature in a range between about 100° C. and about 500° C., preferably between about 200° C. and about 400° C., more preferably between about 250° C. and about 350° C., and even more preferably between about 280° C. and about 330° C., and wherein the converting of the catalyst portion and absorbing of the sorbent portion are both capable of occurring at a pressure in a range between about 2 bar to about 200 bar, preferably between about 5 bar and about 100 bar, more preferably between about 5 bar and about 50 bar, and even more preferably between about 5 bar and about 20 bar.

### Ammonia Production and Capture Utilizing Catalyst-Sorbent Structures

The present disclosure is also directed at a process for producing ammonia, wherein the process comprises providing a catalyst-sorbent structure of the present disclosure in a reactor, preferably as a fixed bed, such as a packed bed, wherein during normal operating conditions the catalyst portion converts an unreacted hydrogen feedstock and an unreacted nitrogen feedstock to an ammonia product, and the sorbent portion captures the produced ammonia.

The catalyst-sorbent structures is preferably arranged within a reactor wherein the catalyst-sorbent structures are loaded in a range between about 0.1% to about 99.9% of the volume of the reactor, preferably between about 10% to about 80%, preferably between about 15% to about 60%, more preferably between about 20% to about 40%, and in some aspects even more preferably between about 25% to about 35%, of the volume of the reactor. It is generally understood that when packed, the inventive catalyst-sorbent pellet will have an interstitial void volume ranging from about 20 to 50%. The defined loading in the volume of the reactor defines the reactor volume portion that contains the packing material without consideration of the interstitial void volume.

The catalyst-sorbent loading in the reactor is preferably at least 10%, in some aspects at least 20%, in some aspects at least 30%, in some aspects at least 40%, in some aspects at least 50%, in some aspects at least 60%, in some aspects less than 95%, in some aspects less than 80%, and in some aspects less than 70%, of the volume of the reactor.

The catalyst portion of the catalyst-sorbent structure can be present in the reactor in a weight range (w/w) between about 0.01% and about 20%, preferably between about 0.25% and about 10%, more preferably between about 0.5% and less than about 5%. In some preferred aspects, the catalyst-sorbent particle has a catalyst portion loading in the reactor that is less than 5% by weight.

The sorbent portion of the catalyst-sorbent structure can be present in the reactor in a weight range (w/w) between about 5% and about 95%, preferably between about 10% and about 90%, more preferably between about 20% and about 80%.

The catalyst-sorbent structure can be present in the reactor in a weight ratio of the catalyst portion to the sorbent portion (catalyst:sorbent) of about 1:1 to about 1:300, preferably about 1:10 to about 1:50, more preferably about 1:15 to about 1:25.

In some preferred aspects, the process for producing ammonia with the catalyst-sorbent structures of the present disclosure have a process cycle that is less than a full sorption capacity of the sorbent portion. In some aspects, the process cycle is at least 20% up to about 95% of full theoretical capacity as defined by the temperature and pressure of operation for the process bed.

The process for producing ammonia with the catalyst-sorbent structures can have an initial process cycle having an initial conversion and a second process cycle having a second conversion, wherein the second conversion has a lower conversion than the initial conversion, in some aspects at least 0.1% lower, and in some preferred aspects between 1% and 10% lower than the initial conversion.

The process for producing ammonia can comprise providing the catalyst-sorbent of the present disclosure in multiple beds. In some aspects, the multiple beds are provided in series. In some aspects, the multiple beds are provided in parallel. In some aspects, the multiple beds are provided in both series and parallel.

The unreacted hydrogen can be provided from a hydrogen source. While the unreacted hydrogen is contemplated to be able to be provided from any hydrogen source, in some preferred aspects the hydrogen source comprises production from water in an electrolyzer.

The unreacted nitrogen can be provided from a nitrogen source. While the unreacted nitrogen is contemplated to be able to be provided from any nitrogen source, in some preferred aspects the nitrogen source is a pressure swing adsorption (PSA) system, air separation unit (ASU) system, membrane separator, or a combination thereof.

In general the process of the present disclosure operates in a cyclic mode, whereby the unreacted feedstocks of hydrogen and nitrogen flow over the catalyst-sorbent structures in a first bed whereby the catalyst portion produces ammonia, and whereby the sorbent portion captures the produced ammonia. The sorbent may comprise an absorbent, adsorbent, or combinations thereof. Before ammonia exits or achieves breakthrough at the end of the tube comprising sorbent and catalyst in intimate contact, the process feeds are switched to a second bed comprising catalyst and sorbent in intimate contact whereby the process continues to form ammonia. The ammonia may only fill a portion of the first integrated reactor-absorber section, with a capacity from about 10 to 99% of theoretical maximum at a given temperature and pressure. After the feed is switched to a regenerated integrated reactor and absorber single or series segmented tubes, the ammonia absorbed in the previous cycle is desorbed. The desorption process is conducted in a manner to remove ammonia from the system and minimize the reverse reaction such that more than 80% of the ammonia produced during the sorption part of the process is captured during desorption, preferably more than 90% is captured, and more preferably still more than 95% of produced ammonia is recovered.

Generally, the absorbent reacts with ammonia per the equation (2) as follows:

$$[ absorbent ] + NH 3 →︀ [ absorbent ] - x NH 3 , \qquad ( 2 )$$

wherein several values of “x” are possible depending on the sorbent material chemistry, temperature, and pressure. The sorbent may be supported on a porous material. The sorbent may primarily absorb ammonia into the bulk of the material while first absorbing into surface molecules. The sorbent may also capture and store ammonia predominantly at the interface of the sorbent and gas phase through chemical or physical sorption or binding.

Following desorption, the gas stream can comprise substantially pure ammonia. In some aspects, the gas stream can comprise ammonia in nitrogen gas ranging from about 0% NH₃ to about 100% NH₃ by volume. In some other aspects, the gas stream can comprise ammonia in a mixture of H₂ and N₂, wherein the ammonia ranges by volume from about 5% to 99%, preferably from about 10% to 99%, more preferably from about 20% to 99%, more preferably from about 30% to 99%, more preferably from about 40% to 99%, more preferably from about 50% to 99%, and most preferably such that ammonia is greater than about 50%.

The gas stream may be pressurized and/or cooled according to the vapor-liquid-equilibrium of the mixture to condense substantially pure NH₃ as defined by a mass fraction exceeding 90% and preferably from about 90% to about 100%, more preferably from about 92% to about 100%, more preferably from about 94% to about 100%, more preferably from about 96% to about 100%, and even more preferably from about 98% to about 100%. The remaining gas can be N₂ with trace ammonia as determined from Vapor/Liquid equilibrium. It is beneficial to choose the conditions for condensation such that the gas stream leaving the condenser unit has minimum NH₃. This mostly-N₂ gas stream may be used to repressurize the process after a lower pressure desorption step, for example through a boost compressor, and re-used as a sweep gas for subsequent or parallel desorption steps.

Alternatively, a pressure swing adsorber may be used downstream of the reactor or combined reactor and adsorber to purify ammonia.

It should be understood in this disclosure that desorption occurs from the sorbent (e.g., an absorbent and/or adsorbent) by raising the temperature of the sorbent and/or decreasing the NH₃ partial pressure at the sorbent, and/or decreasing the total pressure at the sorbent. It is beneficial to operate sorption/desorption substantially isothermally which is defined as a bed thermal gradient from about 0° C. to about 10° C., such that heat can be transferred between modes; otherwise desorption may require higher temperatures and heat exchange using a liquid heat transfer fluid is more complex. In some aspects, a substantially isothermal pressure swing is desired, where beds remain isothermal or near isothermal in each cycle, such as within about 30° C., more preferably within about 20° C., and even more preferably within about 10° C., and pressure is decreased from the adsorption mode to the desorption mode to cause elution of the previously sorbed NH₃.

It may be beneficial to maximize the desorption pressure to simplify a downstream NH₃ condensation/separation step. It is beneficial that the desorption pressure is above the condensation pressure of NH₃ at ambient or near ambient temperature, such that no further pressurization is needed for ammonia condensation at ambient temperature. In some preferred aspects, the desorption pressure is at least about 1 bara, in some aspects at least about 2 bara, in some aspects at least about 5 bara, in some aspects at least about 8 bara, in some aspects at least about 11 bara, in some aspects at least about 13 bara, and in some aspects at least about 15 bara, above the condensation pressure for NH₃ at ambient temperature, wherein the condensation pressure of NH₃ preferably is in the range from about 4 bara to about 15 bara between about −15° C. and about 30° C. It can be beneficial to desorb ammonia at as high a pressure as possible such that minimal cooling (or chilling) is needed to allow NH₃ to condense at the desorption pressure, or, to require minimal recompression to condense NH₃ at a given temperature.

It may be beneficial to maximize the desorption pressure to minimize the backreaction of produced ammonia back to N₂ and H₂, which is more thermodynamically favored at low pressure. It may be beneficial to minimize the pressure of desorption, such that a larger working capacity of the sorbent is available for the cyclic process. In some aspects, the desorbed gas stream pressure is below that of NH₃ condensation at a given temperature, such that the desorbed stream comprising NH₃ may be compressed to favor NH₃ condensation in a subsequent cooling and/or condensation step.

In some aspects following a pressure swing, a desorbed bed can preferably be at a pressure significantly below that of the feed gases as fed to a parallel bed operating in a sorption mode, which in some aspects is preferably an adsorption mode. The total pressure can preferably be more than 3 bar below the feed pressure, in some aspects more than 5 bar below the feed pressure, in some aspects more than 7 bar below the feed pressure, in some aspects more than 9 bar above the feed pressure, in some aspects more than 11 bar above the feed pressure, in some aspects more than 13 bar above the feed pressure, and in some aspects about 15 bar below the feed pressure. In some aspects, the total pressure is between about 1 to about 20 bar below the feed pressure, and in some other aspects between about 5 to about 15 bar below the feed pressure. The unreacted effluent from a bed in the sorbing mode may be fed to a bed having just undergone desorption to re-pressurize the bed. Similarly, there may be an initial depressurization event upon the switch from adsorption to desorption mode, in which unreacted feed gases are rapidly vented from the headspace and interstices of the bed. This unreacted feed gas can be reused N₂ or unreacted gases that exit during the evacuation step, but preferably do not include NH₃. These unreacted feed gases may similarly be fed to a recently depressurized bed to re-pressurize the bed. These unreacted feed gases may also be used as a sweep gas during the desorption step in a parallel bed. A sweep gas that contains H₂ may suppress the back-reaction/decomposition of desorbed ammonia by reducing the equilibrium driving force of the back-reaction.

In some aspects relating to the desorption rates in zeolites, the desorption rate may be limited by mass-transfer kinetics, not bulk desorption kinetics as in metal-halides whereby the rate limiting step typically is the diffusion of the NH₃ from the crystal structure to the surface of the NH₃ (e.g., as an ion). Instead, in the desorption rate in zeolites, the mass-transfer kinetics relates to the desorption from the inside of the pore to the outside of the pore (e.g., as a gas molecule). In the inventive process where the sorbent is a zeolite or combination of zeolites, desorption may be the fastest step in the process cycle. A third, repressurization step may become beneficial. In this step, H₂ and N₂ can be fed into a recently depressurized bed, filling the bed with unreacted and/or inert gases to restore pressure to the desired reaction pressure.

In some aspects, it can be advantageous to maximize the rate of desorption to minimize the residence time of desorbed NH₃ in the reactor and prevent the backreaction. The decomposition reaction will catalytically decompose the product NH₃ back to N₂ and H₂ and is favored at higher temperature and higher catalyst loading. Reducing the reaction time or residence time that the desorbed ammonia spends in contact with the catalyst is essential to maximize the recovery of NH₃. As shown in Table 13 with an iron-based catalyst, for a superficial velocity greater than about 0.01 m/s with a catalyst loading density from about 100 kg/m3 to about 500 kg/m3 at 3 bara the anticipated decomposition conversion of NH₃ is less than about 1.11% at a temperature less than about 330° C. Superficial velocity is defined by volumetric flow at the actual temperature and pressure divided by the open channel cross section. For alternate catalyst compositions, the limiting superficial velocity, temperature, and pressure may be different but are determined based on kinetics, catalyst loading and desorption conditions to maintain a performance of less than 10% decomposition of NH₃ during the desorption step.

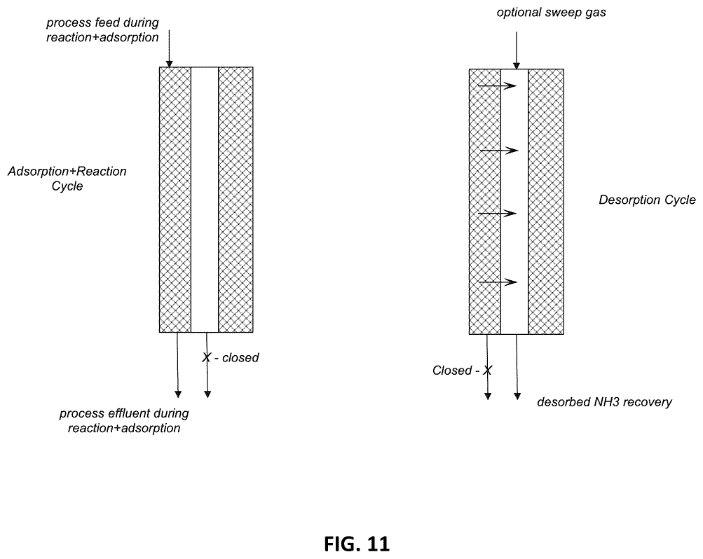

In certain aspects, the inventive process includes an additional fluidic chamber disposed within the packed bed comprising reaction and sorption such that during desorption, the fluid flow is substantially radial not axial. The inventive reactor configuration is first manufactured with an inner porous tube, an annular gap that the inventive sorbent and catalyst can be contained therein, and an outer heat transfer wall to remove the exothermic heat of reaction and adsorption/absorption. After manufacturing, the catalyst-sorbent structure, such as in the pelletized form, is loaded in the annular flow region in a manner consistent with traditional best practices for catalyst loading in tubular or annular reactor chambers. As illustrated in FIG. 11, porous tube or chamber is maintained with a closed outlet during reaction and sorption, but open outlet during desorption, such that the desorbing NH₃ spends a minimal amount of time near the catalyst in order to minimize the decomposition reaction. The length of the reactor bed comprising catalyst that the desorbed ammonia would otherwise need to traverse is reduced by an order of magnitude or more for the radial flow desorption step whereby the product ammonia is more quickly removed from the catalyst to inhibit the decomposition reaction. The radial flow length may range from about 0.02-m to about 0.1-m which represents the packed annular catalyst-sorbent flow chamber. The length of the reactor may range from about 1-m to about 15-m such that the ratio of reactor axial flow length to radial flow length is about 10 to about 750. During the sorption step, the reacting species flow in the axial flow length whereas during the desorption step, the product species flow in the radial flow length. The time for decomposition is reduced about proportionally to the reduction in product specie flow length through the desorption process when in contact with the inventive catalyst-sorbent particles.

### Aspects of the Catalyst-Sorbent Structure and Process

The integrated catalyst and sorbent system can provide better performance than a recycle reactor, where a comparative recycle reactor loaded with an ammonia synthesis catalyst at or near the theoretical packed bed density is operated in a recycle mode. Further, the recycle reactor will require substantial recompression and reheating of the unreacted feed mixture to the inlet of the reactor.

In some aspects, it may be desirable to have a lower weight fraction per reactor volume of catalyst than sorbent. For a sufficiently active catalyst, a lower weight loading is required while a higher weight loading of sorbent will increase the cycle time for a feed switch between moving the feed to a fresh reactor tube to continue the process. After switching the feed to the second bed, the absorbed ammonia is then desorbed in the first bed. The lower catalyst loading can reduce the rate of reverse reaction during desorption. In some embodiments, the weight loading of active catalyst may range from about 5 kg/m3 to 500 kg/m3 while the sorbent weight loading may range from about 50 to 1500 kg/m3. The ratio of sorbent to catalyst may range from about 3 to about 300.

In some aspects, the per pass conversion of nitrogen to form ammonia in the presence of hydrogen (in terms of % of stoichiometric conversion) is at least about 30%, in some aspects from about 30% to about 99%, and in some other aspects from about 50% to about 99%. In some aspects, the utilization of hydrogen in conjunction with the catalyst-sorbent structures is greater than about 70%, and in some aspects from about 80% to about 99%.

In relation to cycle-time to reactor volume ratio, it may be desirable to both decrease the process volume while increasing the cycle time. Reactor volume can be minimized by having more catalyst and less sorbent, which enables the reactor volume to be filled more quickly for desorption and reuse. With less catalyst and more sorbent, then the reactor volume will fill more slowly, and a longer cycle time is possible. It is desirable to have a longer cycle time for longer catalyst and sorbent lifetime, for less mechanical wear and tear on valves, and for a reduced loss of feed that is left inside the catalyst-sorbent structures, between catalyst-sorbent structural interstices, and in open process volume found in headers and footers during each cycle at a feed switch.

In relation to cycle time less than full sorption capacity, the process may be cycled when the absorbent is at least about 20% to 95% full theoretical capacity as defined by the temperature and pressure of operation for the process bed. The conversion drops as the bed begins to fill towards the front of the reactor absorber. The process might run with an initial conversion between about 90% and about 99%, which drops to at least a second conversion that is at least 1% or from 1% to 10% lower than the first conversion. In some aspects, the stability of absorbents is improved by cycling between a limited capacity range and may be improved for a higher coordination number as defined by a transition from 2 to 1 or 6 to 2 moles of ammonia per mole of sorbent.

In relation to operating temperature and pressure, it may be desirable to increase temperature for faster kinetics, while minimizing temperature to obtain a higher sorption capacity, as defined by the moles of ammonia per mole of absorbent or grams of ammonia held per gram of absorbent. It may be desirable to operate at a lower temperature than the phase transition temperature of the absorbent. In one embodiment the temperature is set to enable a high coordination number absorption (e.g., the 6 to 2 mol NH3 per mole of absorbent transition in MnCl₂, which is 4× capacity and ½× as exothermic as the 2-1 transition). The reactor temperature is defined by the wall temperature or the highest temperature in at least a portion of the inventive reactor and absorbent bed. In some aspects, higher pressure NH3 also enables higher absorbent capacity. Choice of reaction and desorption pressures to match with upstream feed compression needs and downstream ammonia compression needs to minimize the process volume, metal weight, thermal input energy and compression energy. In some aspects, pressure and temperature swing considerations. Isothermal or near isothermal with pure pressure swing—substantially all heat can be re-used. Tube walls or other heat transfer areas may be coupled between beds in opposite modes such that sorption and desorption can occur at the same temperature, with the heat of desorption provided by the heat of sorption released. Time and energy wise, small swings are preferred. Considering the tradeoffs for kinetics and capacity, then larger swings may be preferred. In some aspects, sweep gas considerations can minimize dilution of NH3 during desorption while minimizing the reverse or ammonia decomposition reaction. In some aspects, electric heating elements in at least a portion of the tube length can improve the speed of desorption or utilize intermittent energy sources. In some aspects, the catalyst-sorbent structure may be directly heated directly. In other aspects, the catalyst-sorbent bed may be heated or cooled through the tube walls.

In relation to temperature and pressure profiles with a catalyst-sorbent structure having low catalyst loading, the pressure drops as the produced moles of ammonia sorb into or on the solid absorbent and the packed bed heat transfer deteriorates with lower density gas to increase thermal gradients. There can be a balance between catalyst loading, velocity, operating pressure, and temperature that will create combinations where the reactor is in thermal control or has an elevated hot spot that sinters the catalyst or absorbent or reduces the ability of the absorbent to hold ammonia.

In some aspects, there is a segmented process wherein two or more reactor-absorbent beds could operate in series such that each segment is independently optimized by adjusting parameters such as length, diameter, catalyst loading, velocity, temperature, and particle diameter. In some aspects, the segmented process may operate whereby the desorption of the second or more segments occurs after the desorption of the first segment. In some aspects, the desorption of the second or later segment may occur (start or finish) after the feed switch or cycle to the first segment.

In some aspects, the present catalyst-sorbent structure has a redox activation protocol. In some aspects, one or two or more REDOX activation steps are employed prior to running. In some aspects, the REDOX activation can be conducted in both staged reactors or only the first or only a subsequent stage in series to increase activity in a portion of the reactor length. For instance, cobalt is reduced between about 350° C. to about 450° C., with about a range from about 395° C. to about 420° C. preferred. In some aspects, the oxidation step of REDOX can be done ex situ, prior to loading and operation such that only the final reduction step in dilute hydrogen is completed prior to running the ammonia synthesis reaction.

In some aspects, there is an engineered interaction between the catalyst portion sorbent portion. For instance, the sorbent portion may act as a promoter for the catalyst, or, if strongly interacting, may provide a spillover site for intermediates from the catalyst surface to reside, affecting the apparent reaction order with respect to H₂, N₂, or NH₃. Similarly, the NH3 produced at the catalyst surface may be preferentially adsorbed, potentially through a spillover mechanism, by the sorbent portion, altering the apparent reaction order of NH₃. In one embodiment, the apparent reaction order is adjusted by a higher surface concentration of an adsorbed specie which competes with catalyst sites for conversion. The effect may slow the net reaction rate by site blocking or increase the net reaction rate by dislodging otherwise blocking site species. This same effect may increase rates of sorption of NH₃ to the absorbent. The presence of one component may increase site density of the other, increasing surface area to volume ratio and speeding kinetics. Generally, the affinity of the sorbent for NH₃ may change the reaction order of the catalyst for NH₃, and, also generally, a co-supported absorbent/catalyst may perform better than an independently supported mixture due to molecular interactions. In some aspects, it may be beneficial in the present disclosure to increase the apparent reaction rate to produce NH₃ such that the reverse reaction is minimized by the presence of other species that limit adsorption of NH₃ or dislodge NH₃ after formation on catalyst sites. The forward reaction is maximized by the propensity for NH₃ to migrate away from the catalyst surface to a nearby absorbent site thereby creating a molecular mass transfer driving force. In some aspects, the interactions between co-supported catalyst and absorbent imply an optimal loading where performance is maximized, e.g., performance may increase with increasing catalyst loading (assuming constant absorbent loading) until a point where it decreases, or plateaus.

In some aspects, the sorbent portion may have an activation protocol. The sorbent may be activated in part prior to forming the catalyst-sorbent structural components, or alternatively, after loading the catalyst-sorbent structures in the reactor by subjecting the catalyst-sorbent structures to a temperature above that of the sorbent hydration reaction (ie, MY-xH₂O→MY+H₂O), (40° C. to upwards of 400° C., depending on the absorbent), in a substantially dry process gas with no water vapor as defined by less than about 10 millibar vapor pressure. In some aspects, the sorbent may be subjected to formation cycles, wherein the ammonia sorption/desorption process is cycled at least one time through at least the desired capacity range, sometimes exceeding the desired capacity range, such that pulverization or other mechanical change from cycling occurs prior to its final integration in the combined system and the morphology of the absorbent is set before use in the combined system. In some aspects, the sorbent remains unaffected by the reduction or REDOX activation steps required to produce a substantially reduced metal catalyst site for ammonia synthesis in proximity or intimate contact with the absorbent material.

Multiple beds in series, parallel, or series and parallel may be employed that enable operating with low production capacity resulting from variable renewable energy. It may be desirable to couple the process to an energy source that produces time-variable or intermittent amounts of power as found from renewable sources such as wind, solar, tidal, or geothermal. The hydrogen and/or nitrogen generation or purification source may be operated by such intermittent power. In some embodiments the hydrogen source is an electrolyzer. In some embodiments, the nitrogen source is a PSA system, or and ASU system, or a membrane separator, and may be electrically powered. When it is desirable to operate with less power is available than the designed capacity, the nitrogen and/or hydrogen source may be operated with partial capacity or with a turndown below the plant nameplate capacity, such that the feedstock available is only enough to produce a certain amount of the designed NH₃ capacity. In some embodiments, one or more of the nitrogen or hydrogen source may be operated at full capacity while the other is operated at below full capacity, and the excess product may be stored or released.

In some aspects, when it is desirable and/or necessary to produce less than designed NH₃ capacity, the feedstock flow to one or more bed may be stopped such that the bed is maintained in a hot, warm, or cold standby mode such that the idled unit is not in active operation. Cold standby is defined by allowing the unit process temperature to drop to ambient conditions. A warm standby mode is defined by an intermediate temperature between ambient and the full process operating temperature. Hot standby is defined by maintaining the target operating temperature while not in use such that the process can be quickly restarted as defined by restarting in a time ranging from seconds to hours and preferably within 10 seconds to 60 minutes.

In some aspects, the tube containing the bed may be evacuated to remove process gases by reducing internal pressure through depressurization or by vacuum pumping. In some embodiments, the bed may be isolated as-is during a standby mode. The remaining substantially stagnant gases within the bed may react to form NH₃ and may be absorbed into the absorbent. In some embodiments, the heat generated may be actively removed or passively lost due to system thermal losses. In other embodiments, the bed may be thermally isolated when stopping feed flow to reduce cooling loads. The thermal mass of the system may create a sink to collect heat generated by the substantially stagnant feeds present within the system during standby mode.

In some aspects, an idled reactor-sorbent bed may remain at various absorbent states including substantially clean as defined by less than 10% of theoretical capacity, partial as defined from about 10 to about 80% of theoretical capacity, or full as defined from about 80 to 100% of theoretical capacity. The idled process may resume operation after an idle period ranging from less than one second up to 15 days, preferably from about 10 seconds to about 16 hours. Restart may occur by either the reaction and sorption part of the process cycle or through desorption to remove sorbed ammonia remaining in the hardware. Resuming operation through combined reaction and sorption may improve ramp-up times by leveraging the exothermic reactions to quickly heat to the desired temperature. In one embodiment, the flows to the combined reactor and absorber may be different than at steady cyclic operation such that there is more exothermic heat generated in specific locations to increase the temperature of the unit operation from a cold or warm standby mode.

In some aspects, the system shall be configured with valves and piping such that beds can be connected or disconnected in series and or parallel without equipment modification, such that changes can be made in short timescales as defined from about 10 seconds to 60 minutes, preferably less than about 5 minutes.

The inventive process intimately integrates catalytic formation of ammonia from nitrogen and hydrogen with separation of ammonia to reduce the thermodynamic limitation on conversion. The intimate contact of catalyst and absorbent is achieved by achieving close molecular proximity of both materials such that they are retained within a single pellet or other structural component as disclosed herein.

In some aspects, at least one reactor bed contains the catalyst-sorbent structure. Preferably, the reactor contains two or more reactor beds that include the catalyst-sorbent structure, more preferably the reactor contains a plurality of reactor beds that include the catalyst-sorbent structure. In some aspects, the composition of the catalyst-sorbent structure in each reactor bed is substantially the same with respect to the axial length and width of the reactor bed. In some other aspects, the composition of the catalyst-sorbent structure varies down the length of the bed in at least one of the reactor beds, in some aspects in two or more of the reactor beds, and in some other aspects in each of the reactor beds.

In an exemplary aspect, the loading of the catalyst may be higher at the beginning of the reactor bed than at the end of the reactor bed. In another exemplary aspect, the loading of the catalyst may be higher at the end of the reactor bed than at the beginning of the reactor bed. In yet another exemplary aspect, the loading of the catalyst may be higher at an intermediate area of the reactor bed than at the beginning or end of the reactor bed.

In an exemplary aspect, the loading of the sorbent may be higher at the beginning of the reactor bed than at the end of the reactor bed. In another exemplary aspect, the loading of the sorbent may be higher at the end of the reactor bed than at the beginning of the reactor bed. In yet another exemplary aspect, the loading of the sorbent may be higher at an intermediate area of the reactor bed than at the beginning or end of the reactor bed.

In some aspects, multiple reactor beds may be implemented in parallel in a reactor, and the composition of the catalyst-sorbent structure in each reactor bed may be different. In some aspects, one or more of the reactor beds in the multiple reactor bed configuration may have the composition of the catalyst-sorbent structure vary along the axial length, width, or a combination thereof.

In still other aspects, certain reactor beds may have different relative loadings of catalyst:sorbent. In an exemplary aspect, one or more reactor beds may have 100% catalyst while one or more other reactor beds have 100% sorbent. In such beds, multiple catalysts or sorbents may be used and vary down the length of the bed. In some preferred aspects, reactor beds with only catalyst or mainly catalyst would be configured in the reactor to be located prior to other reactor beds in relation to the introduction of the unreacted nitrogen and unreacted hydrogen feedstocks. In some preferred aspects, reactor beds with only sorbent or mainly sorbent would be configured in the reactor to be located after other reactor beds in relation to the introduction of the unreacted nitrogen and unreacted hydrogen feedstocks.

In an exemplary aspect, a first reactor bed having a loading of only catalyst or a higher loading of catalyst than other reactor beds would be located prior to other reactor beds in relation to the introduction of the unreacted nitrogen and unreacted hydrogen feedstocks, a third reactor bed having a loading of only sorbent or a higher loading of sorbent than other reactor beds would be located after other reactor beds in relation to the introduction of the unreacted nitrogen and unreacted hydrogen feedstocks, and a second reactor bed having a mixed loading of the catalyst and sorbent, such as the catalyst-sorbent structure of the present disclosure, would be located between the first and third reactor beds. In some aspects, the second reactor bed comprises one or more reactor beds having the catalyst-sorbent structure of the present disclosure.

The present disclosure contemplates an inventive process whereby a first cycle comprising sorption and reaction is in thermal communication with the desorption process. In one embodiment, concentric tubes can be used, which are packed with the catalyst-sorbent structures that maintain intimate contact. In the first part of the cycle the feed may enter a first bed where the exothermic reaction and sorption occur. The heat generated from the first process is transferred to the adjacent chamber where desorption occurs. The process may be configured as concentric reactor beds such that one bed is maintained in a central core and the second is maintained in an annular region surrounding the first bed. In an alternate embodiment, a heat exchange chamber may be disposed at the core such that both the first and second processes are constructed as annular packed beds. In this embodiment the total amount of reactor volume and metal is reduced by sharing walls with the reaction cycle and the desorption cycle. Further, proximity of the two processes allows for a minimized reactor header and footer volume to allow for higher utilization of the reacting feedstocks of hydrogen and nitrogen.

The desorption energy may be further augmented with the use of resistive heating, whereby heating elements may be embedded in the walls at one or more axial locations to further modify temperature such that the absorbent coordination number decreases and the ammonia absorbed in a previous cycle is more quickly and easily desorbed.

The present disclosure contemplates an inventive system for a pellet or related structured catalyst comprising cobalt that may achieve an increased activity by using two or more REDOX activation steps prior to operation.

Accordingly, the catalyst-sorbent structures of the present disclosure may undergo a REDOX activation prior to use for combined ammonia synthesis and sorption. The catalyst-sorbent structures may undergo successive oxidation-reduction-oxidation prior to loading and operation in the plant such that only the final reduction step must be done in situ prior to operating the plant to product ammonia. The total number of REDOX steps may be two or more for at least a portion of the plant. In one embodiment, a portion of catalyst-sorbent structures loaded in one or more stages is REDOX activated with two more steps while a portion of catalyst-sorbent structures in one or more stages has one or more fewer REDOX activation steps. By this manner, the effective catalyst activity per gram of catalyst in one or more stages is more active than the effective catalyst activity per gram of catalyst in one or more stages.

In one embodiment, the catalyst is more active in the first stage than a second stage. In an alternate embodiment, the catalyst is less active in the first stage than the second stage.

It is desirable to avoid or minimize a catalyst oxidation step within the plant and desirable to load a pre-oxidized catalyst for final in situ reduction. The inventive catalyst may also be reduced in situ before operation or periodically during operation as needed to regenerate the catalyst with feed gas comprising hydrogen.

The present disclosure contemplates that a combined catalyst and absorbent may be deployed in a desired configuration. Unreacted nitrogen and unreacted hydrogen in a first portion of the process may be used to improve desorption of ammonia during the second part of the process cycle by serving as a sweep gas to reduce the time for desorption. The flowrate of unreacted feeds may be combined from two or more tubes to increase the flowrate to a single tube which increases the desorption velocity or reduces the average residence time for desorption.

The combined unreacted feeds from the first part of the cycle may sequentially desorb ammonia from parallel tubes. As shown in Example 5 below, a higher velocity during desorption decreases the residence time which reduces the amount of ammonia lost to decomposition. In the inventive desorption process, multiple tubes as configured in parallel that had been previously operated for combined reaction and sorption in one cycle could be desorbed in a series or series-parallel manner. For an example case with 100 tubes operating in parallel during the reaction and sorption part of the process, then for example the first 10 tubes are desorbed followed by the second 10 tubes and so on to provide for a higher velocity during desorption than during reaction and sorption.

In one embodiment, the inlet superficial velocity during desorption is more than 1.2 times greater than the outlet superficial velocity during the combined sorption and reaction such that the desorption tubes are processed in a partially sequentially mode. In other embodiments, the inlet superficial velocity during desorption is from 1.2 to 1500 times higher, preferably from about 1.5 to 1000 times higher, and more preferably from about 2 to 100 times higher than the outlet superficial velocity of the combined reaction and sorption stage.

In one embodiment, the desorption process is enhanced by using a reduced inlet pressure at the tube inlet to aid in the desorption of ammonia from the sorbent.

In an alternate embodiment, the desorption process is further enhanced by increasing the temperature to help release absorbed ammonia from the solid absorbent. As the temperature is raised above a critical value that reduces the coordination number of absorbed moles of ammonia per mole of sorbent and thereby aids in desorbing the produced product. For the absorbent MnCl2, the temperature is increased to about 300 to 400° C., preferably from 330 to 390° C. and more preferably from about 350 to 380° C. the metal halide can no longer retain the same number of moles of ammonia per mole of absorbent.

In one embodiment, a hot heat transfer fluid stream, such as a hot oil or equivalent, may be used from the first part of a series process which comprises a catalyst only. In this example, the first part of the process may react from about 10 to 40% of nitrogen to form ammonia with a peak temperature higher than that allowable with an integrated catalyst and absorbent system. The corresponding heat transfer fluid as operated in a co-current or countercurrent mode in the first series process may then flow to the desorption stage of the process. The desorption may be conducted sequentially such that the hot heat transfer fluid from the first reactor-only stage is fed to a portion of the desorption tubes for a time less than the cycle time before moving to at least a second portion of the desorption tubes. All desorption tubes are sequentially regenerated to be substantially cleaned of absorbed ammonia before starting a fresh reaction and sorption cycle. Substantially cleaned means from about 50 to 99.9999% removal of absorbed ammonia, preferably from about 50 to 99.999% ammonia removal, and more preferably from about 85 to 99.999% ammonia removal prior to a cycle switch whereby the previously cleaned desorbed bed is re-used for fresh reaction and sorption.

In an alternate embodiment, unreacted feedstock as present from other unit operations in the system, including a final condensation step to capture substantially neat ammonia for packaging and sale may be used to aid in desorption to augment the sweep gas velocity in whole or part such that the desorption velocity is increased, and the desorption average residence time is decreased to reduce the amount of ammonia decomposition and maximize the production rate of valuable ammonia product.

In an alternate embodiment, unreacted feedstock gathered after a final ammonia purification step that may comprise an ammonia condensation or other unit operation or gathered as effluent from the combined sorption and reaction process or from the desorption process, or combinations thereof may be fed to a second and smaller integrated reaction and sorption reactor system. The second integrated reaction and sorption system may be smaller than the first integrated reaction and sorption system as defined by a reduced inlet process mass flow or process volume or combinations thereof. The inlet pressure to the second integrated reactor and sorption system may be lower than the inlet pressure to the first integrated reactor and separator system to minimize gas compression costs while achieving a higher net overall process conversion of nitrogen and hydrogen to ammonia. The overall production rate of ammonia is driven by the inlet feed rate to the first process multiplied by the conversion and reaction stoichiometry in the first process added to the inlet feed rate to the second process multiplied by the conversion and reaction stoichiometry in the second process minus loss of ammonia to decomposition during desorption.

The present disclosure contemplates gas collected during and after each desorption cycle to comprise ammonia, as well as unreacted nitrogen and unreacted hydrogen. The concentration of ammonia is anticipated to be substantially higher than the concentration of unreacted nitrogen and unreacted hydrogen with a mole fraction from about 0.4 to 0.999999, preferably from about 0.5 to 0.99999, and more preferably from about 0.8 to 0.9999. The concentrated ammonia gas mixture can be desorbed at anticipated pressures lower than the inlet pressure of the first sorption and reaction cycle. The gas is anticipated to flow through unit operations that may include one or more heat exchangers and/or a condensing system to capture purified liquified ammonia for product use and sale.

The condensation of ammonia is expected to follow vapor-liquid equilibrium that is a function of both temperature and pressure. Condensation is an exothermic process, whereby heat must be removed to enable phase change of gaseous condensable ammonia to a liquid form. The fixed gases of nitrogen and hydrogen are non-condensable in the anticipated condensation process operating conditions. The plant may be thermally integrated such that heat removed during cool down and or ammonia condensation can be re-used in the process. In one embodiment, the heat removed may be recuperated to reheat non-condensable gases in whole or part prior to re-use in a second integrated sorption reaction system.

In one embodiment, the outlet desorption mixed gas comprising ammonia, nitrogen, and hydrogen may be gathered at a temperature from about 200° C. to about 400° C., preferably from about 300° C. to about 395° C., and more preferably from about 330° C. to about 390° C. The gathered process stream may enter a heat exchanger or combined heat exchanger condenser system such that the gathered desorption stream is cooled to about −10° C. to about 60° C. where condensation may occur depending upon the operating pressure as following phase equilibrium. For example, at about 50° C., the condensation pressure is about 20 bara, at about 20° C., the condensation pressure is near 8 bara, and at −10° C. the condensation pressure is about 3 bara.

In one embodiment, a recuperative heat exchanger transfers heat in a countercurrent mode between an inlet desorption stream at 3 bara from a temperature of 380° C. down to about 25° C. against a stream of collected non-condensable gases exiting the condensation unit operation as it flows in from about −10° C. and heated to about 300° C. in a countercurrent heat exchanger for use in a second integrated reactor-sorption system. The heat exchanger may be compact or intensified to reduce process volume or it may comprise a conventional shell and tube heat exchanger.

In one embodiment, heat exchangers and or one or more condensers may use a separate working fluid to augment heat transfer to further cool fluids to condensation conditions by using either a separate cooling fluid or a heat transfer fluid that flows as a single phase in closed loop configuration or that vaporizes at a temperature near the condensation temperature. By this manner, effective condensation could be achieved by removing the heat of condensation for ammonia by closed loop vaporization of a heat transfer fluid so that the enthalpy is transferred from the ammonia condensation stream to the vaporizing working fluid stream. Energy collected in the closed loop vaporizing fluid stream or single-phase heat transfer loop could be rejected to ambient with the use of cooling towers in part or whole. Alternatively, energy gathered with a closed loop vaporizing stream could be re-used in whole or part elsewhere in the process.

The present disclosure contemplates one or more reactors may be configured as a shell and tube process, wherein either the shell side or the tube side of the one or more reactors is packed with the catalyst and/or sorbent and/or the catalyst-sorbent structure of the present disclosure.

In some aspects of the active materials being packed in the tubes, the tubes may operate in series or in parallel. Individual tubes within a common shell may each be in either sorption mode or desorption mode; or each tube within the same shell may be operating within the same mode.

In some aspects of operating in the same mode, the shell may be circulated with a heat transfer fluid—in sorption mode, the heat transfer fluid may remove heat from the tubes. This heat transfer fluid may be directed elsewhere in a plant, such that the heat can be used. Preferably, the heat transfer fluid may circulate to a second (or plurality) of tubes operating in the opposite mode. For example, the heat transfer fluid may take heat from a reactor with all tubes in sorption mode, and then circulate to a reactor in desorption mode. The heat transfer fluid may take the form of a boiling liquid that when partially evaporated can remove heat at the exterior of the reactor wall.

In some aspects of the tubes within a common shell being in different modes at the same time, they may be configured as a bundle such as to provide thermal communication between each other. The heat transfer fluid may pass heat between individual tubes in opposing modes, or the fluid may pass heat between bundles of tubes in opposing modes. The shell may be segmented, baffled, or otherwise separate streams of heat transfer fluid.

Recognizing that some catalysts require reduction at temperatures higher than that of commonly available liquid heat transfer fluids, inventive processes may integrate resistance or other heating elements or other methods to achieve a preferred catalyst reduction temperature.

Desorption may require temperatures higher than commonly available liquid heat transfer fluids. A secondary heat source may be integrated into the reactor in the form of a resistive heater, inductive heater, or similar. It may also take the form of a gas preheater upstream of a reactor unit. A secondary benefit of any such device is increasing the rate at which a bed can heat from a cold state, which is beneficial for fast production ramp-up from an ambient or standby condition.

Increasing the fixed bed reactor and sorbent diameter may reduce the mass of steel needed for the plant, recognizing that the metal wall thickness will increase with increasing diameter to withstand the process temperature and pressure, but fewer tubes are needed for an otherwise equal production capacity. Smaller tube diameters may necessitate more tubes per plant which in turn increases the total metal needed for a fixed ammonia production capacity. Smaller tube diameters will be more responsive to thermal changes which reduces plant startup and dynamic load change response time.

Heat transfer into and out of a larger tube diameter for a packed bed process may respond more slowly than for a smaller diameter bed with the same wall conditions or wall heat flux. The bed may be set with stages with intervening heat transfer between the bed of catalyst and sorbent. Alternatively, a bed may have multiple gas inlets down the axial length of the bed. A colder process gas may be introduced at the multiple gas inlets to cool the bed and gas stream. The multiple gas inlets have the additional advantage of adding molecules to the system; this is beneficial to compensate for the molecules lost to reaction to ammonia and sorption, which would otherwise decrease the pressure down the length of the bed. Introducing process gas at multiple points throughout the bed may increase pressure stability.

Increasing the bed diameter can reduce the total plant mass of steel needed for a fixed production capacity but heat transfer through a larger diameter bed is less effective than a smaller diameter bed with the same wall conditions. In one aspect, a cooling media may be contained within the packed bed, that comprises, a tube, coil, or similar fluidic chamber through which a heat transfer fluid may flow. Internal heat transfer chambers come with a secondary advantage of reducing the cross-sectional area of the bed and therefore increasing the superficial velocity of the process gas, and therefore increasing rates of heat transfer between the process gas and innovative pellet that contains catalyst and sorbent.

In certain aspects where a heat transfer fluid cools the reactor, this fluid may be placed in thermal communication with a steam generator. Steam may be coupled with an electrolyzer, in particular a solid oxide electrolyzer. The fluid may alternatively be placed in thermal communication to provide heat to any electrolyzer for hydrogen generation, thus improving the efficiency of the plant.

The heat transfer fluid may be implemented as a thermal energy storage mechanism, where the fluid system is adequately insulated to retain heat over hours, days, weeks, or longer. The fluid may be evacuated from the reactor shells and may be stored in a tank to minimize heat loss. The still-hot fluid may then be recirculated through the reactor shells to re-heat the reactor bed.

The present disclosure contemplates employing a sufficiently active ammonia synthesis catalyst, such that the reaction temperature may be sufficient to operate the active sorbent, which may comprise a metal halide or other absorbent, adsorbent or combinations thereof in a range where more than one mole of ammonia is held per mole of active absorbent. For the case of a MnCl₂ absorbent, it is anticipated that at a temperature from about 130° C. to about 260° C., then two moles of ammonia may be held per mole of absorbent.

In one embodiment, the combined reactor-absorbent system is operated at a temperature of 320° C. wall and inlet for a catalyst of equivalent activity to that described in Example 2 below, with 150 kg/m³ of catalyst loaded with more than 800 kg/m³ absorbent, a diameter of about 0.02 meters, a length of 10 meters, a pressure of 40 barg, a feed ratio of 3:1 H₂ to N₂, and other catalyst pellet dimensions as described in Table 10. For an inlet superficial velocity of 1e-4 m/s, the initial conversion of nitrogen is about 95.7% and the cycle time is from about 50 to 60 hours. The number of tubes for this example is about 23,000 for a 4 tpd ammonia production system.

In an alternate case, the diameter is increased to 0.04-m to reduce the number of tubes to about 5600 for a conversion at equal conditions of about 96.6%. The temperature rise in the larger diameter bed has increased from about 1° C. to about 3° C. with a cycle time within the same range. Alternatively for this example, an increase in the tube diameter to 0.06-m further reduces the number of tubes to about 2300 with an initial conversion of 96.3% and a cycle time between 50 and 60 hours.

It is generally understood that operating at a temperature below about 330° C. (for the case of MnCl2 used as an absorbent) will allow for more than one mole of ammonia to be absorbed per mole of active absorbent which is desirable to enable longer cycle times. It is desirable to have cycle times from about 1 to about 200 hours, preferably from about 4 to 100 hours, and more preferably from 8 to 60 hours. A higher absorbent capacity as defined by moles of ammonia held per mole of absorbent will enable a longer cycle time.

At each cycle switch, the unreacted gases of nitrogen and hydrogen that are held within the porous pellets, within the interstices between pellets, and within the header and footer of the tube assembly will either be lost to a purge stream thereby lowering the mass efficiency of the process or join the desorbing ammonia which flows to a separate unit operation for purification which may include condensation. The unreacted feed gas after the ammonia purification step may be lost or it may be further converted in a separate reactor and or reactor-absorber system. It is desirable to reduce the mass flowrate of this non-condensable gas stream such that further utilization or conversion may occur in a smaller process volume. Achieving longer cycle times may be advantageous for the combined reaction-sorption system.

The present disclosure contemplates that the inventive reactor-absorber system may comprise two or three or more segments connected in series where flow continuously travels from the first to subsequent segments within a process cycle before the feed is switched to a parallel reacting and absorbing system. In one embodiment, a first reactor segment comprises a catalyst while the second reactor segment comprises a catalyst and an absorbent in intimate contact within a catalyst-sorbent structural component, such as a pellet.

In an alternate embodiment, two reactor segments operating in series each comprise a catalyst and sorbent in intimate contact within a catalyst-sorbent structural component, such as a pellet. The first and second segment may have different tube diameters and lengths, and/or different catalyst and/or absorbent loading density within the catalyst-sorbent structural component.

In one embodiment, the inventive reactor-absorber system may have three segments in series whereby the first segment comprises a catalyst while the second and third segments comprise a catalyst and absorbent in intimate contact within a catalyst-sorbent structural component, such as a pellet. The number of tubes in each segment may be the same or different between segments. In one embodiment, the first segment may have 10% fewer tubes than the at least second segment, or preferably from about 10 to 95% fewer tubes, and more preferably from about 20% to 90% fewer tubes.

The number of tubes in two segments connected in series comprising catalyst and sorbent in intimate contact may be from about 1 to 100 for the first to second series segments or may be from about 100 to 1.

In one embodiment, a hybrid two segment series integrated reactor and absorber may operate with a first segment of 8-m in length and a second segment of 2-m in length, where the catalyst loading density for a catalyst of equivalent activity to that described in Example 3 (below) is 125 kg/m³ in the first segment and 150 kg/m³ in the second segment with an absorbent density of 800 kg/m³ in both segments as operated at 40 barg and a tube diameter in the first segment of 0.04-m and a tube diameter of 0.03-m in the second segment with a wall temperature of 305° C. in the first segment and 310° C. in the second segment. The net reactor volume for the two-segment series integrated reactor and absorber can maintain a peak internal bed temperature below 330° C. such that the absorbent may capture or absorb about one mole of ammonia per mole of absorbent. The net volume for the two-segment series reactor is less than 50% of the volume for an equivalent length tube with a diameter of 0.03-m. The outlet of the first segment flows into a second segment with the same mass flow and composition. In this case a higher feed velocity can be used for the two-segment reactor by adjusting the catalyst density, tube diameter and length, and temperature such that the internal bed temperature rise maintains a value below the temperature transition point where the absorbent can no longer hold one more of ammonia per mole of absorbent.

It is generally understood that depending on the catalyst activity and temperature switch points, that the specific hybrid design for each of two or more segments may be optimized.

In an alternate embodiment, a reactor system with two or more series segments may be operated such that the desorption process may occur in a manner to first desorb a first segment or segments for multiple tubes operating in parallel and then desorb a second integrated reactor and absorber segment or segments that operate in parallel. In one embodiment, the desorption of a second segment may start before, during or after the switch of the feed to the first segment. In the inventive process whereby the desorption of the second segment starts after the feed is switched back to the first segment in the series, the unreacted nitrogen and hydrogen that exits the first segment may serve as a desorption aid or sweep gas to the second segment. The temperature in the second segment may be increased to aid desorption by use of a heat transfer chamber surrounding one or more tubes operating in parallel whereby the temperature of the heat transfer fluid is higher than the temperature of the heat transfer fluid in the first segment by the re-use of exothermic heat obtained from a catalyst-only reactor and/or from a combined catalyst and absorber tube or tube bundle elsewhere in the system.

In an alternate embodiment, the tubes may include the use of electrical resistance or induction-based heating to increase the wall temperature to aid with desorption of ammonia. It is desirable to allow for digital control of the temperature such that there may be two or more thermal zones achieved by electrical means on any segment within the inventive process.

The present disclosure contemplates an integrated reactor and absorbent system operated with segments in series whereby the conversion on the first and subsequent segments is maintained at a value between about 30 and 90% such that a relatively higher gas superficial velocity may be used in the first segment to improve heat transfer while achieving a lower conversion. The convective component of pellet heat transfer and associated heat transfer of gas to a wall is increased with higher superficial velocity. With improved bed heat transfer, larger tube diameters may be used to reduce the total number of tubes for a plant at equal production capacity along with the associated cost of metal, flanges, piping, and assemblies. The unreacted feed from the first segment, with the conversion in the defined range, may then be sent to a separate separation stage that comprises absorption, adsorption, or combinations thereof to separate the produced ammonia. The unreacted feed may then flow to a second reactor and absorber system to continue reaction for a higher net or overall feedstock utilization.

The pressure of the second integrated reactor and absorbent system may be the same, lower, or higher than the first integrated system. For a pressure lower in the second system than the first system, little to no gas compression is required. It is desirable to operate systems in series such that each of two or more systems operates with a lower pressure to avoid or minimize gas recompression and associated plant complexity, unit operations, and cost.

In one embodiment, three reactor-absorbent segments are operated in series as described in Table 1 with the catalyst of equivalent activity to that described in Example 3 (below), wherein the three segment integrated reactor and absorber can minimize volume and metal weight by operating each stage with higher velocity, lower conversion, and higher tube diameter.

TABLE 1
Three segment integrated reactor and absorber.

| | Catalyst | | | | | | | | Reactor | Metal | Total metal |
|---|---|---|---|---|---|---|---|---|---|---|---|
| | loading | | | Superficial | | | Stage | | Volume | weight, | weight |
| Segment | density, | Length, | Diam, | velocity, | P, | T_wall, | conversion, | Number | (half, m3 | (half | (full cycle), |
| number | kg/m3 | m | m | m/s | bara | C. | % | of tubes | cycle) | cycle), kg | tonnes |
| 1 | 300 | 3.75 | 0.07 | 0.01 | 41 | 270 | 39.6% | 389 | 5.6 | 8019 | 16.0 |
| 2 | 200 | 3.75 | 0.07 | 0.01 | 31 | 270 | 44.2% | 278 | 4.0 | 5738 | 11.5 |
| 3 | 150 | 5 | 0.04 | 0.01 | 21 | 270 | 89.9% | 345 | 2.2 | 5591 | 11.2 |
| NET overall | | 12.5 | | | | | 96.6% | | 11.8 | | 38.7 |

A reduction in the number of tubes, reactor-absorber volume, and/or metal weight may be achieved by operating the integrated-reactor absorber in segments such that the diameter and velocity may be increased which lowers the segment conversion but when operated with multiple segments in series the overall net conversion of nitrogen may remain high.

In one alternate embodiment the series segmented reactors may be regenerated to desorb the absorbed ammonia in a sequential fashion such that the desorption of at least one segment is occurring during the sorption in the first segment.

The following examples provide further disclosure of the present invention. It should be understood, however, that the intention is not to limit the claimed inventions to the particular embodiments described in the following examples, which are for exemplary purposes only.

### EXAMPLES

### Example 1

The production of ammonia with highly active Cobalt-based catalysts is described by Gao and coworkers. The 2017 publication provides data for low temperature production of ammonia from nitrogen and hydrogen for Cobalt as supported on carbon nanotubes and tested at 10 bara. Gao reported reaction orders for hydrogen and ammonia at 0.58 and −1.27 respectively. A set of power law kinetics were fit to the available data as published by Gao and coworkers. The form of the reaction rate expression included a standard equilibrium form for thermodynamic consistency. The value for the equilibrium constant was provided by Sehested and coworkers, 1999.

The rate of ammonia production is described below such that the rate of nitrogen consumption is half of this rate.

$$rate = k 0 {e}^{- \frac{Ea}{RT}} {P}_{H 2}^{0.58} {P}_{NH 3}^{- 1.27} ( {P}_{N 2} - {P}_{NH 3}^{2} / ( K\_eq {P}_{H 2}^{3} ) ) in moles / g\_cat / min$$

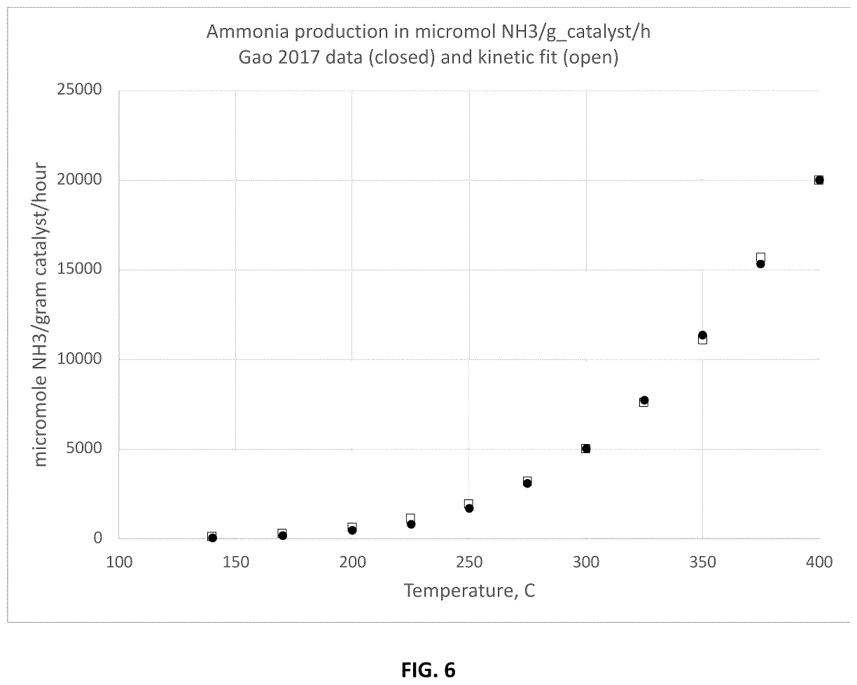

K_eq=2.03E-12 exp(101600/R/T), in units of bar\hat{ }−2 and T in units of K
Ea=106.853 kJ/mol
k0=1218.81 mole/g_cat/min/bar\hat{ }−0.31
   FIG. 6 shows the production rate of ammonia per gram of catalyst per hour as reported in Gao 2017 in closed circle shown with the present kinetic fit as shown with open squares. Kinetic parameters were fit using an automated genetic algorithm that couples DAKOTA with commercial DETCHEM PBR reactor codes to optimize parameters for minimized residuals. The fit value of kinetics for the Co-based catalyst shown in Gao were evaluated in a recycle reactor to benchmark anticipated performance for a comparative system to the present invention. The Gao data and the modeled kinetic fit data are shown in FIG. 6, wherein the production rate of ammonia per gram of catalyst per hour as reported in Gao 2017 is depicted in closed circles and the present kinetic fit modeled data is depicted in open squares.

TABLE 2
Recycle reactor performance in an iso-thermal
reactor to produce 4 tpd NH₃.

| | Per Pass | | Recycle | Reactor | Tube |
|---|---|---|---|---|---|
| Temp. | Conversion | Recycle | Reactor | Tubes | Metal |
| (° C.) | % | Ratio | Vol. m³ | (No.) | Weight, kg |
| 280 | 7.0 | 14.3 | 86.1 | 1097 | 85171 |
| 290 | 8.4 | 11.9 | 73.0 | 930 | 72226 |
| 300 | 10.0 | 10.0 | 62.4 | 795 | 61740 |
| 310 | 11.8 | 8.5 | 53.7 | 684 | 53145 |
| 360 | 23.0 | 4.4 | 30.0 | 383 | 29705 |
| 370 | 24.5 | 4.1 | 28.6 | 364 | 28279 |
| 400 | 22.4 | 4.5 | 32.7 | 417 | 32347 |
| 405 | 21.4 | 4.7 | 34.5 | 439 | 34069 |

For the table summarized in Table 2, the results are based on the input conditions as summarized in Table 3. Temperature refers to a constant wall temperature and inlet gas temperature. Velocity is superficial as calculated at the inlet temperature and pressure.

TABLE 3
Input conditions for results as shown in Table 2.

| Parameter | Value |
|---|---|
| Pressure, bara | 41 |
| Capacity, tpd | 4 |
| Tube length, m | 10 |
| Tube diameter, m | 0.1 |
| Superficial velocity, m/s | 0.01 |
| Feed ratio (H₂:N₂) | 3 |
| Wall thickness, mm | 3 |
| Metal density, kg/m³ | 8000 |
| Catalyst loading density, kg/m³ | 1200 |
| Pellet diameter, mm | 3 |
| Pellet thermal conductivity, W/m-K | 1 |
| Mean internal pore diameter, μm | 1 |
| Internal porosity, % | 50 |
| Tortuosity | 3 |
| Pellet Shape | spherical |
| Bed Void Fraction | 0.4 |

It is noted that the inlet mole fraction of ammonia is set at a low but non-zero value to avoid a mathematical singularity with the form of the rate equation which contains a negative order with respect to ammonia partial pressure. A sensitivity for this value selects a sufficiently low value that does not affect results and is in the range of an inlet mole fraction between 1e-5 to 1e-7.

The recycle ratio, RR, is calculated and performance evaluated for the recycle system where all ammonia is removed in a series downstream ammonia separation step. Ammonia may be separated by absorption, adsorption, condensation, or other methods.

The inlet feed into the reactor is calculated as the fresh feed rate based on a mass conversion rate of 100% to achieve the plant nameplate capacity and multiplied by the Recycle Ratio as defined. A mass balance confirms that the produced ammonia from the reactor for each test condition equals the target plant production capacity. An overdesign factor of at least 1%, or a range from 3-15% with preferably a range 3 to 10% is anticipated for an industrial system to account for system losses in downstream unit operations.

The design calculations are based on an ammonia production plant capacity of 4 tpd. A similar set of analyses were conducted using the kinetics fit for the Co-based catalyst from Gao 2017 for a non-isothermal reactor which includes pellet internal pore diffusion of reactants and products as presented in Table 4. Similar reactor assumptions were used as described in Table 3

TABLE 4
Recycle reactor performance in a non-isothermal reactor for 4 tpd.

| | Per pass | | Recycle | Number of | | Peak Bed |
|---|---|---|---|---|---|---|
| Temperature, | conversion, | Recycle | Reactor Vol, | Reactor | Tube Metal | Thermal |
| C. | % | Ratio | m3 | Tubes | Weight, kg | gradient, C. |
| 290 | 8.6% | 11.587 | 71.1 | 905 | 70293 | 8 |
| 360 | 23.8% | 4.195 | 28.9 | 368 | 28609 | 32 |
| 370 | 25.2% | 3.976 | 27.9 | 355 | 27547 | 38 |
| 390 | 24.2% | 4.139 | 29.9 | 381 | 29567 | 51 |
| 400 | 22.4% | 4.466 | 32.8 | 417 | 32386 | 56 |
| 405 | 21.4% | 4.67 | 34.5 | 439 | 34088 | 58 |

The kinetics as fit from Gao 2017 were used to evaluate the expected performance improvement if utilized in the inventive reactor that intimately integrates catalyst and absorbent. A typical catalyst loading density for a commercial pelletized reactor may range from about 800 to 2000 kg/m3. Some catalysts may be outside this range as is the case for high iron-based catalysts. Lower catalyst densities can be achieved by the inventive system through the structures of intermixed structure, single coated structure, or double coated structure embodiments.

For a highly active catalyst as described by Gao 2017, it is challenging to operate with a high volumetric catalyst loading to obtain a high per pass conversion while maintaining a peak temperature below about 330 C such that the ammonia will continue to absorb with a 1:1 molar ratio with the metal halide. Results are shown in Table 5 where the temperature may exceed the limit for ammonia absorption as defined by the metal halide under various reactor configurations and conditions for the initial part of the cycle before the absorbent fills with ammonia within the reactor with catalyst loading at least 300 kg/m3 or higher loading. For MnCl2, a peak temperature of about 330° C. or from about 320° C. to about 350° C. is anticipated.

TABLE 5
Performance of Integrated Gao Catalyst with MnCl₂ Absorbent with Catalyst Loading at least 300 kg/m3 or Higher Loading.

| | | | | | Peak Bed | Per | Number of | Vol_Reactr, | | Metal | Total Tube |
|---|---|---|---|---|---|---|---|---|---|---|---|
| Cat | | | | | Thermal | pass | Reactor- | m3 | | Weight (half | Metal |
| Density, | Diam, | P, | Superfical | Temperature, | gradient, | conversion, | Abs | (half | Vol_Reactr, | cycle), | Weight, |
| kg/m3 | m | bara | vel, m/s | C. | C. | % | Tubes | cycle) | m3 | kg | tonnes |
| 800 | 0.012 | 41 | 1 | 200 | 433 | 95.0% | 48 | 0.054 | 0.1085 | 542 | 1.1 |
| 1000 | 0.012 | 41 | 2 | 200 | 82 | 60.6% | 38 | 0.043 | 0.0851 | 425 | 0.9 |
| 1000 | 0.012 | 41 | 1.5 | 200 | 305.7 | 88.7% | 34 | 0.039 | 0.0775 | 388 | 0.8 |
| 1000 | 0.012 | 41 | 1.3 | 200 | 363.4 | 92.3% | 38 | 0.043 | 0.0860 | 430 | 0.9 |
| 500 | 0.012 | 41 | 1 | 200 | 423.4 | 93.4% | 49 | 0.055 | 0.1104 | 552 | 1.1 |
| 500 | 0.012 | 41 | 2 | 200 | 38.07 | 47.0% | 49 | 0.055 | 0.1098 | 549 | 1.1 |
| 500 | 0.012 | 31 | 2 | 200 | 39.7 | 49.6% | 61 | 0.069 | 0.1374 | 687 | 1.4 |
| 500 | 0.012 | 21 | 2 | 200 | 41 | 53.3% | 84 | 0.094 | 0.1890 | 945 | 1.9 |
| 500 | 0.012 | 11 | 1.5 | 200 | 64.3 | 67.9% | 167 | 0.189 | 0.3775 | 1888 | 3.8 |
| 500 | 0.012 | 11 | 1.5 | 220 | 139.1 | 86.5% | 136 | 0.154 | 0.3087 | 1543 | 3.1 |
| 500 | 0.012 | 21 | 2 | 220 | 98.7 | 73.9% | 63 | 0.071 | 0.1420 | 710 | 1.4 |
| 500 | 0.012 | 21 | 1.9 | 220 | 112 | 76.0% | 64 | 0.073 | 0.1452 | 726 | 1.5 |
| 600 | 0.012 | 21 | 2 | 200 | 48 | 56.4% | 79 | 0.089 | 0.1784 | 892 | 1.8 |
| 600 | 0.012 | 21 | 1.5 | 200 | 99.6 | 66.9% | 89 | 0.100 | 0.2005 | 1002 | 2.0 |
| 600 | 0.012 | 21 | 1 | 200 | 342.7 | 90.7% | 98 | 0.111 | 0.2219 | 1109 | 2.2 |
| 300 | 0.012 | 21 | 1 | 200 | 218.8 | 78.5% | 113 | 0.128 | 0.2565 | 1283 | 2.6 |
| 300 | 0.012 | 21 | 2 | 240 | 135.2 | 83.3% | 58 | 0.065 | 0.1310 | 655 | 1.3 |
| 300 | 0.012 | 21 | 1.5 | 240 | 275.2 | 93.5% | 69 | 0.078 | 0.1557 | 779 | 1.6 |
| 300 | 0.009 | 21 | 1.5 | 240 | 100.2 | 85.9% | 133 | 0.085 | 0.1694 | 1205 | 2.4 |
| 300 | 0.009 | 21 | 1.2 | 240 | 156.2 | 90.9% | 157 | 0.100 | 0.2002 | 1424 | 2.8 |

Lower levels of catalyst loading, below about 100 kg/m3 are presented in Table 1.5. For a highly active catalyst, an acceptable operating window can be defined by decreasing the amount of catalyst loaded within an inventive system.

TABLE 1.5
Performance of Integrated Gao catalyst with MnCl₂ absorbent with Catalyst Loading at or below 100 kg/m3.

| | | | | | | | | | | Metal | Total |
|---|---|---|---|---|---|---|---|---|---|---|---|
| | | | | | Peak | Per | Number of | Vol_Reactr, | | Weight | Tube |
| Cat | | | Superfical | | Bed | pass | Reactor- | m3 | | (half | Metal |
| Density, | Diam, | P, | vel, | Temperature, | Thermal | conversion, | Abs | (half | Vol_Reactr, | cycle), | Weight, |
| kg/m3 | m | bara | m/s | C. | gradient, C. | % | Tubes | cycle) | m3 | kg | tonnes |
| 100 | 0.01 | 41 | 0.01 | 200 | 997 | 99.9% | 6570 | 5.16 | 10.32 | 64393 | 128.8 |
| 50 | 0.01 | 41 | 0.01 | 200 | 989 | 99.4% | 6603 | 5.19 | 10.37 | 64717 | 129.4 |
| 20 | 0.01 | 41 | 0.01 | 200 | 956 | 98.2% | 6686 | 5.25 | 10.50 | 65534 | 131.1 |
| 10 | 0.01 | 41 | 0.01 | 200 | 25.6 | 72.7% | 9026 | 7.09 | 14.18 | 88473 | 176.9 |
| 12 | 0.01 | 41 | 0.01 | 200 | 35.2 | 75.6% | 8687 | 6.82 | 13.65 | 85147 | 170.3 |
| 14 | 0.01 | 41 | 0.01 | 200 | 60.7 | 78.0% | 8418 | 6.61 | 13.22 | 82515 | 165.0 |
| 16 | 0.01 | 41 | 0.01 | 200 | 925.6 | 97.6% | 6724 | 5.28 | 10.56 | 65910 | 131.8 |
| 15 | 0.01 | 41 | 0.01 | 200 | 903.6 | 97.4% | 6741 | 5.29 | 10.59 | 66073 | 132.1 |
| 14 | 0.01 | 41 | 0.008 | 200 | 815 | 96.9% | 8465 | 6.65 | 13.30 | 82975 | 165.9 |
| 14 | 0.008 | 41 | 0.008 | 200 | 20.8 | 80.6% | 15908 | 8.00 | 15.99 | 131934 | 263.9 |
| 14 | 0.008 | 41 | 0.007 | 200 | 21 | 82.6% | 17729 | 8.91 | 17.82 | 147041 | 294.1 |
| 14 | 0.008 | 41 | 0.007 | 210 | 50.3 | 89.3% | 16744 | 8.42 | 16.83 | 138871 | 277.7 |
| 14 | 0.008 | 41 | 0.007 | 211 | 60 | 89.9% | 16670 | 8.38 | 16.76 | 138261 | 276.5 |
| 14 | 0.008 | 41 | 0.007 | 212 | 103 | 90.6% | 16581 | 8.33 | 16.67 | 137522 | 275.0 |
| 14 | 0.008 | 31 | 0.007 | 212 | 39 | 92.1% | 21580 | 10.85 | 21.69 | 178981 | 358.0 |
| 14 | 0.008 | 21 | 0.007 | 212 | 26 | 94.1% | 31182 | 15.67 | 31.35 | 258618 | 517.2 |
| 14 | 0.008 | 11 | 0.007 | 212 | 15.7 | 96.4% | 58060 | 29.18 | 58.37 | 481539 | 963.1 |
| 14 | 0.008 | 8 | 0.00 | 212 | 12.5 | 97.3% | 79119 | 39.77 | 79.54 | 656196 | 1312.4 |
| 14 | 0.01 | 11 | 0.007 | 212 | 28.8 | 96.4% | 37155 | 29.18 | 58.36 | 364181 | 728.4 |
| 14 | 0.015 | 11 | 0.007 | 212 | 648.2 | 99.6% | 15994 | 28.26 | 56.53 | 217066 | 434.1 |
| 14 | 0.012 | 11 | 0.007 | 212 | 113.7 | 96.6% | 25751 | 29.12 | 58.25 | 291238 | 582.5 |
| 15 | 0.012 | 11 | 0.007 | 212 | 420 | 99.3% | 25069 | 28.35 | 56.70 | 283521 | 567.0 |
| 15 | 0.012 | 8 | 0.007 | 212 | 43.7 | 97.6% | 35070 | 39.66 | 79.33 | 396634 | 793.3 |
| 15 | 0.012 | 9 | 0.007 | 212 | 54.9 | 97.3% | 31257 | 35.35 | 70.70 | 353506 | 707.0 |
| 15 | 0.012 | 10 | 0.007 | 212 | 79.5 | 97.1% | 28195 | 31.89 | 63.78 | 318876 | 637.8 |

The loading density of absorbent is evaluated at 800 kg/m3 with the properties of MnCl₂. A fully densified metal halide at room temperature has a density above about 2900 kg/m3. It is understood that the halide absorbent will be contained or loaded within a porous support and pelletized. The absorbent will be disposed as in a continuous, discontinuous, or continuous-discontinuous manner within the support. In the present embodiment, the porous support will be loaded to about 25% to 30% fraction of the reactor volume. In some embodiments, the absorbent will have a fraction of the reactor and absorber volume between about 10 and 80%, with a preferred range from about 20 to 40%. In this range, the absorbent may change from a more discontinuous to a continuous-discontinuous structure. In this structure transition to continuous regions containing connected absorbent, the effect of percolation theory may enhance mass transfer which moves ammonia within the connected absorbent passageways. In this embodiment, sorption capacity is enhanced during the reaction and sorption part of the cycle and enhance desorption when the feed is not flowing to the specific reactor vessel or tube that contains sorbent and catalyst as described by the present invention.

In one embodiment the increase in volume during sorption of ammonia is limited to localized regions such that the overall macroscopic pellet dimension does not substantially change or swell. In an alternate embodiment, a volume increase in a localized region acts to connect otherwise disconnected regions of absorbent such that the rate of mass transfer is enhanced by allowing ammonia to migrate more easily to regions of lower filled capacity, thereby increasing the effective capacity or utilization for the absorbent.

The results from Table 1.5 as sorted by conversion from high to low and highlighted for test conditions that exceed 95% conversion per pass and maintain a peak temperature less than about 330° C. where the absorbent capacity is reduced are shown in Table 1.6.

TABLE 6
Sorted Results from Table 5.

| | | | | | | | | | | | Total |
|---|---|---|---|---|---|---|---|---|---|---|---|
| | | | | | Peak | Per | Number | | | Metal | Tube |
| Cat | | | | | Bed | pass | of | Vol_Reactr, | | Weight | Metal |
| Density, | | | Superfical | Temperature, | Thermal | conversion, | Reactor-Abs | m3 (half | Vol_Reactr, | (half | Weight, |
| kg/m3 | Diam, m | P, bara | vel, m/s | C. | gradient, C. | % | Tubes | cycle) | m3 | cycle), kg | tonnes |
| 100 | 0.01 | 41 | 0.01 | 200 | 997 | 99.9% | 6570 | 5.16 | 10.32 | 64393 | 128.8 |
| 14 | 0.015 | 11 | 0.007 | 212 | 648.2 | 99.6% | 15994 | 28.26 | 56.53 | 217066 | 434.1 |
| 50 | 0.01 | 41 | 0.01 | 200 | 989 | 99.4% | 6603 | 5.19 | 10.37 | 64717 | 129.4 |
| 15 | 0.012 | 11 | 0.007 | 212 | 420 | 99.3% | 25069 | 28.35 | 56.70 | 283521 | 567.0 |
| 20 | 0.01 | 41 | 0.01 | 200 | 956 | 98.2% | 6686 | 5.25 | 10.50 | 65534 | 131.1 |
| 16 | 0.01 | 41 | 0.01 | 200 | 925.6 | 97.6% | 6724 | 5.28 | 10.56 | 65910 | 131.8 |
| 15 | 0.012 | 8 | 0.007 | 212 | 43.7 | 97.6% | 35070 | 39.66 | 79.33 | 396634 | 793.3 |
| 15 | 0.01 | 41 | 0.01 | 200 | 903.6 | 97.4% | 6741 | 5.29 | 10.59 | 66073 | 132.1 |
| 14 | 0.008 | 8 | 0.007 | 212 | 12.5 | 97.3% | 79119 | 39.77 | 79.54 | 656196 | 1312.4 |
| 15 | 0.012 | 9 | 0.007 | 212 | 54.9 | 97.3% | 31257 | 35.35 | 70.70 | 353506 | 707.0 |
| 15 | 0.012 | 10 | 0.007 | 212 | 79.5 | 97.1% | 28195 | 31.89 | 63.78 | 318876 | 637.8 |
| 14 | 0.01 | 41 | 0.008 | 200 | 815 | 96.9% | 8465 | 6.65 | 13.30 | 82975 | 165.9 |
| 14 | 0.012 | 11 | 0.007 | 212 | 113.7 | 96.6% | 25751 | 29.12 | 58.25 | 291238 | 582.5 |
| 14 | 0.01 | 11 | 0.007 | 212 | 28.8 | 96.4% | 37155 | 29.18 | 58.36 | 364181 | 728.4 |
| 14 | 0.008 | 11 | 0.007 | 212 | 15.7 | 96.4% | 58060 | 29.18 | 58.37 | 481539 | 963.1 |
| 14 | 0.008 | 21 | 0.007 | 212 | 26 | 94.1% | 31182 | 15.67 | 31.35 | 258618 | 517.2 |
| 14 | 0.008 | 31 | 0.007 | 212 | 39 | 92.1% | 21580 | 10.85 | 21.69 | 178981 | 358.0 |
| 14 | 0.008 | 41 | 0.007 | 212 | 103 | 90.6% | 16581 | 8.33 | 16.67 | 137522 | 275.0 |
| 14 | 0.008 | 41 | 0.007 | 211 | 60 | 89.9% | 16670 | 8.38 | 16.76 | 138261 | 276.5 |
| 14 | 0.008 | 41 | 0.007 | 210 | 50.3 | 89.3% | 16744 | 8.42 | 16.83 | 138871 | 277.7 |
| 14 | 0.008 | 41 | 0.007 | 200 | 21 | 82.6% | 17729 | 8.91 | 17.82 | 147041 | 294.1 |
| 14 | 0.008 | 41 | 0.008 | 200 | 20.8 | 80.6% | 15908 | 8.00 | 15.99 | 131934 | 263.9 |
| 14 | 0.01 | 41 | 0.01 | 200 | 60.7 | 78.0% | 8418 | 6.61 | 13.22 | 82515 | 165.0 |
| 12 | 0.01 | 41 | 0.01 | 200 | 35.2 | 75.6% | 8687 | 6.82 | 13.65 | 85147 | 170.3 |
| 10 | 0.01 | 41 | 0.01 | 200 | 25.6 | 72.7% | 9026 | 7.09 | 14.18 | 88473 | 176.9 |

With a reduced catalyst loading in the reactor for the highly active catalyst, the reactor volume becomes larger to enable a high per pass conversion while also maintaining a peak temperature below about 330° C. so that ammonia can continue to absorb. It is generally noted for the reported simulations, that the ammonia is allowed to continue to absorb at temperatures greater than 330° C. For the exemplar MnCl₂ metal halide, the absorption capacity of NH₃ will drop to about 0.5 mole/mol between about 330° C. to about 370° C. and then drop to substantially zero at higher temperatures.

It is desirable to either maintain the integrated bed temperature below about 330° C. or from about 320° C. to about 370° C. or more preferably below about 300° C. to about 320° C. for a MnCl₂ absorbent. It is desirable to identify absorbents with higher ammonia capacity and those that retain absorbent capacity at higher temperatures and/or lower pressures.

The cycle time necessary to switch the feed from the first integrated reactor to the second parallel integrated reactor is dependent upon the carrying capacity of the selected metal halide absorbent and the amount loaded within the integrated reactor and absorber bed.

The rate of absorption on the MnCl₂ metal halide is estimated from Smith and Torrente-Murciano 2021 as a function of absorbent loading density. The rate of absorption is substantially faster than the initial reaction rate (highest value) across the range of expected operating conditions. In the exemplar case where the amount of catalyst is minimized and amount of absorbent is maximized to enable longer cycle times, the rate of absorption is higher than the rate of reaction. To conserve mass, the local rate of ammonia absorption when the catalyst and absorbent are in intimate contact cannot exceed the rate of ammonia formation and is matched accordingly.

For the design space where the MnCl₂ metal halide absorbs one mole of NH₃ per mole of absorbent, then the theoretical absorption capacity of the material is about 0.1353 g NH₃/g of active absorbent. Further ammonia may be adsorbed on the surface of the MnCl₂ or support or catalyst material. The metal halide salt may be supported with a porous structure and pelletized or it may be pelletized in a way to maintain sufficient internal porosity for gas phase diffusion of ammonia to allow access to the metal halide material while avoiding solid state diffusion. The diffusion process within the exemplar pressed pellets may be Knudsen or molecular as determined by the size of the internal pores and the mean free path of ammonia.

The anticipated loading density for the metal halide absorbent or other sorbent material may range from about 100 kg/m3 to 2000 kg/m3 with a preferred range of about 300 to 1500 kg/m3 and a more preferred range from about 500 to 1200 kg/m3. Cycle time and performance for the inventive absorption and reaction system is shown in Table 1.7.

TABLE 7
Anticipated cycle time in hours for the selected cases where the per pass conversion
exceeds 95% and the peak metal temperature is less than about 330 C.

| | | | | | | | | | | | Fraction | |
|---|---|---|---|---|---|---|---|---|---|---|---|---|
| | | | | | Peak | | Number | | | | of | |
| | | | | | Bed | Per | of | Vol_Reactr, | | Absorbent | theoretical | |
| Cat | | | Superfical | | Thermal | pass | Reactor- | m3 | | loading | absorbent | Cycle |
| Density, | Diam, | P, | vel, | Temperature, | gradient, | conversion, | Abs | (half | Vol_Reactr, | density, | loading | time, |
| kg/m3 | m | bara | m/s | C. | C. | % | Tubes | cycle) | m3 | kg/m3 | at switch | h |
| 15 | 0.012 | 8 | 0.007 | 212 | 43.7 | 97.6% | 35070 | 39.66 | 79.33 | 800 | 0.6 | 15.5 |
| 14 | 0.008 | 8 | 0.007 | 212 | 12.5 | 97.3% | 79119 | 39.77 | 79.54 | 800 | 0.6 | 15.5 |
| 15 | 0.012 | 9 | 0.007 | 212 | 54.9 | 97.3% | 31257 | 35.35 | 70.70 | 800 | 0.6 | 13.8 |
| 15 | 0.012 | 10 | 0.007 | 212 | 79.5 | 97.1% | 28199 | 31.89 | 63.78 | 800 | 0.6 | 12.4 |
| 14 | 0.012 | 11 | 0.007 | 212 | 113.7 | 96.6% | 25751 | 29.12 | 58.25 | 800 | 0.6 | 11.3 |
| 14 | 0.01 | 11 | 0.007 | 212 | 28.8 | 96.4% | 37155 | 29.18 | 58.36 | 800 | 0.6 | 11.4 |
| 14 | 0.008 | 11 | 0.007 | 212 | 15.7 | 96.4% | 58060 | 29.18 | 58.37 | 800 | 0.6 | 11.4 |

For the cases with very high loading (greater than 300 kg/m3) of a highly active catalyst such as that described by Gao et al in 2017, the cycle time for absorbent loading from 500 to about 1500 kg/m3 would be less than about 1 hour. In one trade-off analysis, very fast cycle times (less than 1 hour) would minimize the overall reactor volume but at the expense of a less robust system that must cycle with increased frequently. At each cycle, unreacted feedstock retained inside the pellet pores, within the interstices between pellets located in the packed bed, and in void volumes present in headers and footers that connect tubes would be lost to reduce the overall mass efficiency of the inventive process.

It is generally understood that the anticipated design will maximize the loading of absorbent to increase the cycle time such that the frequency for bed cycling and regeneration is reduced. The reactor feed will be cycled from the parallel integrated reactor absorber before the bed capacity reaches the theoretical loading. The process feeds will be cycled when the bed has reached from about a fraction of 0.1 to about 0.9 of the theoretical bed loading, with the preferred range from about 0.2 to about 0.85 and a more preferred range from about 0.3 to about 0.8.

It is also anticipated that more optimal configurations will seek to increase the tube diameter such that the number of tubes that require flanges, manifolds, and connecting tubing is reduced while also reducing the associated metal weight to procure. The assumed wall thickness of 3-mm will be optimized for the duty cycle and associated pressure, chemical, and thermal stresses.

### Example 2

A multistage system may be configured where the first stage comprises only reaction without separation. The product from the first stage will flow to one or more integrated reaction-sorption reactor stages as described by the present invention.

In an alternate embodiment, the process is configured to accommodate a first catalyst-only stage to produce a portion of the target plant capacity of ammonia. This first stage will have an equilibrium-limited conversion in accordance with thermodynamics. In a preferred embodiment there is no recycle of unreacted feed to this first stage to minimize process compression and heating requirements. This process will produce from about 10 to 40% of the plant capacity on a continuous basis in the first stage containing only catalyst.

As shown in Table 8, the reaction only process has a lower heat release than the combined sorption and reaction system such that the anticipated tube diameter can be larger and the allowable peak temperature higher to minimize overall reactor volume, number of tubes and metal weight in the first stage. The analysis is completed with kinetics fit for data provided in Gao 2017 as described in Example 1.

TABLE 8
First stage of hybrid process with two or more stages where the first stage comprises only a catalyst.

| | | | | | Peak Bed | Per pass | Number of | | Tube Metal | |
|---|---|---|---|---|---|---|---|---|---|---|
| Cat Density, | | | Superfical | Temperature, | Thermal | conversion, | Reactor | Vol_Reactr, | Weight, | Capacity |
| kg/m3 | Diam, m | P, bara | vel, m/s | C. | gradient, C. | % | Tubes | m3 | tonnes | NH3 tpd |
| 1200 | 0.1 | 41 | 0.01 | 200 | 1 | 1.1% | 66 | 5.2 | 5.1 | 0.042 |
| 1200 | 0.4 | 41 | 0.01 | 200 | 3.8 | 1.2% | 4 | 5.2 | 1.2 | 0.046 |
| 1200 | 0.4 | 41 | 0.01 | 300 | 64 | 19.8% | 5 | 6.2 | 1.5 | 0.792 |
| 1200 | 0.4 | 41 | 0.01 | 320 | 99 | 24.6% | 5 | 6.5 | 1.6 | 0.985 |
| 1200 | 0.4 | 41 | 0.001 | 320 | 104 | 36.2% | 51 | 64.6 | 15.6 | 1.449 |
| 1200 | 0.4 | 41 | 0.001 | 300 | 76.8 | 31.0% | 50 | 62.4 | 15.1 | 1.238 |
| 1200 | 0.4 | 41 | 0.001 | 340 | 104.7 | 36.4% | 53 | 66.8 | 16.2 | 1.454 |
| 1200 | 0.4 | 41 | 0.01 | 340 | 102 | 24.8% | 5 | 6.7 | 1.6 | 0.994 |

For an exemplar case with a per pass conversion of 25% in the first stage, roughly 1 tonne/day of ammonia can be produced with a reactor volume from about 5 to 7 m³ and an estimated metal weight from about 0.5 to 2 tonnes. These metrics represent a reduction from about 10 to 50% of the reactor volume and a reduction from about 10 to 98% of the metal weight in the first portion of the process for a process that comprises only absorbent and catalyst in all reaction vessels. As equilibrium limits remain, the hybrid process can only produce from about 10 to 40% of the total plant capacity in the first stage such that the unconverted feedstock is not wasted as it is fed to a second stage that contains the inventive catalyst and absorbent pellets with materials in intimate contact.

For the comparative case for the fully integrated reactor and absorber system as shown in Table 1.6, a reactor-absorber tube volume for a conversion greater than about 95% conversion requires from about 55 to 80 m³. The hybrid embodiment is a means to reduce the overall reactor volume and required metal weight. For the fully integrated reactor and absorber system, the first tonne per day of ammonia would require about 25% of the full volume or from about 13 to 20 m³ with a metal weight of 130 to 350 tonnes for a wall thickness of 3 mm. It is generally understood that the final design may require an optimal wall thickness which may range from about 1 to 5 mm for the required duty cycle and mechanical robustness. Thereby the weight and weight reduction advantage for the hybrid inventive process will scale accordingly.

In the second stage of the hybrid process, the produced ammonia may be fed to an integrated reactor and absorber. The ammonia produced in the first stage is captured on the absorbent and the reaction continues to proceed to a higher conversion as the thermodynamic limitation for the reverse ammonia decomposition reaction is limited by local and intimate product removal.

The inventive hybrid process may be further advantaged with the use of three or more stages in series. In the first stage, the reaction only is allowed to proceed to produce from about 10 to 40% of the plant capacity. In the second stage the ratio of absorbent to catalyst density is higher than in a third stage in series. The ammonia produced in the first stage is preferentially absorbed in the second stage. The third stage continues to react most nitrogen with hydrogen to achieve a net process conversion rate from about 80 to 99.9% with a preferred range from 90 to 99% and a more preferred range from about 95 to 98%.

In an alternate embodiment to the hybrid process, a first highly active catalyst formulation such as the catalyst as described by Gao in 2017 may be used in the first stage and a second catalyst formulation that may be less active is used in at least the second stage of a hybrid process. The active catalyst materials may be the same or different or combinations of the two in each of the at least first and second stage.

### Example 3

An alternate catalyst based on a formulation comprising iron and cobalt is described in Smith and Torrente-Murciano (2022) for a commercial composite Fe—Co catalyst available from Johnson Matthey under the brand name Katalco 74-1.

Data is presented in the Smith paper for a low catalyst loading (0.2-g) and a high catalyst loading (1.5-g) as housed within a reactor volume of about 1e-6 m3. An inert material is mixed with the low loading to maintain the same packed bed reactor volume for both cases. The catalyst with higher bed loading (1.5-g provided a loading density of about 1492 kg/m3) produced roughly twice the conversion as the lower loading catalyst (0.2-g for a loading density of about 190 kg/m3). A traditional Temkin-Pyzhev power law form of the reaction rate expression did not well capture the data. An alternate form of the reaction rate expression based on competitive Langmuir adsorption on surface sites taking the kinetic form of LHHW (Langmuir-Hinshelwood-Hougen-Watson) was evaluated and optimized kinetic parameters were fit by regressing the published data sets.

The reaction rate for the formation of ammonia is shown below where the rate of nitrogen consumption is half the rate of ammonia formation to follow the reaction stoichiometry.

$$rate = k 0 {e}^{- \frac{Ea}{RT}} ( {P}_{N 2} - {P}_{NH 3}^{2} / ( K\_eq {P}_{H 2}^{3} ) ) / {DENOM}^{2}$$

$$DENOM = ( 1 + KN 2 {P}_{N 2} + KNH 3 {P}_{NH 3} {P}_{H 2}^{n} + KH 2 {P}_{H 2}^{0.5} ) ,$$

Where each adsorption constant as a function of temperature is defined by the equation for the with specie as follows.

$$Ki = Ki 0 {e}^{\frac{DHi}{RT}}$$

where the value of the heat of adsorption DHi may be either negative or positive depending if the surface adsorption of a specie on an active catalyst site is endothermic or exothermic. The units of Ki are inverse bara-based to match partial pressures used in units of bara such that each term in the 1+ denominator is unitless. For example, the units of KN2 are bar⁻¹ while KNH₃ has units of bar^{0.5}.

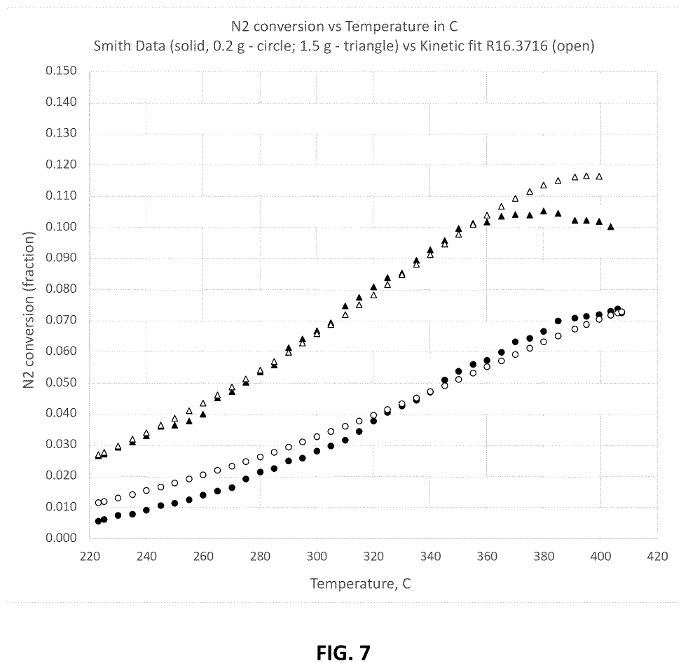

The parity comparison between kinetic predictions and the data as presented in the Smith 2022 paper is shown in FIG. 7. The complexity of the catalyst kinetics can be seen in the data, where an increase of 7.5× catalyst per reactor volume roughly doubles the nitrogen conversion.

The impact of reaction equilibrium with the reverse reaction (ammonia decomposition) coupled with the impact of ammonia adsorption on catalyst sites strongly inhibits this Fe—Co catalyst. It is generally understood that the present kinetic expression is not a perfect fit for the complex chemistry but reflects a reasonable approximation for the current and anticipated performance when scaling the catalyst with an absorbent in the present invention.

The reaction activation energy is 140.06 kJ/mol. The heat of adsorption for NH₃, H₂, and N2 in kJ/mol are −32.73, 23.85, and −24.41 respectively.

The reaction pre-exponential term is 8.35e29 in mole/gram/min/bar while the adsorption pre-exponential terms for NH₃, H₂, and N₂ are 3.17e¹⁶, 1.994e³, and 7.25e” respectively. The catalyst as tested in a small granular form is shown to not have internal pore diffusion limitation nor a substantial temperature rise as defined by less than about 1 C for most cases.

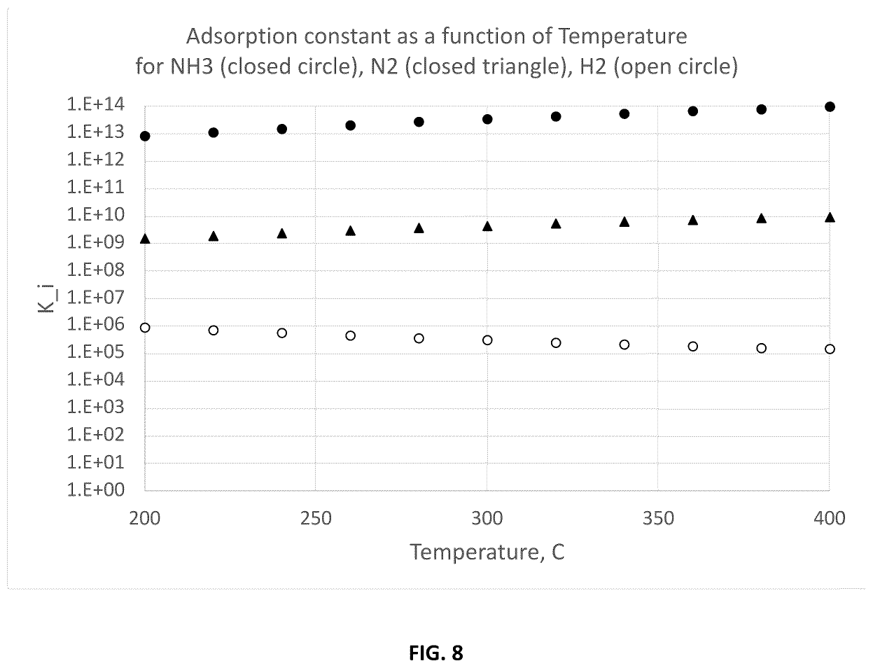

The values of the adsorption constants for each of the species is shown in FIG. 8 as a function of reaction temperature over the range of test data. The adsorption constant for hydrogen decreases with temperature, while the adsorption constants for ammonia and nitrogen increase with temperature.

As the denominator term is squared in the kinetic expressions, the effect of ammonia inhibition from surface adsorption on the catalyst site profoundly limits the overall rate of ammonia synthesis. This limitation of surface adsorption as coupled with thermodynamic limitations to overall conversion limit the overall rate of ammonia formation. It is anticipated that refined kinetic expressions will achieve closer parity with experimental reactor data. The impact of scaling with the catalyst comprising cobalt and iron is further evaluated to understand the impact of this catalyst in a recycle reactor configuration and as operated with an integrated catalyst and absorbent maintained in intimate contact as described by the present invention.

The impact of operating the catalyst as described by Smith in 2022 in a recycle reactor system is shown in Table 9. The reactor operates upstream of a separate unit operation comprising a separator where produced ammonia is removed by absorption, adsorption, condensation, or another means. Unreacted feedstocks are recompressed and recycled to the first reactor. Input conditions are described in Table 10.

TABLE 9
Recycle System operation with the 74-1 catalyst comprising Fe
and Co at the conditions and parameters described in Table 10.

| | Per pass | | Recycle | Number of | | Peak Bed |
|---|---|---|---|---|---|---|
| | conversion, | Recycle | Reactor Vol, | Reactor | Tube Metal | Thermal |
| Temperature, C. | % | Ratio | m3 | Tubes | Weight, kg | gradient, C. |
| 300 | 12.9% | 7.75 | 48.37 | 616 | 47823 | 16.9 |
| 340 | 18.0% | 5.56 | 37.17 | 473 | 36755 | 27.4 |
| 370 | 21.1% | 4.74 | 33.24 | 423 | 32866 | 36.6 |
| 380 | 21.6% | 4.63 | 32.96 | 420 | 32588 | 39.7 |
| 385 | 21.7% | 4.61 | 33.09 | 421 | 32716 | 41.3 |
| 390 | 21.6% | 4.63 | 33.42 | 425 | 33041 | 42.8 |
| 400 | 21.1% | 4.74 | 34.76 | 443 | 34366 | 45.5 |
| 410 | 20.0% | 5.00 | 37.17 | 473 | 36758 | 47.8 |

TABLE 10
Input parameters for a recycle reactor system
operating with the Katalco 74-1 catalyst.

| Parameter | Value |
|---|---|
| Pressure, bara | 41 |
| Capacity, tpd | 4 |
| Tube length, m | 10 |
| Tube Diameter, m | 0.1 |
| superficial velocity, m/s | 0.01 |
| Feed ratio (H2/N2) | 3 |
| Wall thickness, mm | 3 |
| Metal density, kg/m3 | 8000 |
| Catalyst loading density, kg/m3 | 2200 |
| pellet diameter, mm | 3 |
| pellet thermal conductivity, W/m-K | 1 |
| mean internal pore diameter, micron | 1 |
| Internal porosity, % | 50 |
| tortuosity | 3 |
| pellet shape | spherical |
| bed void fraction | 0.4 |

TABLE 11
Recycle System operation with the Katalco 74-1 catalyst comprising Fe and Co at
the conditions shown in Table 3.1 except for varying reactor pressure as shown.

| | | Per pass | | Recycle | Number of | | Peak Bed |
|---|---|---|---|---|---|---|---|
| | Pressure, | conversion, | Recycle | Reactor Vol, | Reactor | Tube Metal | Thermal |
| Temperature, C. | bara | % | Ratio | m3 | Tubes | Weight, kg | gradient, C. |
| 380 | 21 | 15.7% | 6.38 | 88.60 | 1128 | 87605 | 25.0 |
| 370 | 21 | 16.0% | 6.24 | 85.34 | 1087 | 84380 | 23.2 |
| 360 | 21 | 15.9% | 6.29 | 84.75 | 1079 | 83800 | 21.4 |
| 340 | 11 | 11.7% | 8.57 | 213.34 | 2716 | 210953 | 11.6 |
| 350 | 11 | 11.8% | 8.49 | 214.80 | 2735 | 212392 | 12.6 |
| 360 | 11 | 11.6% | 8.61 | 221.44 | 2819 | 218960 | 13.7 |
| 390 | 61 | 25.5% | 3.92 | 19.02 | 242 | 18807 | 56.1 |
| 400 | 61 | 25.6% | 3.91 | 19.27 | 245 | 19053 | 59.7 |
| 410 | 61 | 25.0% | 3.99 | 19.98 | 254 | 19753 | 62.7 |

The overall catalyst activity for the Katalco 74-1 per unit weight is lower than the Cobalt-only catalyst dispersed on carbon nanotubes as described by Gao 2017 and as described in Example 1. With a higher catalyst loading density for the present case of 2200 kg/m3 vs 1200 kg/m3 in Example 1, the recycle reactor volume is larger with this combined iron-cobalt catalyst.

### Example 4

An integrated pellet comprising a MnCl₂ metal halide for ammonia absorption and an ammonia synthesis catalyst comprising iron and cobalt based on reaction kinetics fit with Katalco 74-1 data as described in Example 3 was investigated for performance under integrated operation under various conditions and loading.

TABLE 12
Integrated Catalyst and Absorption based on the Katalco 74-1 at initial operation.

| | | | | | | | | | | Metal | Total | |
|---|---|---|---|---|---|---|---|---|---|---|---|---|
| | | | | | Peak | Per | Number of | Vol_Reactr, | | Weight | Tube | |
| Cat | | | Superfical | | Bed | pass | Reactor- | m3 | | (half | Metal | Cycle |
| Density, | Diam, | P, | vel, | Temperature, | Thermal | conversion, | Abs | (half | Vol_Reactr, | cycle), | Weight, | time, |
| kg/m3 | m | bara | m/s | C. | gradient, C. | % | Tubes | cycle) | m3 | kg | tonnes | hours |
| 150 | 0.02 | 41 | 0.01 | 300 | 6.3 | 97.9% | 2030 | 6.38 | 12.75 | 35199 | 70.4 | 2.5 |
| 200 | 0.02 | 41 | 0.01 | 300 | 9 | 98.4% | 2019 | 6.34 | 12.69 | 35016 | 70.0 | 2.5 |
| 100 | 0.02 | 41 | 0.01 | 300 | 3.3 | 77.0% | 2581 | 8.11 | 16.22 | 44756 | 89.5 | 3.2 |
| 125 | 0.02 | 41 | 0.01 | 300 | 5 | 97.1% | 2046 | 6.43 | 12.86 | 35489 | 71.0 | 2.5 |
| 125 | 0.03 | 41 | 0.01 | 300 | 14.2 | 97.5% | 906 | 6.40 | 12.81 | 22545 | 45.1 | 2.5 |
| 125 | 0.03 | 41 | 0.012 | 300 | 14.1 | 95.5% | 771 | 5.45 | 10.89 | 19175 | 38.3 | 2.1 |
| 125 | 0.03 | 31 | 0.012 | 300 | 17.8 | 97.8% | 995 | 7.03 | 14.07 | 24759 | 49.5 | 2.7 |
| 125 | 0.03 | 21 | 0.012 | 300 | 28.9 | 98.0% | 1467 | 10.37 | 20.74 | 36500 | 73.0 | 4.0 |
| 125 | 0.03 | 11 | 0.012 | 290 | 29 | 97.4% | 2767 | 19.56 | 39.12 | 68852 | 137.7 | 7.6 |
| 125 | 0.03 | 9 | 0.012 | 285 | 23.5 | 97.1% | 3362 | 23.77 | 47.54 | 83663 | 167.3 | 9.3 |

The internal bed temperature as a function of length was evaluated for multiple catalyst loading densities using the kinetics for Katalco 74-1 and shown in Table 12. For cases other than 100 kg/m3, the per pass conversion exceeded 95% and specific results are shown in Table 12. Other non-listed packed bed parameters in Table 12 are as described in Table 10.

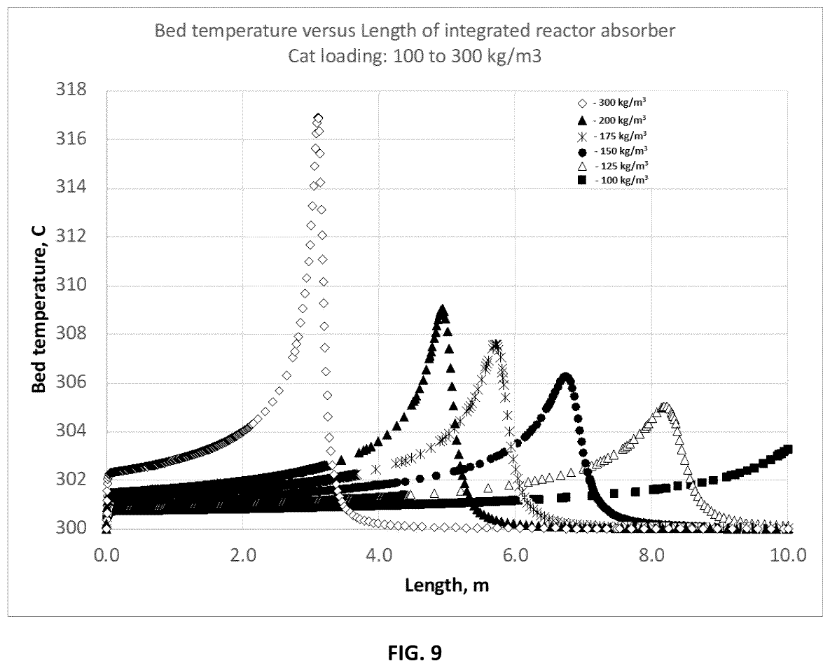

For catalyst loadings between than about 100 and 300 kg/m³, the bed temperature is less about 330° C. as shown in FIG. 9 for the selected reactor dimensions and conditions.

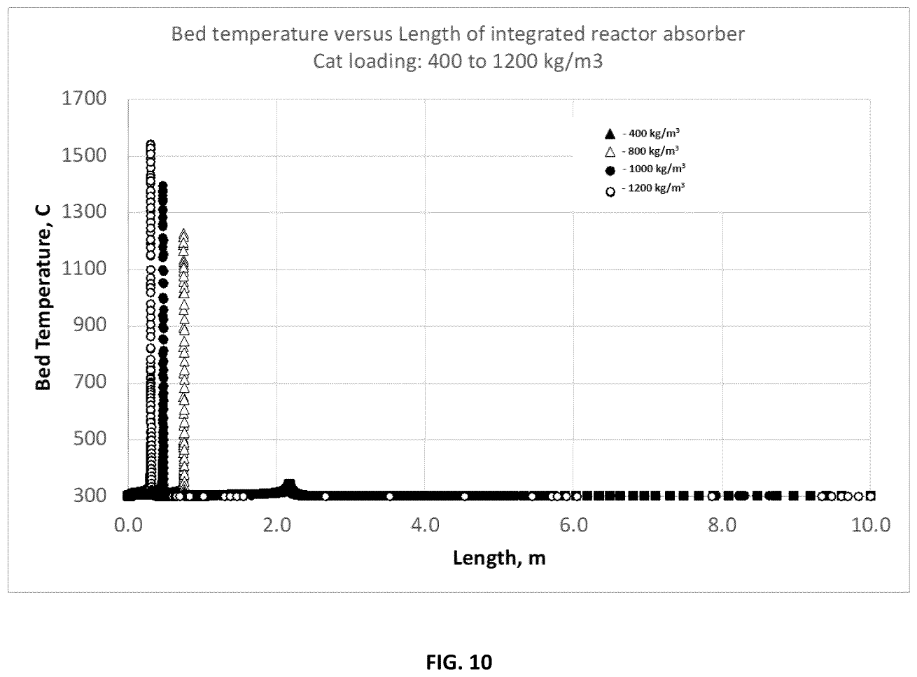

It is understood that when the internal temperature exceeds about 370° C. that the absorbent bed will no longer substantially hold or absorb ammonia and for bed temperatures greater than about 800° C., the catalyst may begin to sinter for permanent deactivation. The results in FIG. 10 are illustrative to show the impact of higher catalyst activity or loading (from about 400 to 1200 kg/m³) which moves the hot spot towards the front of the bed. The results as shown for FIGS. 9 and 10 are an early snapshot in the cycle time for the bed thermal profile before the absorbent begins to substantially fill such that the feed is cycled to a fresh bed when the absorbent is from 10 to 90% filled to the theoretical capacity, preferably from about 30 to 85% filled, and more preferably from about 40 to 70% filled to theoretical absorbent capacity.

The thermal profile for the present invention of combined absorbent and catalyst maintained in intimate contact will depend upon the weight loading of catalyst and absorbent along with specific catalyst formulations. It is understood that more active catalysts lead to higher exotherms but this exotherm can be managed by reducing the loading of catalyst within a reactor volume, adjusting the tube diameter, increasing the superficial velocity, and optimizing reactor temperature in one or more locations along the reactor length.

### Example 5

Ammonia produced and absorbed during the first cycle is removed or desorbed in the second cycle while minimizing the backwards reaction which decomposes or converts ammonia back to the feed gases of nitrogen and hydrogen. For the catalyst described in Example 3, the impact of ammonia decomposition was evaluated and summarized in Table 13. Physical properties of the catalyst and absorbent when not defined presently are found in Table 14.

It is shown that increasing the superficial velocity during desorption reduces the average residence time to thereby reduce the loss of ammonia to catalytic decomposition. The decomposition reaction is limited by reduced residence time even in the case for an elevated temperature as may be required to affect the coordination number such that the sorbed ammonia is released into the gas stream to remove from the system.

TABLE 13
Ammonia decomposition during desorption for the
conditions as noted or summarized in Table 14.

| Cat Density, | Temp, | superficial | NH3 |
|---|---|---|---|
| kg/m3 | C | vel, m/s | conv % |
| 100 | 330 | 0.01 | 0.2% |
| 100 | 330 | 0.1 | 0.02% |
| 100 | 330 | 1 | 0.002% |
| 100 | 350 | 0.01 | 0.7% |
| 100 | 350 | 0.1 | 0.07% |
| 100 | 350 | 1 | 0.01% |
| 100 | 380 | 0.01 | 3.4% |
| 100 | 380 | 0.1 | 0.4% |
| 100 | 380 | 1 | 0.036% |
| 125 | 330 | 0.01 | 0.3% |
| 125 | 330 | 0.1 | 0.03% |
| 125 | 330 | 1 | 0.003% |
| 125 | 350 | 0.01 | 0.9% |
| 125 | 350 | 0.1 | 0.09% |
| 125 | 350 | 1 | 0.009% |
| 125 | 380 | 0.01 | 4.3% |
| 125 | 380 | 0.1 | 0.45% |
| 125 | 380 | 1 | 0.045% |
| 150 | 330 | 0.01 | 0.34% |
| 150 | 330 | 0.1 | 0.03% |
| 150 | 330 | 1 | 0.003% |
| 150 | 350 | 0.01 | 1.06% |
| 150 | 350 | 0.1 | 0.11% |
| 150 | 350 | 1 | 0.011% |
| 150 | 380 | 0.01 | 5.1% |
| 150 | 380 | 0.1 | 0.54% |
| 150 | 380 | 1 | 0.054% |
| 500 | 330 | 0.01 | 1.11% |
| 500 | 330 | 0.1 | 0.11% |
| 500 | 330 | 1 | 0.011% |
| 500 | 350 | 0.01 | 3.44% |
| 500 | 350 | 0.1 | 0.36% |
| 500 | 350 | 1 | 0.036% |
| 500 | 380 | 0.01 | 15.54% |
| 500 | 380 | 0.1 | 1.75% |
| 500 | 380 | 1 | 0.18% |
| 800 | 330 | 0.01 | 1.76% |
| 800 | 330 | 0.1 | 0.2% |
| 800 | 330 | 1 | 0.02% |
| 800 | 350 | 0.01 | 5.40% |
| 800 | 350 | 0.1 | 0.6% |
| 800 | 350 | 1 | 0.06% |
| 800 | 380 | 0.01 | 23.5% |
| 800 | 380 | 0.1 | 2.8% |
| 800 | 380 | 1 | 0.3% |

TABLE 14
Desorption input parameters for the
scenarios shown in Table 13.

| Parameter | Value |
|---|---|
| Tube length, m | 10 |
| Tube Diameter, m | 0.02 |
| Pressure, bara | 3 |
| pellet diameter, mm | 3 |
| bed void fraction | 0.4 |
| pellet thermal conductivity, W/m-K | 1 |
| mean internal pore diameter, micron | 1 |
| Internal pellet porosity, % | 50 |
| tortuosity | 3 |
| pellet shape | spherical |
| bed void fraction | 0.4 |
| ammonia mole fraction | 0.99 |
| nitrogen mole fraction | 0.0025 |
| hydrogen mole fraction | 0.0075 |

For integrated catalyst and absorbent systems, minimizing the catalyst weight loading and/or exposed surface area in the reactor helps to minimize the reverse ammonia decomposition reaction during desorption. In the case for a high loading of catalyst, as shown as 800 kg/m³ in Table 5.1, and a low gas velocity which produces a larger average residence time within the reactor and a high desorption temperature would decompose more than 20% of the absorbed ammonia.

Average residence time is defined by the reactor length divided by the superficial velocity and multiplied by the void fraction.

For the same case of a high catalyst loading (800 kg/m³), high desorption temperature (380° C.) and a higher superficial velocity of 1 m/s then the ammonia decomposition is reduced below 0.5%.

At low catalyst loadings (150 kg/m³ as an example), the ammonia decomposition conversion drops to less than 5% at 0.01 m/s and less than 0.05% at 1 m/s. For these cases the average residence time during desorption is about 400 and 4 seconds respectively.

For the inventive combined catalyst and absorbent, the ammonia decomposition conversion is less than about 5% and from about 0.001% to 5%, preferably from about 0.002 to 4%, and more preferably from about 0.002 to 0.5%.

### Example 6

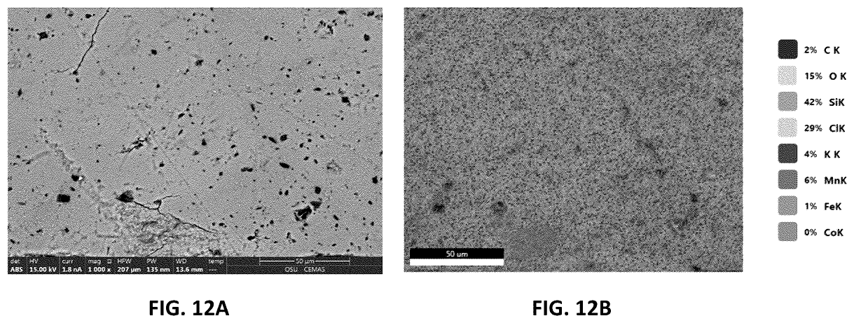

A catalyst-sorbent structure in the form of 6 mm pellets were manufactured. An Fe/Co based catalyst powder was synthesized following the recipe in Kai et al, 2022. Separately, MnCl₂ was impregnated into SiO₂ Aerosil in a single step aqueous impregnation to 25 wt % SiO₂. The resulting powders were mixed in a 10:1 sorbent:catalyst mass ratio and pressed with a binder into pellets and calcined at 250° C. in air. The resulting pellets had an average diameter of 6.1 mm and a crush strength of 3.7 lbf. Pellets were mounted in epoxy and polished to the core for SEM/EDS imaging. The SEM image of the resulting pellet is illustrated in FIG. 12A. The EDS image of the resulting pellet is illustrated in FIG. 12B. The SEM/ED cross-section images illustrate the intimate contact between the catalyst and sorbent and the homogenous dispersion of the catalyst and sorbent throughout the material, according to certain preferred aspects of the present disclosure.

### Example 7

Zeolite 13X powders, in their Na form, were modified to incorporate active catalysts and sorbent metals. 0.025 moles of metal salt (Mg(NO3)2·xH2O, Mn(NO3)2·xH2O, Cu(NO3)2·xH2O Co(NO3)2·xH2O, Zn(NO3)2·xH2O) were dissolved in 50 ml deionized water and added to 2 g Na13X or H-ZSM5 or Na-4A from Sigma Aldrich. The solution was stirred on a stir plate for 24 hours at room temperature. Upon completion, the suspension was treated with centrifugation at 2000 rpm for 10 minutes, the supernatant was decanted, replaced with fresh DI water, and centrifuged again. The washing process was repeated a total of 4 times and the resulting solid was heated under vacuum at 200° C. overnight to dry. The samples were dissolved by microwave-assisted acid digestion and characterized with ICP-OES. The mean concentrations of relevant metals were then determined as reported in Table 15 and indicate successful exchange to the desired metal ions.

TABLE 15
Metal Concentration in Ion-Exchanged Zeolites.

| | | Mg13X | | | Co13X | | | Mn4A | | |
|---|---|---|---|---|---|---|---|---|---|---|
| | | Dilution Factor: 1 | | | Dilution Factor: 1 | | | Dilution Factor: 1 | | |
| Element/ | Emission | Cₘ | Uₘ | Uₘ | Cₘ | Uₘ | Uₘ | Cₘ | Uₘ | Uₘ |
| Isotope | Line | (μg/g) | (μg/g) | (%) | (μg/g) | (μg/g) | (%) | (μg/g) | (μg/g) | (%) |
| Na | 589.592 | 30200 | 1100 | 3.8 | 31000 | 1100 | 3.5 | 27500 | 700 | 2.5 |
| Mg | 280.27 | 1060 | 40 | 3.7 | 9.01 | 0.69 | 7.6 | 64.1 | 1.6 | 2.6 |
| Mn | 259.373 | <20 | — | — | 23.9 | 8.3 | 35 | 93800 | 2100 | 2.3 |
| Co | 228.616 | <60 | — | — | 86400 | 900 | 1.1 | <60 | — | — |
| Cu | 324.754 | <90 | — | 1 | <90 | — | — | <90 | — | — |
| Zn | 213.856 | 28.5 | 3.7 | 13 | <20 | — | — | <20 | — | — |

| Zn13X | | | Mg/Co13X | | | Mg4A | | | Mn-ZSM-5 | | |
|---|---|---|---|---|---|---|---|---|---|---|---|
| Dilution Factor: 1 | | | Dilution Factor: 1 | | | Dilution Factor: 1 | | | Dilution Factor: 1 | | |
| Cₘ | Uₘ | Uₘ | Cₘ | Uₘ | Uₘ | Cₘ | Uₘ | Uₘ | Cₘ | Uₘ | Uₘ |
| (μg/g) | (μg/g) | (%) | (μg/g) | (μg/g) | (%) | (μg/g) | (μg/g) | (%) | (μg/g) | (μg/g) | (%) |
| 26400 | 200 | 0.81 | 24300 | 600 | 2.3 | 27400 | 1400 | 5 | 113 | 5 | 4.3 |
| <6 | — | — | 284 | 4 | 1.5 | <6 | — | — | 24.9 | 0.8 | 3.1 |
| <20 | — | — | 39.4 | 2.7 | 6.8 | 110000 | 4000 | 4.1 | 125000 | 4000 | 3.6 |
| <60 | — | — | 97200 | 90 | 0.093 | <60 | — | — | <60 | — | — |
| <90 | — | — | <90 | — | — | <90 | — | — | <90 | — | — |
| 114000 | 300 | 0.24 | 42.6 | 5.0 | 12 | 20.0 | 4.9 | 25 | <20 | — | — |

| MgZSM5 | | | Cu13X | | | H-ZSM-5 | | |
|---|---|---|---|---|---|---|---|---|
| Dilution Factor: 1 | | | Dilution Factor: 1 | | | Dilution Factor: 1 | | |
| Cₘ | Uₘ | Uₘ | Cₘ | Uₘ | Uₘ | Cₘ | Uₘ | Uₘ |
| (μg/g) | (μg/g) | (%) | (μg/g) | (μg/g) | (%) | (μg/g) | (μg/g) | (%) |
| <40 | — | — | 11100 | 400 | 3.6 | <40 | — | — |
| 884 | 20 | 2.3 | <6 | — | — | <6 | — | — |
| <20 | — | — | <20 | — | — | <20 | — | — |
| 61.9 | 2.7 | 4.4 | <60 | — | — | 62.2 | 8.0 | 13 |
| <90 | — | — | 197000 | 7000 | 3.5 | <90 | — | — |
| <20 | — | — | 89.9 | 5.3 | 5.9 | <20 | — | — |

| Na13X | | | 4a | | | Mn13X | | |
|---|---|---|---|---|---|---|---|---|
| Dilution Factor: 1 | | | Dilution Factor: 1 | | | Dilution Factor: 1 | | |
| Cₘ | Uₘ | Uₘ | Cₘ | Uₘ | Uₘ | Cₘ | Uₘ | Uₘ |
| (μg/g) | (μg/g) | (%) | (μg/g) | (μg/g) | (%) | (μg/g) | (μg/g) | (%) |
| 103000 | 3000 | 3.2 | 107000 | 10000 | 9.2 | 30400 | 1200 | 4 |
| <6 | — | — | <6 | — | — | <6 | — | — |
| <20 | — | — | <20 | — | — | 70200 | 800 | 1.1 |
| <60 | — | — | <60 | — | — | <60 | — | — |
| <90 | — | — | <90 | — | — | <90 | — | — |
| 25.3 | 2.7 | 10 | <20 | — | — | 26.1 | 4.2 | 16 |

### Example 8

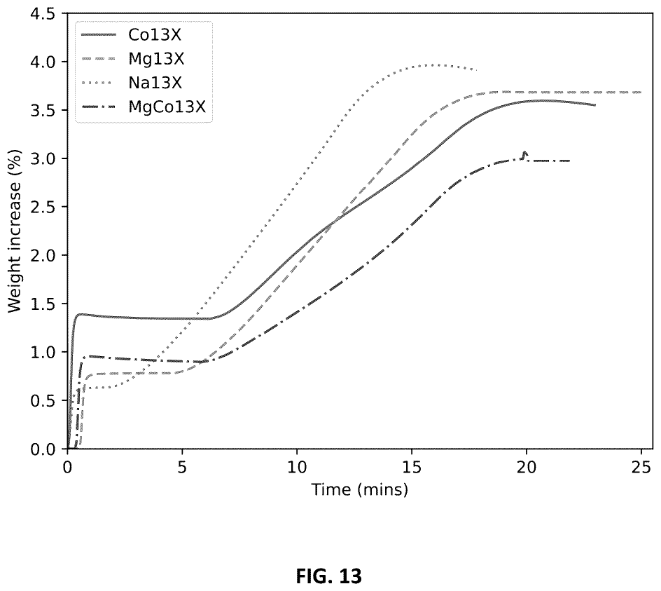

An amount between 20-50 mg of select ion exchanged zeolites as described in example 7 were placed in a TA Instruments Q50 GA. Adsorbed water was removed by heating to 500° C. for 10 minutes under 100 sccm N₂. NH³ gas was introduced at 40 sccm and N² reduced to 60 sccm, corresponding to t=0 min on the graph in FIG. 13. Thereafter, temperature was ramped down to 300° C. while gas flow was held constant. Weight increase shown in FIG. 13 is attributed to ammonia adsorption, where relative weight increases between zeolites of varying metal loadings varies by temperature indicating that ion exchange alters ammonia adsorption characteristics.

### Example 9

The present example demonstrates the catalyst-sorbent structure in a system consisting of a bed of a Ru-based catalyst and metal exchanged zeolite adsorbent in simulated intimate contact, whereby the small powders are mixed in approximate intimate contact in the packed bed by providing significant surface area catalyst and sorbent in intimate contact, rather than forming a co-pressed pellet of the catalyst and sorbent. It is commonly accepted that Ru-based catalysts are high performing at low temperatures compared to that of the standard Fe-based catalysts. Low temperature operations are preferred for the inventive catalyst-adsorbent system to achieve sufficient adsorption during reaction conditions. Zeolite-based adsorbents also offer the advantage of elevated thermal stability, preventing catalyst poisoning events.

The catalyst and adsorbent for this experiment were prepared as follows. A 5-wt % Ru and 10-wt % Cs supported on CeO₂ were prepared via traditional incipient wetness impregnation. The CeO₂ support powder was prepared by calcination of Cerium(III) nitrate hexahydrate (Sigma, 99%) at 350° C. for 2 hrs in a muffle furnace. The obtained CeO₂ powder was impregnated with ruthenium nitrosyl nitrate (0.3 cc/g_{CeO2}), dried in a convection oven at 80° C. for 12-hours, then impregnated with cesium carbonate solution. The resulting sample was dried in a vacuum oven at 80° C. then sieved to 40-100 mesh size before use. Magnesium exchanged ZSM-5 (Si/Al₂=23, Zeolyst) was prepared via ion exchange at room temperature by suspending 2-grams ZSM-5 powder in an aqueous solution and adding 6.41-grams magnesium nitrate. The solution was allowed to stir overnight (˜12-hours) and then separated via centrifugation and washed three times with DI water before drying in a muffle furnace at 100° C. for 12-hours.

The catalyst and adsorbent powders weighing approximately 1 gram and 0.4 grams, respectively, were loaded into the reaction chamber. The catalyst reaction chamber measured 2.75″ (7-cm) in length, 0.205″ I.D. (0.521-cm), 0.375″ O.D. (0.953-cm), and 1.46 cm³ bed volume with an above ¼″ (0.635-cm) bed of SiC pre-heating zone. The bed was pre-reduced at 400° C. in 50 sccm pure H₂ for 12 hrs then cooled to the reaction temperature of 340° C. at 10° C./min. Gas lines were then switched to bypass the reactor, where the feed gas of 3:1 H₂:N₂ (by mole or volume) was introduced with a total flow rate of 70 or 20 sccm (measured at 273 K and 1-atm reference conditions). Pressure was built up by a downstream dome loaded BPR (Equilibar) until the set point pressure ranging from 22-35 barg was reached. A downstream online mass spectrometer monitored the outlet gas flow composition, and a mass flow meter monitored the outlet total gas flow rate. The reaction started when the gas lines were switched from the bypass to flow into the reaction chamber. Adsorbent regeneration was conducted by pressure swing at 300° C. from reaction pressure to 1-bara with N₂ flow of 60-80 sccm acting as a sweep gas.

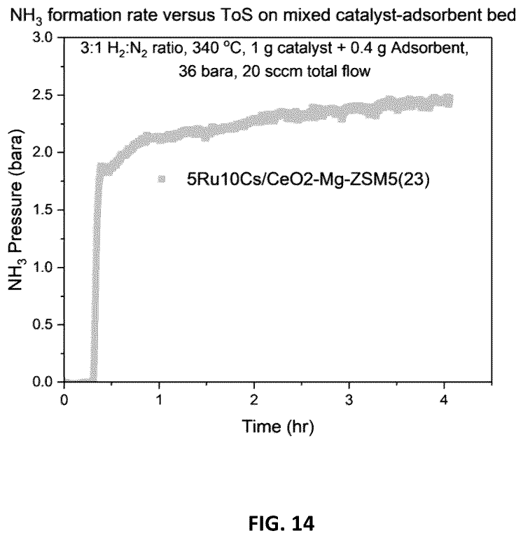

FIG. 14 shows the results of these experiments, which provides for NH₃ adsorption and an increased rate of NH₃ production of the integrated catalyst-sorbent structure of the present disclosure. Delay in NH₃ elution of about 0.3-hours represented the breakthrough period caused by adsorption of NH₃ on ZSM-5 during the initial synthesis-adsorption period. The reaction was allowed to run for 4-hours before being terminated by cutting off the H₂ gas flow. After outlet NH₃ and H₂ signals stabilized to negligible levels in the downstream mass spectrometer, absolute pressure was progressively dropped by releasing the applied pressure to the downstream dome loaded BPR. Mass flow rates were continuously monitored with a downstream mass flow meter to quantity outlet molar flow rates during desorption. Over the depressurization range of 36 to 1 bara, roughly 0.0053 intact moles NH₃ eluted from the system. The quantity of desorbed NH₃ led to the estimate of ˜33% N₂ conversion during the adsorption period compared to 12% at steady state operation after the adsorbent was loaded to capacity or hence the impact of catalyst only.

As shown in FIG. 14, all ammonia being produced is initially adsorbed by the sorbent (zeolite). The jump in NH₃ pressure occurs when the sorbent is mostly saturated. This illustrates performance quantified to have a better rate of production when active catalyst is in simulated intimate contact with the sorbent. The NH₃ rate of formation on the catalyst is slower than the adsorption rate.

### Example 12

This example relates to the pre-reduction of catalysts. Pre-reduction was conducted in situ in a conventional packed bed flow reactor measuring 2″ (5.08-cm) in length, 0.205″ I.D. (0.521-cm), 0.375″ O.D. (0.953-cm), and 1.06 cm³ bed volume with an above 1″ (2.54-cm) bed of SiC pre-heating zone. Reduction was conducted with 50 sccm (measured at 273 K and 1 atm reference conditions) of pure H₂ flow, 1 bara, at constant temperature of 350° C., 400° C., and 500° C. that was maintained by an isothermal furnace. Pre-reduction at 350° C. and 400° C. was performed for 48 hrs while 500° C. pre-reduction was done for 12 hrs. In a separate case, catalyst pre-reduction was done ex situ in a tube furnace at 500° C. with 50 sccm pure H₂ flow then transferred to the reaction chamber with exposure to ambient air during the transition. Non-reduced Katalco 74-1R was directly loaded into the reaction chamber and heated to the reaction temperature in 50 sccm N₂.

In situ pre-reduction was immediately followed by NH₃ synthesis testing in the same reactor. Approximately 2 g catalyst were ground and sieved into 40-100 mesh and loaded into the reaction chamber. During in situ pre-reduction, the reaction chamber was ramped to temperature under 50 sccm H₂ at 5° C./min. The catalyst was then cooled to the reaction temperature of 300° C. at 10° C./min under at least 50 sccm H₂. The gas flow lines were then switched to bypass the reactor, where a 3:1 flow ratio of H₂:N₂ was introduced to match the stoichiometry of the NH₃ synthesis reaction. Gas pressure was slowly built using a dome loaded BPR (Equilibar). Once the system equilibrated to the set point pressure and flow rate, the reaction was initiated by switching the gas line configuration back to the packed bed flow reactor. The effluent gas stream composition was monitored by an online mass spectrometer.

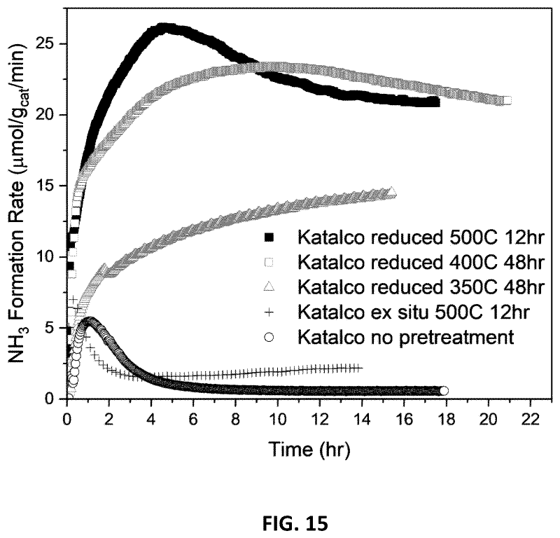

Table 16 summarizes the effects of pre-reduction on catalyst activity. The data in Table 16 is also shown in graphical form in FIG. 15. In general, in situ pre-reduction showed no loss in NH₃ synthesis activity from 500° C. reduction for 12 hrs compared to 400° C. for 48 hrs. Pre-reduction at 350° C. for 48 hrs resulted in lower catalyst activity, achieving about ˜1.4 times less NH₃ synthesis rate compared to higher reduction temperatures. Ex situ reduced Katalco 74-1R showed significant activity loss of about 7.5 times compared to 400° C. reduction. Non-reduced Katalco 74-1R exhibited a small peak in activity during <5 hrs ToS that reached 1.2 μmol g_{cat}⁻¹min⁻¹ but decayed to a low steady state rate of 0.2 μmol g_{cat}⁻¹ min⁻¹. Thus, pre-reduction strongly influences the NH₃ activity of Fe—Co composite catalysts.

TABLE 16
Pre-Reduction on Catalyst Activity.
Katalco 74-1R steady state performance for NH₃ synthesis at 300° C.,
20 barg, >10 hrs ToS relative to pre-treatment protocol

| | | Total flow of | | NH₃, rate |
|---|---|---|---|---|
| | Weight | 3:1 H₂: | N₂ | (μmol |
| Pretreatment | Catalyst | N₂ gas | Conversion, | g_{cat}⁻¹ |
| method | (g) | (sccm) | % | min⁻¹) |
| 500° C., 12 hr in situ | 0.5 | 80 | 0.56 | 20.8 |
| 400° C., 12 hr in situ | 2 | 80 | 2.7 | 20.9 |
| 350° C., 12 hr in situ | 2 | 80 | 1.8 | 14.4 |
| 500° C., 12 hr ex situ | 0.5 | 80 | 0.07 | 2.4 |
| No pre-reduction | 0.5 | 20 | 0.06 | 0.57 |

### Example 13: Pre-Ammoniation of Metal Halide Sorbent

The effect of pre-ammoniation of halide-based absorbents (MnCl₂) was examined in a mixed catalyst-absorbent reaction bed system. The equipment was the same as in Example 12. According to literature, thermal treatment of metal halides can lead to hydrothermal decomposition following the reaction scheme shown in Equation (3) below.

$$M {X}_{2} \cdot {H}_{2} O ( s ) = M ( OH ) X ( s ) + H X ( g ) \qquad ( 3 )$$

Pre-ammoniation can mitigate decomposition at high temperatures by exchanging absorbed H₂O with NH₃. Such treatment prevents the loss of gaseous halides during temperature ramp that diminishes sorbent capacity and potential catalyst poisoning from Cl or X halide in the catalyst-sorbent structures having an intimate relationship as provided in the present disclosure.

The effect of pre-ammoniation was examined with a mixed bed of 1-gram Katalco 74-1R catalyst with 0.4-grams MnCl₂·(H₂O)ₓ absorbent. Before ammoniation, the absorbent was pretreated in 3:1 H₂:N₂ gas at 350° C. for 12 hrs in a tube furnace. The absorbent was then sealed in a vial containing a bed of 1-gram NaOH and 1-gram NH₄Cl. The vial was held at room temperature for 4 hrs. The reaction listed below in Equation (4) produced NH₃ gas that absorbed into MnCl₂, causing a discoloration from pink to dark brown.

$$NaOH ( s ) + {NH}_{4} Cl ( s ) = NaCl ( s ) + {H}_{2} O ( l ) + N {H}_{3} ( g ) \qquad ( 4 )$$

Both 0.5-gram catalyst and 1-gram ammoniated absorbent with a particle size of 150-400 m were mixed uniformly then added to the reaction chamber described in Example 12. In situ pre-reduction at 350° C. was done by the same methods detailed in Example 12; however, pure H₂ flow was replaced by 80 sccm of a 5:45:50 gas mixture of NH₃:He:H₂ (by volume). The presence of 5% NH₃ ensured the retention of the MnCl₂—(NH₃)ₓ state during pre-reduction of the catalyst. Afterwards, the mixed catalyst-absorbent bed was allowed to cool to the reaction temperature of 300° C. under the same 5:45:50 gas mixture of NH₃:He:H₂.

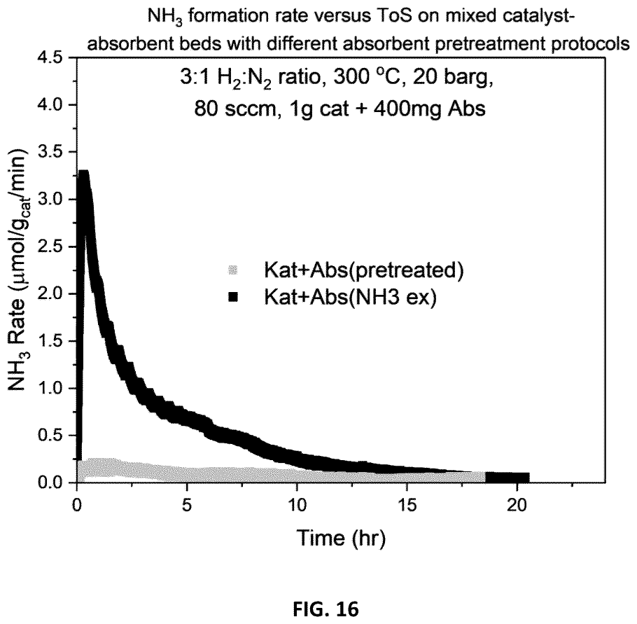

The results of the pre-ammoniation are provided in FIG. 16. FIG. 16 details ammonia synthesis formation rate at 300° C. and 20 barg with 80 sccm 3:1 H₂N₂ flow for the mixed catalyst-absorbent bed for both an ammoniated and non-ammoniated absorbent. In general, pre-ammoniation showed a high initial activity reaching an NH₃ production rate of 3.25 μmol g_{cat}⁻¹min⁻¹ and a gradual decay to negligible activity over 20 hrs time on stream (ToS). The same mixed bed configuration without a pre-ammoniated absorbent and pure H₂ flow during pre-reduction showed negligible activity from the onset of reaction startup. Thus, pre-ammoniation mitigates metal halide decomposition during catalyst pre-reduction to yield appreciable activity during early ToS of NH₃ synthesis, but still exhibits limited lifetime as the reaction proceeds.

### Aspects of Present Disclosure

In some aspects, the present disclosure is directed to the following aspects.

A composition comprising a plurality of particles, wherein each of the particles comprises a catalyst portion in intimate contact with a sorbent portion to provide a catalyst-sorbent structure, wherein the sorbent portion allows for the removal of ammonia essentially as it forms via a catalytic reaction by the catalyst portion configured to convert nitrogen and hydrogen gas to a reaction mixture comprising ammonia.

A composite material comprising a catalyst portion in intimate contact with a sorbent portion to provide a catalyst-sorbent structure, wherein the sorbent portion allows for the removal of ammonia essentially as it forms via a catalytic reaction by the catalyst portion configured to convert nitrogen and hydrogen gas to a reaction mixture comprising ammonia.

A method of synthesizing ammonia from a gaseous feedstock comprising hydrogen and nitrogen in the presence of a catalyst-sorbent structure comprising a catalyst portion in intimate contact with a sorbent portion, wherein the sorbent portion allows for the removal of ammonia essentially as it forms via a catalytic reaction by the catalyst portion configured to convert nitrogen and hydrogen gas to a reaction mixture comprising ammonia.

An apparatus for producing ammonia from a feedstock comprising hydrogen and nitrogen, wherein the apparatus contains a catalyst-sorbent structure comprising a catalyst portion in intimate contact with a sorbent portion, wherein the sorbent portion allows for the removal of ammonia essentially as it forms via a catalytic reaction by the catalyst portion configured to convert nitrogen and hydrogen gas to a reaction mixture comprising ammonia.

A system for producing ammonia from a feedstock comprising hydrogen and nitrogen, wherein the apparatus contains a catalyst-sorbent structure comprising a catalyst portion in intimate contact with a sorbent portion, wherein the sorbent portion allows for the removal of ammonia essentially as it forms via a catalytic reaction by the catalyst portion configured to convert nitrogen and hydrogen gas to a reaction mixture comprising ammonia.

A catalyst-sorbent structure comprising a catalyst portion in intimate contact with a sorbent portion, wherein the sorbent portion allows for the removal of ammonia essentially as it forms via a catalytic reaction by the catalyst portion configured to convert nitrogen and hydrogen gas to a reaction mixture comprising ammonia.

An integrated catalyst-sorbent structure comprising a catalyst portion and a sorbent portion, wherein the catalyst portion is capable of converting an unreacted hydrogen feedstock and an unreacted nitrogen feedstock to an ammonia product and the sorbent portion is capable of absorbing the produced ammonia, wherein the converting of the catalyst portion and absorbing of the sorbent portion are both capable of occurring at a temperature in a range between about 100° C. and about 500° C., preferably between about 200° C. and about 400° C., more preferably between about 250° C. and about 380° C., and even more preferably between about 280° C. and about 350° C., and wherein the converting of the catalyst portion and absorbing of the sorbent portion are both capable of occurring at a pressure in a range between about 2 bar to about 200 bar, preferably between about 5 bar and about 100 bar, more preferably between about 5 bar and about 50 bar, and even more preferably between about 10 bar and about 40 bar.

Any of the foregoing aspects, wherein the catalyst and sorbent portions are intermixed and pressed into a structural component, such as a pellet, tablet granule, or extrudate.

Any of the foregoing aspects, wherein the sorbent portion is first formed into a structural component, such as a pressed pellet, tablet, granule or extrudate, to provide an absorbent core, and then a thin layer of active catalyst is coated as a surrounding shell or external layer at least encompassing the absorbent core.

Any of the foregoing aspects, wherein the sorbent portion is first formed into a structural component, such as a pressed pellet, tablet or extrudate, to provide an absorbent core, a thin layer of active catalyst is coated as a surrounding shell or external layer at least encompassing the absorbent core, and a second layer of absorbent is coated as a surrounding shell or external layer at least encompassing the catalyst layer.

Any of the foregoing aspects, wherein the catalyst portion is first formed into a structural component, such as a pressed pellet, tablet, granule or extrudate, to provide an active catalyst core, and then a layer of sorbent is coated as a surrounding shell or external layer at least encompassing the catalyst core.

Any of the foregoing aspects, wherein the sorbent portion and the catalyst portion are loaded and dispersed along the same porous support either sequentially or simultaneously, preferably by incipient wetness impregnation, colloidal synthesis, or a sol-gel method.

Any of the foregoing aspects, wherein the catalyst portion comprises discontinuous portions that are impregnated within the sorbent portion.

Any of the foregoing aspects, wherein the catalyst portion comprises an active catalyst material comprising iron, cobalt, ruthenium, or combinations thereof.

Any of the foregoing aspects, wherein the sorbent portion comprises one or more metal halide absorbents that has an absorption affinity for NH₃ over N₂ and H₂.

Any of the foregoing aspects, the catalyst-sorbent structure further comprising a support material, preferably wherein at least a portion of the catalyst portion, at least a portion of the sorbent portion, or a combination thereof, is supported on a molecularly porous support material.

Any of the foregoing aspects, wherein the catalyst-sorbent structure further comprises one or more promoters to increase catalyst activity and/or improve catalyst stability.

Any of the foregoing aspects, wherein the catalyst-sorbent structure has porous structure having an average pore diameter between about 20 nm and about 50 microns, in some preferable aspects between about 50 nm and about 5 microns.

Any of the foregoing aspects, wherein the catalyst-sorbent structure further comprises a molecularly porous support material for the active catalyst, such that the catalyst-sorbent has a surface area in a range from about 1 to 1000 m²/gram.

Any of the foregoing aspects, wherein the molecularly porous support material comprises an oxide chosen from of alumina, silica, magnesium, ceria, titania, or combinations thereof.

Any of the foregoing aspects, wherein the active catalyst is self-supported in a porous form.

Any of the foregoing aspects, wherein the sorbent portion supports the active catalyst or the catalyst portion supports the sorbent portion.

Any of the foregoing aspects, wherein the sorbent portion comprises one or more metal halide absorbents, wherein the metal of the one or more metal halides is chosen from Mn, Mg, Ca, Sr, and Fe, and wherein the halide of the one or more metal halides is chosen from Cl, Br and I.

Any of the foregoing aspects, wherein the sorbent portion is a metal halide salt chosen from the group consisting of LiCl, NH₄Cl, CoCl₂, MgCl₂, CaCl₂, MnCl₂, FeCl₂, NiCl₂, CuCl₂, ZnCl₂, SrCl₂, SnCl₂, BaCl₂, PbCl₂, LiBr, NaBr, MgBr₂, CaBr₂, MnBr₂, FeBr₂, NiBr₂, CoBr₂, SrBr₂, BaBr₂, PbBr₂, NaI, KI, CaI₂, MnI₂, FeI₂, NiI₂, SrI₂, BaI₂ and PbI₂.

Any of the foregoing aspects, wherein the sorbent portion is a metal halide salt chosen from the group consisting of MgCl₂, CaCl₂, MnCl₂ and NiCl.

Any of the foregoing aspects, wherein the one or more metal halide salts comprises MnCl₂, MgCl₂, CaCl₂, MgBr₂, CaBr₂, MgClBr, CaClBr, MgCaBr and mixtures thereof.

Any of the foregoing aspects, wherein the catalyst-sorbent structure is provided in a structural component chosen from a pellet, tablet, granule, or extrudate.

Any of the foregoing aspects, wherein the sorbent portion comprises one or more zeolites, preferably one or more aluminosilicate zeolites chosen from zeolite Y, zeolite X, zeolite 4A, zeolite 5A, ZSM-5, or a mixture thereof.

Any of the foregoing aspects, wherein the catalyst-sorbent structure comprises one or more coatings of the catalyst portion, the sorbent portion, or a combination thereof, wherein each coating has an average thickness between about 1 microns and about 200 microns, preferably between about 10 microns and about 150 microns, more preferably between about 20 microns and about 100 microns.

Any of the foregoing aspects, wherein the sorbent portion and the catalyst portion are loaded and dispersed along the same porous support (either sequentially or simultaneously, e.g., by incipient wetness impregnation, colloidal synthesis, or a sol-gel method, or other method), such that the catalyst-sorbent particle is supported on the same porous support.

Any of the foregoing aspects, wherein the catalyst-sorbent structure has an average diameter between 1 and 20 mm, preferably between 3 and 10 mm, more preferably between 3 and 9 mm.

Any of the foregoing aspects, wherein the catalyst-sorbent structure has a sorbent portion loading between 5% and 95% by weight, preferably between 10% and 90% by weight, more preferably between 20% and 90% by weight.

Any of the foregoing aspects, wherein the catalyst-sorbent structure has a catalyst portion loading between 0.01% and 20% by weight, preferably between 0.25% and 10% by weight, more preferably between 0.5% and 5% by weight.

Any of the foregoing aspects, wherein the catalyst-sorbent structure has a catalyst portion loading less than 5% by weight.

Any of the foregoing aspects, wherein the catalyst-sorbent structure has a catalyst portion loading to sorbent portion loading (catalyst:sorbent) ratio by weight of about 1:1 to about 1:300, preferably about 1:1 to about 1:50, more preferably about 1:1 to about 1:10.

Any of the foregoing aspects, wherein the sorbent portion loading density is in the range from about 100 kg/m³ to 2000 kg/m³, preferably in the range from about 300 kg/m³ to about 1500 kg/m³, more preferably in the range from about 500 kg/m³ to about 1200 kg/m³.

Any of the foregoing aspects, wherein the catalyst portion loading density is in the range from about 10 kg/m³ to 2000 kg/m³, preferably in the range from about 100 kg/m³ to about 1500 kg/m³, more preferably in the range from about 150 kg/m³ to about 1200 kg/m³.

Any of the foregoing aspects, wherein catalyst-sorbent structure exceeds the equilibrium NH₃ conversion that would be obtained if only the catalyst portion and not the sorbent portion were used or wherein the catalyst-sorbent structure has improved product rates and/or kinetics if only the catalyst portion and not the sorbent portion were used.

Any of the foregoing aspects, wherein the catalyst-sorbent structure is provided in a reactor, preferably as a fixed bed, such as a packed bed, wherein during normal operating conditions the catalyst portion converts an unreacted hydrogen feedstock and an unreacted nitrogen feedstock to an ammonia product, and the sorbent portion absorbs the produced ammonia.

Any of the foregoing aspects, wherein the catalyst-sorbent structure is arranged within a reactor, wherein the catalyst-sorbent structure is loaded in a range between about 0.1% to about 99.9%, preferably between about 10% to about 90%, preferably between about 15% to about 80%.

Any of the foregoing aspects, wherein the catalyst-sorbent structure is arranged within a reactor, wherein the catalyst-sorbent structure is loaded in the reactor in amount of at least 10%, in some aspects at least 20%, in some aspects at least 30%, in some aspects at least 40%, in some aspects at least 50%, in some aspects at least 60%, in some aspects less than 90%, in some aspects less than 80%, and in some aspects less than 70%, of the volume of the reactor.

Any of the foregoing aspects, wherein the catalyst-sorbent structure is provided in the reactor with the catalyst portion having a weight range (w/w) between about 0.01% and about 20%, preferably between about 0.25% and about 10%, more preferably between about 0.5% and less than about 5%.

Any of the foregoing aspects, wherein the catalyst-sorbent structure is provided in the reactor with the catalyst portion being a weight range (w/w) of less than 5% by weight.

Any of the foregoing aspects, wherein the process for producing ammonia with the integrated catalyst-sorbent structure has a process cycle that is less than a full absorption capacity of the sorbent portion. In some aspects, the process cycle is at least 20% up to about 95% of full theoretical capacity as defined by the temperature and pressure of operation for the process bed.

Any of the foregoing aspects, wherein the process for producing ammonia with the integrated catalyst-sorbent structure has an initial process cycle having an initial conversion and a second process cycle having a second conversion, wherein the second conversion has a lower conversion than the initial conversion, in some aspects at least 1% lower, and in some preferred aspects between 1% and 10% lower than the initial conversion.

Any of the foregoing aspects, wherein the process for producing ammonia comprises providing the integrated catalyst-sorbent structure in multiple beds, wherein the multiple beds are provided in series, parallel, or a combination of in series and parallel.

Any of the foregoing aspects, wherein the unreacted hydrogen is provided from a hydrogen source comprising an electrolyzer.

Any of the foregoing aspects, wherein the unreacted nitrogen is provided from a nitrogen source, wherein the nitrogen source is a pressure swing adsorption (PSA) system, air separation unit (ASU) system, membrane separator, nitrogen tank, or a combination thereof.

Any of the foregoing aspects, wherein the one more zeolites has a binding affinity for NH₃ over N₂ and H₂, preferably at least 5 times, in some aspects at least 10 times, in some aspects at least 100 times, in some aspects at least 200 times, in some aspects at least 300 times, in some aspects at least 400 times, in some aspects at least 500 times, in some aspects at least 600 times, in some aspects at least 700 times, and in some aspects at least 1000 times or more greater affinity for NH₃ than for N₂ and/or H₂.

Any of the foregoing aspects, wherein the one or more zeolites have a pore size smaller than N₂ and H₂ molecules but larger than NH₃ molecules, such that the pore size effectuates size exclusion of unreacted N₂ and unreacted H₂ but allows for the flow of NH₃.

Any of the foregoing aspects, wherein the one or more zeolites have a pore size between about 3 Å and about 5 Å, preferably between about 4 Å and about 5 Å.

Any of the foregoing aspects, wherein the one or more zeolites have a pore size that is larger than NH₃ molecules.

Any of the foregoing aspects, wherein the one or more zeolites have a pore size greater than 5 Å.

Any of the foregoing aspects, wherein the one or more zeolites have a desired pore size formed by ion-exchange to partially or fully replace the Na and/or H cations with one or more other metals, preferably one or more alkali or transition metals.

Any of the foregoing aspects, wherein the sorbent portion comprises one or more zeolites, preferably one or more aluminosilicate zeolites, and the one or more zeolites are loaded with the catalyst portion.

Any of the foregoing aspects, further comprising a secondary sorbent portion.

Any of the foregoing aspects, wherein the secondary sorbent portion comprises one or more metal halides.

Any of the foregoing aspects, wherein the secondary sorbent portion comprises one or more zeolites that are different than the sorbent portion.

Any of the foregoing aspects, further comprising a promoter material, the promoter material preferably comprising K, Ce, Cs, Ba, or a mixture thereof.

Any of the foregoing aspects, wherein the promoter material is preferably loaded into the one or more zeolites in an amount greater than 0 and up to about 10 wt %.

Any of the foregoing aspects, wherein the integrated catalyst-sorbent structure is in the form of a pellet, tablet, extrude or granule having an average diameter between 1 mm and 20 mm, preferably between 3 mm and 10 mm, more preferably between 3 mm and 9 mm.

Any of the foregoing aspects, wherein the integrated catalyst-sorbent structure is in the form of a monolithic structure having a support material, the support material preferably being a ceramic material, metal oxide such as alumina, or a combination thereof.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A catalyst-sorbent structure comprising:
a catalyst portion in direct contact with a sorbent portion, the catalyst portion comprising one or more active catalysts, and the sorbent portion comprising one or more sorbents;
wherein the catalyst portion is capable of converting an unreacted hydrogen feedstock and an unreacted nitrogen feedstock to an ammonia product via a catalyst reaction;
wherein the sorbent portion allows for the removal of the ammonia product from the catalyst portion to the sorbent portion essentially as it forms via the catalyst reaction.

2. The catalyst-sorbent structure of claim 1, wherein the catalyst portion and the sorbent portion are in the form of a pressed pellet, tablet, extrudate, or monolithic structure.

3. The catalyst-sorbent structure of claim 1, further comprising a porous support material chosen from of alumina, silica, magnesium, ceria, titania, or combinations thereof, wherein the sorbent portion and the catalyst portion are loaded and dispersed on the porous support material.

4. The catalyst-sorbent structure of claim 1, wherein the one or more active catalysts comprises iron, cobalt, ruthenium, molybdenum, or combinations thereof.

5. The catalyst-sorbent structure of claim 4, wherein the one or more sorbents includes one or more metal halide absorbents, wherein the metal of the one or more metal halides includes Mn, Mg, Ca, Sr, Fe, or mixtures thereof, and wherein the halide of the one or more metal halides includes Cl, Br, I, or mixtures thereof.

6. The catalyst-sorbent structure of claim 4, wherein the one or more sorbents includes one or more metal halide absorbents, wherein the one or more metal halide absorbents includes MnCl₂, MgCl₂, CaCl₂, MgBr₂, CaBr₂, MgClBr, CaClBr, MgCaBr, or mixtures thereof.

7. The catalyst-sorbent structure of claim 4, wherein the one or more sorbents comprises one or more zeolites.

8. The catalyst-sorbent structure of claim 7, wherein the one more zeolites is chosen from zeolite Y, zeolite X, zeolite 4A, zeolite 5A, ZSM-5, or a mixture thereof.

9. The catalyst-sorbent structure of claim 7, wherein the one more zeolites has a binding affinity for the ammonia product is at least 10 times or more greater over the unreacted hydrogen feedstock and the unreacted nitrogen feedstock.

10. The catalyst-sorbent structure of claim 7, wherein at least a portion of the one or more zeolites have a pore size smaller than the unreacted hydrogen feedstock and the unreacted nitrogen feedstock but larger than the ammonia product, such that the pore size is configured to effectuate size exclusion of the unreacted hydrogen feedstock and the unreacted nitrogen feedstock but allows for the flow of the ammonia product.

11. The catalyst-sorbent structure of claim 10, wherein at least a portion of the one or more zeolites having a desired pore size formed by ion-exchange to partially or fully replace at least a portion of one or more cations.

12. The catalyst-sorbent structure of claim 7, wherein the one or more zeolites have a pore size that is smaller than the ammonia product.

13. The catalyst-sorbent structure of claim 7, further comprising a secondary sorbent portion that includes one or more metal halide absorbents, one or more zeolites, or a combination thereof.

14. The catalyst-sorbent structure of claim 7, further comprising one or more promoter materials, the one or more promoter materials including K, Ce, Cs, or a mixture thereof.

15. The catalyst-sorbent structure of claim 1, wherein the catalyst-sorbent structure includes a porous structure having an average pore diameter between about 20 nm and about 5 microns.

16. A method of synthesizing ammonia from a gaseous feedstock, the method comprising:
providing a catalyst-sorbent structure in a reactor bed, the catalyst-sorbent structure comprising a catalyst portion in direct contact with a sorbent portion, the catalyst portion comprising one or more active catalysts, and the sorbent portion comprising one or more sorbents; and
subjecting the catalyst-sorbent structure to a gaseous feedstock comprising an unreacted hydrogen feedstock and an unreacted nitrogen feedstock to allow a catalyst reaction to occur proximate the catalyst portion, wherein the catalyst reaction converts a portion of the unreacted hydrogen feedstock and a portion of the unreacted nitrogen feedstock into an ammonia product;
wherein the sorbent portion allows for the removal of the ammonia product from the catalyst portion to the sorbent portion essentially as the ammonia product forms via the catalyst reaction.

17. The method of claim 16, further comprising desorbing the ammonia product from the sorbent portion.

18. The method of claim 16, wherein the catalyst reaction to form the ammonia product and the removal of the ammonia product to the sorbent portion are capable of occurring at a temperature in a range between about 280° C. and about 400° C. and a pressure in a range between about 5 bar and about 50 bar.

19. The method of claim 16, wherein the one or more sorbents includes one or more metal halide absorbents or one or more zeolites.

20. The method of claim 19, wherein the one or more active catalysts comprises iron, cobalt, ruthenium, molybdenum, or combinations thereof.
